(19) United States
(12) Patent Application Publication
(10) Pub. No.: US 2019/0320515 A1
(43) Pub. Date: Oct. 17, 2019

(54) Solid State Lighting Systems

(71) Applicant: Laurence P. Sadwick, Salt Lake City, UT (US)

(72) Inventor: Laurence P. Sadwick, Salt Lake City, UT (US)

(21) Appl. No.: 16/384,902

(22) Filed: Apr. 15, 2019

Related U.S. Application Data
(60) Provisional application No. 62/657,904, filed on Apr. 15, 2018.

(51) Int. Cl. H05B 33/08; F21K 9/27; H05B 37/02; F21K 9/23

(52) U.S. Cl. CPC H05B 33/0866; H05B 33/0815; F21K 9/27; H05B 33/0863; F21K 9/23; H05B 37/0281; H05B 33/0821; H05B 37/0227

(57) ABSTRACT

An apparatus for personalized lighting systems, including a power supply, a number of solid state lights connected to the power supply, a number of switches, each connected to one of the solid state lights and operable to switchably block electrical current from the power supply through an associated one of the solid state lights, and a clock generator connected to the switches and configured to activate the switches.

### BACKGROUND

A major source of wasted and excessive energy usage is inefficient lighting such as incandescent bulbs and older types of ballasts used for T8 and T12 fluorescent lights. Interest has grown rapidly in replacing incandescent lights with more efficient lighting, such as fluorescent lighting and light emitting diodes (LEDs). However, great room for improvement remains in efficient lighting.

### BRIEF DESCRIPTION OF THE DRAWINGS

A further understanding of the various embodiments of the present invention may be realized by reference to the figures which are described in remaining portions of the specification. In the figures, like reference numerals are used throughout several figures to refer to similar components.

FIG. 1 depicts a fluorescent light fixture with two solid state replacement tubes.

FIG. 2 depicts a fluorescent light fixture with three solid state replacement tubes.

FIGS. 3A and 3B depict end and side views, respectively, of a solid state lighting ‘bar’ which can be used as a replacement for a fluorescent tube, with lighting elements covering half the bar.

FIGS. 4A and 4B depict end and side views, respectively, of a solid state lighting ‘bar’ which can be used as a replacement for a fluorescent tube, with lighting elements located all the way around the bar.

FIG. 5 depicts a current source-based current control circuit which can be used to set the current level through one or more solid state light sources.

FIG. 6 depicts a voltage source-based current control circuit which can be used to set the current level through one or more solid state light sources.

FIG. 7 depicts voltage source-based current control circuits which can be used to set the current level through multiple banks of solid state light sources.

FIG. 8 depicts a non-limiting example of a troffer with replacement solid state lighting mounted in the troffer fixtures and/or additional solid state lighting.

FIG. 9 depicts a non-limiting example of a troffer with replacement solid state lighting mounted in the troffer fixtures and/or additional solid state lighting with optional additional sensors or other devices.

FIG. 10 depicts a non-limiting example of a troffer with replacement solid state lighting mounted in the troffer fixtures and/or additional solid state lighting, illustrating how additional solid state lighting can be arranged on one side or in other locations or configurations.

FIG. 11 depicts a non-limiting example embodiment of a troffer with replacement solid state light strips and additional central solid state lighting.

FIG. 12 depicts a non-limiting example embodiment of a troffer with replacement solid state light strips and additional central and non-central solid state lighting.

FIG. 13 depicts a non-limiting example embodiment of a troffer with replacement solid state light strips and additional central and non-central solid state lighting and sensors or other devices.

FIG. 14 depicts a non-limiting example embodiment of a 3 lamp fluorescent lamp fixture with solid state replacement light tubes.

FIG. 15 depicts a non-limiting example embodiment of a 3 lamp fluorescent lamp fixture with three LED light strips.

FIG. 16 depicts a non-limiting example embodiment of a 3 lamp fluorescent lamp fixture with six LED light strips connected with a combination of series and parallel connections.

FIG. 17 depicts a non-limiting example embodiment of a 3 lamp fluorescent lamp fixture with eight LED light strips in a series connection.

FIG. 18 depicts a non-limiting example cubicle workspace illuminated only by an overhead solid state light.

FIG. 19 depicts a non-limiting example cubicle workspace illuminated only by cubicle top solid state lighting.

FIG. 20 depicts a non-limiting example cubicle workspace illuminated by a combination of overhead solid state lighting and cubicle top solid state lighting.

FIG. 21 depicts a non-limiting example of solid state light strips in fluorescent replacement tubes being controlled remotely by a smartphone app.

FIG. 22 is a block diagram of an example solid state lighting system for providing wayfinding services.

FIG. 23 depicts a non-limiting example embodiment of a lighting and sensor module, shown in block diagram and graphic depiction.

FIG. 24 depicts a perspective view of the lighting and sensor module of FIG. 23.

FIG. 25 depicts a side view of the lighting and sensor module of FIG. 23.

FIG. 26 depicts a solid state light panel or puck with a plurality of light sources or strips that can be used to form symbols, letters, numbers, etc.

FIG. 27 depicts a block diagram of a dimmable solid state lighting system with optional Edison lamp base adapters.

FIG. 28 depicts a non-limiting example of a solid state security lighting system with incorporated dimmers.

FIG. 29 depicts a solid state light panel with a plurality of light sources or strips and with sensors and/or other devices.

FIGS. 30-31 depict a non-limiting example embodiment of a segmented solid state light panel.

FIGS. 32-34 depict a non-limiting example embodiment of a circular light panel with center lighting and edge lighting, with various cross-hatch patterns representing different colors, dimming states, color temperatures, etc.

FIG. 35 depicts a non-limiting example schematic of a 2-channel current splitter for SSL lighting.

FIG. 36 depicts a non-limiting example schematic of an N-channel current splitter for SSL lighting.

FIGS. 37A-B depict non-limiting example schematics of a current splitter for SSL lighting, with dual and shared PWM generator for hue control, respectively.

FIG. 38 depicts a non-limiting example block diagram of a 2-channel current splitter for SSL lighting.

FIG. 39 depicts a non-limiting example block diagram of an N-channel current splitter for SSL lighting with parallel control channels.

FIG. 40 depicts a non-limiting example block diagram of an N-channel current splitter for SSL lighting with serial control channels.

### DETAILED DESCRIPTION OF THE INVENTION

Embodiments of the present invention can be used to replace fluorescent tubes in fixtures including fixtures in which the lamps either use total or partial indirect, reflected, etc., lighting or can be turned into indirect and/or direct, partially or totally reflected, etc. lighting. In some embodiments, security and/or sensor and/or guidance and/or reporting features can be included. Embodiments of the present invention can also be in other form factors such pendant lamps, down lights, can lights, bulbs, etc.

The embodiments can use one or more SSLs including but not limited to LEDs, OLEDs, QLEDs, QDs, etc. combinations of these, etc. arranged in strings, ropes, edge lit including but not limited to flat, flat panel, and/or cylindrical edge lit, other edge lit form factors and geometries, arrays of SSLs including in any form, fashion, geometry, etc. including but not limited to linear, circular, evenly spaced, randomly spaced, etc. Implementations of the present invention can have one or more color temperatures, one or more colors, can be color temperature tunable, color tunable, white and other colors, white and red and green and blue (WRGB). WRGB plus amber (WRGBA), white plus violet (WV), WVRG, WVRGB, WVRGBA, etc., cool white and warm white RGB (WWRGB) combinations of these, etc. The SSL can be dropped/put in place as a panel, one or more panels, strips, one or more stripes, etc. and can be powered by the ballast(s), directly powered by the AC (e.g., 120 to 277 VAC or lower or higher) power, low voltage DC, solar or other energy sources including but not limited to alternative energy sources, batteries, geothermal, super capacitor(s), etc. The panels can contain or have tethered to the panels sensors, detectors, controls, Internet of Things (IoT), additional lighting including but not limited to warning, alerts, signal, directional, direction indicating, etc., combinations of these to measure, determine, control, monitor, log, respond, etc. to for example but not limited to environment, security, alerts, warnings, comfort, pleasure, mood, health, light quality, including for employees at work, people at home, students at schools and universities, patients at hospitals, clinics, senior living facilities, assisted living facilities, independent living facilities, government offices and buildings, private businesses, public locations, libraries, bathrooms, restrooms, hallways, hospitals, ballrooms, meeting halls, classrooms, cafeterias, lunch rooms, break rooms, lounges, dormitories, parking garages, other public locations, hotels, motels, condos, apartments, assisted living, businesses, markets, restaurants, movie theaters, malls, stores, restroom and bathroom stalls, urinals, sinks, kitchens, showers, baths, warehouses, buildings, etc. The panels or tubes or other form factors can have or consist of one or more color or color temperature that can turn on, flash, strobe, etc. to indicate, for example, fire, danger, active shooter, exits to take and not take, safe passage, etc. The panels can also be used to strobe the light at frequencies that are disturbing and disorienting including but not limited to sub Hertz to tens of Hertz or higher for example but not limited to at a constant frequency, variable frequencies, ramped frequencies, random frequencies, random pattern frequencies, linear ramped frequencies, power law ramped frequencies, etc. to, for example, but not limited to, disorient, disturb, distract, etc. a bad actor, active shooter, others, etc. and to otherwise impair an active shooter or other bad actors.

The present invention can use the lighting as a platform for other types of uses, applications, purposes, etc., and can provide infrastructure for comfort including but not limited to HVAC, lighting, communications, streaming, motion, air quality, security, protection, occupancy, vacancy, etc. The present invention can be used for active shooter detection and response, for wayfinding, indicating, notifying, providing information on availability, occupancy etc.

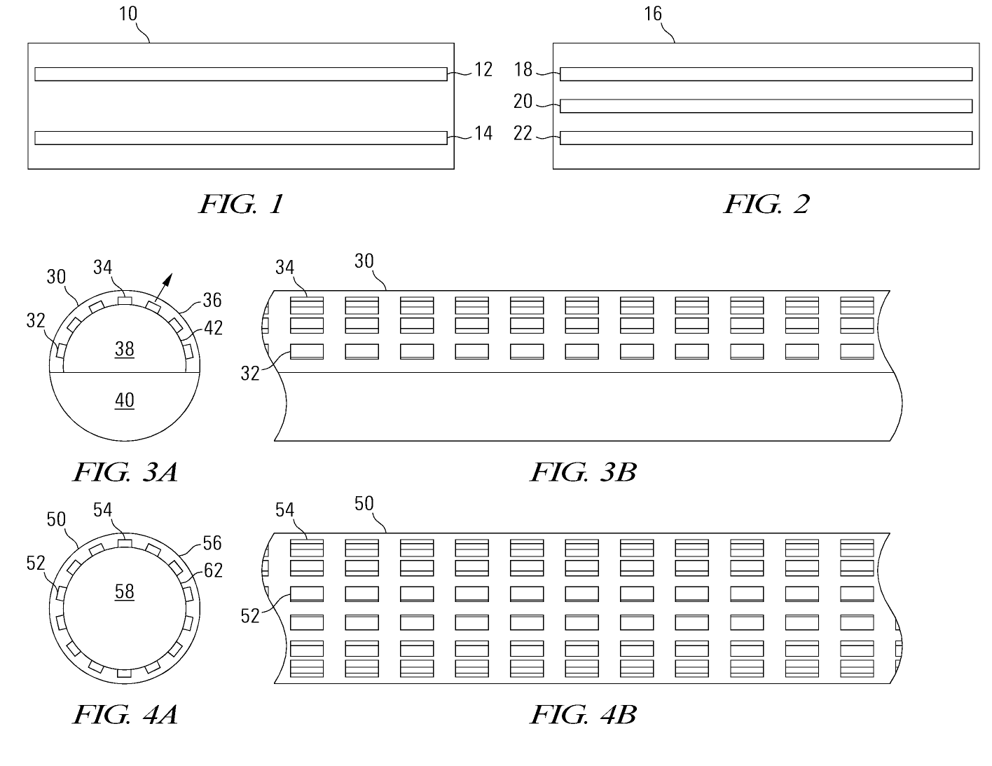

Solid state lighting systems can be provided in any suitable housing or mounting and can be powered in any suitable manner. In one non-limiting example, existing conventional or unconventional lighting fixtures are retrofitted as solid-state lighting systems. Solid state lighting and optional power supplies and/or sensors can be included in tubes or bulbs which can be installed in existing light fixtures, such as, but not limited to, replacing fluorescent tubes of any type, size, length, diameter, pins including but not limited to T5, T8, T12, etc. of any length with bi pins, single pins, quad pins, at both end or one end, etc. For example, turning to FIGS. 1 and 2, fluorescent light fixtures 10 and 16 can have two solid state replacement tubes 12, 14 or three solid state replacement tubes 18, 20, 22 or any number or shape or configuration or combinations of tubes and/or bulbs and/or panels and/or sensors, daylight harvesters, fans, motors, etc.

Turning to FIGS. 3A and 3B, a solid state lighting ‘bar’ 30 is depicted which can be used as a replacement for a fluorescent tube and which can, in some embodiments, be connected directly to a fluorescent light fixture, with or without preexisting fluorescent ballast in place. In this non-limiting example embodiment, one or more lighting elements 32, 34 (e.g., LEDs, quantum dots, contoured light panel, etc.) cover half or about half the circumference of the bar 30 and can extend to the ends or substantially to the ends of the bar 30. A lens 36 can be clear or can be a diffuser or colored. Electronics and/or support structures can be placed inside 38 the lighting structure or in a base 40. The solid state lighting bar is typically of low power, for example, but not limited to, with each row of LEDs requiring about 2 watts (or less) over 4 feet or about 0.5 W/ft (or less) and therefore requires very little heat sinking which can be accomplished by having the inner tube 42 that the LEDs 32, 34 are attached to be made of metal. The number of rows of LEDs or other light sources can range from a few to about a dozen or more depending on the angle covered (e.g., 120, 160, 180, 220, 250, 270, 300, 330, 360 (etc.) degrees). The LEDs or light sources can be of any color, temperature, luminance, size, etc., and can use any suitable power levels. For example, the LEDs 32, 34 can be supplied a DC voltage that can typically range from ˜20 V DC or less to over 120 V DC.

Note that the location, placement, angle, size, shape, etc. of the elements indicating LEDs are for illustration and are in no way or form limiting. Any arrangement can be used including but not limited to symmetrical, asymmetrical, random, varying, at constant spacing, constant angle difference, etc., combinations of these, etc. For example but not limited to 0, 15, 30, 45, 60, 75, 90, 105, 120, 135, 150, 165, 180, 195, 210, 225, 240, 255, 270, 285, 300, 315, 330, 345 degrees etc., smaller angular changes/deltas, larger angular changes/deltas, etc. as a non-limiting example. Implementations can be of any length, any diameter, etc. including for T-Lamps such as but not limited to T1, T2, T3, T4, T5, T6, T8, T9, T10, T12, T14, etc. in any shape, form, etc. including linear, U-bend, etc. Implementations of the present invention can be but are not limited to Class 2.

Turning to FIGS. 4A and 4B, a solid state lighting ‘bar’ 50 is depicted which can be used as a replacement for a fluorescent tube and which can, in some embodiments, be connected directly to a fluorescent light fixture, with or without preexisting fluorescent ballast in place. In this non-limiting example embodiment, one or more lighting elements 52, 54 (e.g., LEDs, quantum dots, contoured light panel, etc.) cover the entire circumference of the bar 30 and can extend to the ends or substantially to the ends of the bar 50. A lens 56 can be clear or can be a diffuser or colored. Electronics and/or support structures can be placed inside 58 the lighting structure. The solid state lighting bar is typically of low power, for example, but not limited to, with each row of LEDs requiring about 1 watt (or less) over 4 feet or about 0.25 W/ft (or less) and therefore requires very little heat sinking which can be accomplished by having the inner tube 62 that the LEDs 52, 54 are attached to be made of metal. The number of rows of LEDs or other light sources can range from a few to about a dozen depending on the angle covered (e.g., 120, 160, 180, 220, 250, 270, 300, 330, 360 (etc.) degrees). The LEDs or light sources can be of any color or colors, color temperature(s), combinations of these, etc., luminance, size, etc., and can use any suitable power levels. For example, the LEDs 52, 54 can be supplied a DC voltage that can typically range from ˜20 V DC or less to over 120 V DC.

Note that the location, placement, angle, size, shape, etc. of the elements indicating LEDs are for illustration and are in no way or form limiting. Any arrangement can be used including but not limited to symmetrical, asymmetrical, random, varying, at constant spacing, constant angle difference, etc., combinations of these, etc. For example but not limited to 0, 15, 30, 45, 60, 75, 90, 105, 120, 135, 150, 165, 180, 195, 210, 225, 240, 255, 270, 285, 300, 315, 330, 345 degrees etc., smaller angular changes/deltas, larger angular changes/deltas, etc. as a non-limiting example. Implementations can be of any length, any diameter, etc. including for T-Lamps such as but not limited to T1, T2, T3, T4, T5, T6, T8, T9, T10, T12, T14, etc. in any shape, form, etc. including linear, U-bend, etc. Implementations of the present invention can be but are not limited to Class 2.

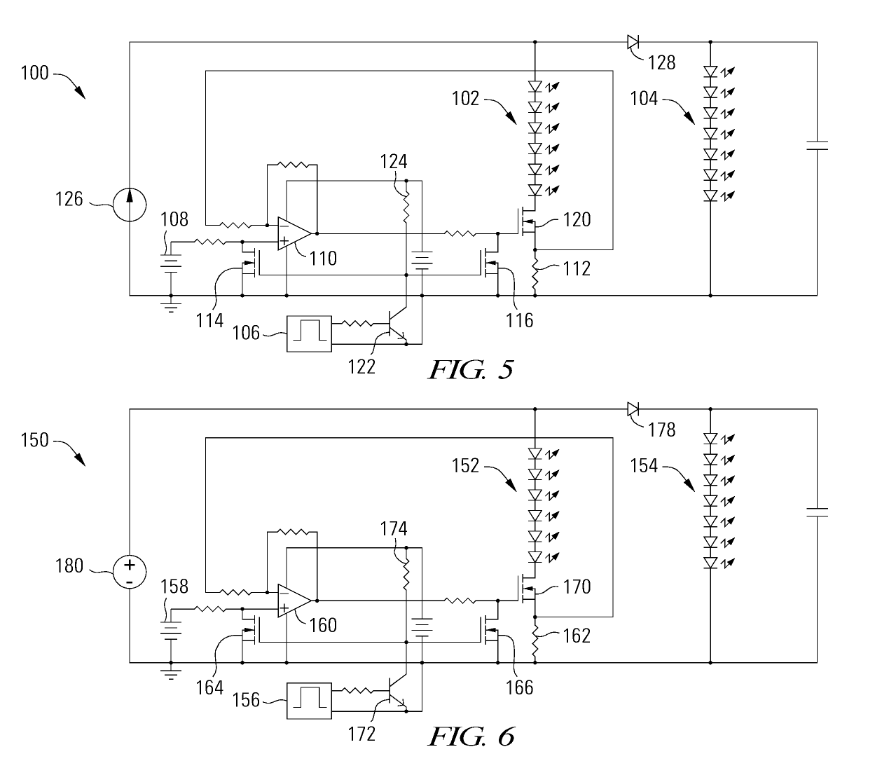

Turning now to FIG. 5, a current control circuit 100 is depicted which can be used to set the current level through one or more one or more strips/arrays/strings/etc. 102, 104 of solid state light sources in general including but not limited to LEDs, OLEDs, QLEDs, etc. The current control circuit 100 uses a pulse width modulated (PWM) signal of any suitable frequency, for example but not limited to about 2500 Hz or higher, produced by any suitable PWM generator 106, to modulate a current set point voltage 108 used as the reference voltage at the non-inverting input of a comparator or difference amplifier 110. The current through an SSL string 102 is measured by a current sensor 112 and is fed back to the inverting input of the amplifier 110, where it is compared with the current set point voltage 108. Switches 114, 116 pull down the non-inverting input and output of the amplifier 110 as controlled by the PWM generator 106, modulating a control switch 120 to control the PWM duty cycle of the current control circuit 100. The PWM generator 106 can be buffered by a switch 122. The amplifier 110 can also be deactivated by the PWM generator 106, for example by pull-down resistor 124, increasing the efficiency of the current control circuit 100.

One or more of such present inventions can be used with a current source 126 to provide specified current to the one or more SSL strings 102, 104. The current source 126 can comprise, but is not limited to, a current power supply, a current driver, a constant current driver and/or power supply, a variable constant current driver and/or power supply, a dimmable current driver and/or power supply, etc., which could be but is not limited to one or more of an AC to DC, a DC to DC converter(s), etc. and in some cases a DC to AC or an AC to AC inverter. One or more of the present invention can be used with the same or different current set points and the same or different PWM duty cycles. In some embodiments as depicted in FIG. 5 an optional diode 128 can be used such that the current which does not go through SSL string 102 will then go through SSL string 104. Although the present invention is described in terms of use with lighting application(s), the present invention can be used for other applications including but not limited to applications that require current sharing including but not limited to non-solid state lighting and/or solid state lighting mixed/combined with non-solid state lighting as well as non-lighting applications and uses, etc. including for example but not limited to photovoltaics (PV)/solar cell applications and uses.

Turning now to FIG. 6, a non-limiting embodiment of a current control circuit 150 is depicted in which a voltage source 180 is used instead of a current source 126 as in FIG. 5. The current control circuit can be used to set the current level through one or more strips/arrays/strings/etc. 152, 154 of solid state light sources in general including but not limited to LEDs, OLEDs, QLEDs, etc.

In such an example embodiment, optional diode 178 can be used to separate one or more strips/strings/arrays/groups/etc. 152, 154 of light emitters including but not limited to solid state lighting as well as non-solid state lighting. In some embodiments a resistor or higher voltage lighting emitters may suffice where in other embodiments the present invention can be used for each light emitting path as illustrated in FIGS. 5 and 6. In other embodiments a second circuit such as that used on SSL strip 152 can be used on and with SSL strip 154 to also control including but not limited to dimming the current through SSL strip 154. In general the circuit used for/on SSL strip 102, 152 in FIGS. 5 and 6 can be replicated and used to control one or more (N>1) arrays of LEDs including arrays of LEDs with different current(s) and/or forward voltage(s).

The current control circuit 150 uses a pulse width modulated (PWM) signal of any suitable frequency, for example but not limited to in some implementations about 2500 Hz or higher, produced by any suitable PWM generator 156, to modulate a current set point voltage 158 used as the reference voltage at the non-inverting input of a comparator or difference amplifier 160. The current through an SSL string 152 is measured by a current sensor 162 and is fed back to the inverting input of the amplifier 160, where it is compared with the current set point voltage 158. Switches 164, 166 pull down the non-inverting input and output of the amplifier 160 as controlled by the PWM generator 156, modulating a control switch 170 to control the PWM duty cycle of the current control circuit 150. The PWM generator 156 can be buffered by a switch 172. The amplifier 160 can also be deactivated by the PWM generator 156, for example by pull-down resistor 174, increasing the efficiency of the current control circuit 150.

One or more of such present inventions can be used with a voltage source 180 to provide specified current to the one or more SSL strings 152, 154. The voltage source 180 can comprise, but is not limited to, a current power supply, a current driver, a constant current driver and/or power supply, a variable constant current driver and/or power supply, a dimmable current driver and/or power supply, etc., which could be but is not limited to one or more of an AC to DC, a DC to DC converter(s), etc. and in some cases a DC to AC or an AC to AC inverter. One or more of the present invention can be used with the same or different current set points and the same or different PWM duty cycles. In some embodiments as depicted in FIG. 6 an optional diode 178 can be used such that the current which does not go through SSL string 152 will then go through SSL string 154.

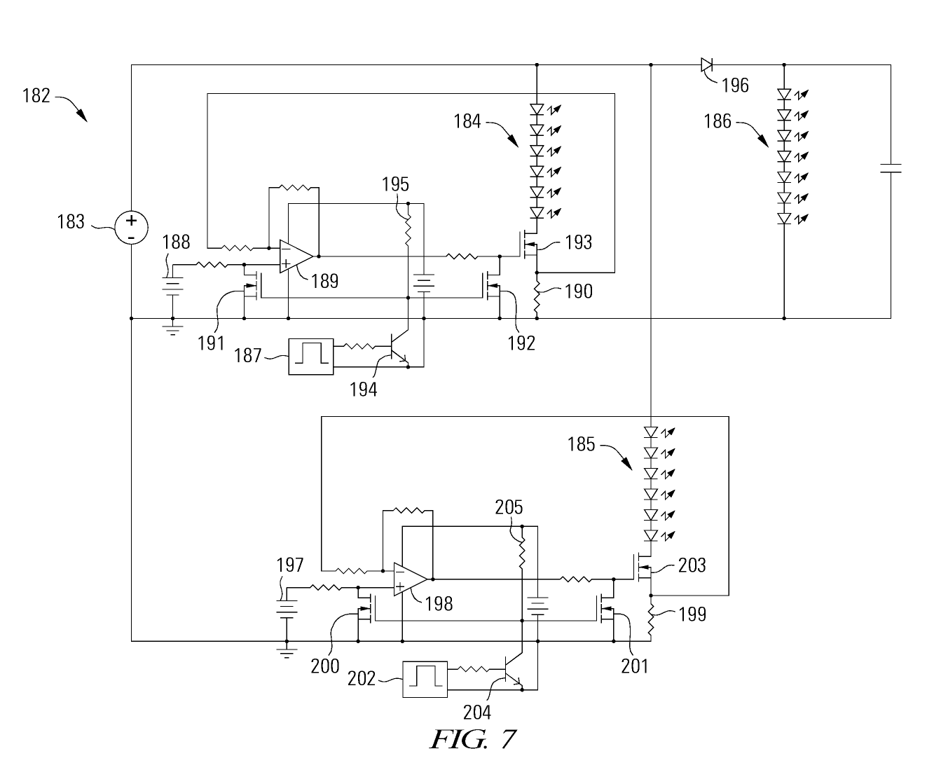

Turning now to FIG. 7, a non-limiting embodiment of a current control circuit 182 is depicted in which a voltage source 183 is used instead of a current source 126 as in FIG. 5. The current control circuit can be used to set the current level through multiple strips/arrays/strings/etc. 184, 185, 186 of solid state light sources in general including but not limited to LEDs, OLEDs, QLEDs, etc.

In such an example embodiment, optional diode 196 can be used to separate one or more strips/strings/arrays/groups/etc. 184, 185, 186 of light emitters including but not limited to solid state lighting as well as non-solid state lighting. In some embodiments a resistor or higher voltage lighting emitters may suffice where in other embodiments the present invention can be used for each light emitting path as illustrated in FIGS. 5-7. As shown in FIG. 7, the current control circuit used to control one or more (N>1) arrays of LEDs including arrays of LEDs with different current(s) and/or forward voltage(s) can be replicated for each additional SSL array.

The current control circuit 182 uses pulse width modulated (PWM) signals of any suitable frequency, for example but not limited to in some implementations about 2500 Hz or higher, produced by any suitable PWM generators 187, 202, to modulate current set point voltages 188, 197 used as the reference voltages at the non-inverting inputs of comparators or difference amplifiers 189, 198. The currents through SSL strings 184, 185 are measured by current sensors 190, 199 and are fed back to the inverting inputs of the amplifiers 189, 198, where they are compared with the current set point voltages 188, 197. Switches 191, 192, 200, 201 pull down the non-inverting inputs and outputs of the amplifiers 189, 198 as controlled by the PWM generators 187, 202, modulating control switches 193, 203 to control the PWM duty cycle of the current control circuit 182. The PWM generators 187, 202 can be buffered by switches 193, 199. The amplifiers 189, 198 can also be deactivated by the PWM generators 187, 202, for example by pull-down resistors 195, 205, increasing the efficiency of the current control circuit 182.

One or more of such present inventions can be used with a voltage source 183 to provide specified current to the one or more SSL strings 184, 185, 186. The voltage source 183 can comprise, but is not limited to, a current power supply, a current driver, a constant current driver and/or power supply, a variable constant current driver and/or power supply, a dimmable current driver and/or power supply, etc., which could be but is not limited to one or more of an AC to DC, a DC to DC converter(s), etc. and in some cases a DC to AC or an AC to AC inverter. In some embodiments, the voltage source 183 can be replaced with a current source. One or more of the present invention can be used with the same or different current set points and the same or different PWM duty cycles. In some embodiments as depicted in FIG. 7 an optional diode 196 can be used such that the current which does not go through SSL strings 184, 185 will then go through SSL string 186.

Although the present invention is described in terms of use with lighting application(s), the present invention can be used for other applications including but not limited to applications that require current sharing including but not limited to non-solid state lighting and/or solid state lighting mixed/combined with non-solid state lighting as well as non-lighting applications and uses, etc. The switches/transistors depicted in FIGS. 5-7 are for illustration purposes and are non-limiting and not limited to those implementations shown in FIGS. 5-7.

In some embodiments and implementations of the present invention, diode 128, 178 can be either replaced with a one or more resistor(s) or augmented with one or more resistor(s). In some embodiments and implementations of the present invention, there may be more than one diode 128, 178. In some embodiments and implementations of the present invention, there may be more than one diode 128, 178 performing similar functions on one or more legs/strings/arrays/etc. of the circuits of the present invention. In some embodiments of the present invention, one or more legs/strings/arrays/etc. 102, 104, 152, 154 may be replaced by a resistor, one or more resistors, a short, fewer SSLs such as LEDs and OLEDs, etc. for example only LEDs in SSL string 102, 152 and/or SSL string 104, 154, etc. shown in FIGS. 5 and 6 are used in series with switch 120, 170. In some embodiments, switch 120, 170 may be shorted to the anode of diode 128, 178. In some embodiments, switch 120, 170 may be shorted to the anode of diode 128, 178 which is also at the node of the current source, voltage source, power sources, etc. In some embodiments, switch 120, 170 is or is part of/forms a shunt circuit, switch, network, etc. In some embodiments, switch 120, 170 is or is part of/forms a shunt circuit, switch, network, etc. with one or more diode or equivalent elements such as one or more diode 128, 178 acting as a block to voltage being dropped or brought to zero when, for example, but not limited to switch 120, 170 being turned on and essentially shorted.

Embodiments of the present invention can be used to interconnect lights to provide directions, status indications, emergency conditions, etc., as disclosed in U.S. patent application Ser. No. 16/147,561 filed Sep. 28, 2018 for a “Universal Solid State Lighting System” which is incorporated herein by reference for all purposes. Similarly, embodiments of the present invention can be used as displays to display information, including but not limited to, using back-lit LEDs/SSLs to display information in different color temperatures, different colors, missing/sleeping/turned off LEDs, providing directions by arrows illuminated on light panels, etc. Communication between light panels in a system such as, but not limited to, that disclosed in U.S. patent application Ser. No. 16/147,561, also incorporated herein by reference, can be performed in any suitable manner, such as, but not limited to, LiFi networks using the LEDs in a light panel to create a wireless network, Bluetooth, Bluetooth low energy, WiFi, IEEE 801, IEEE 802, ZigBee, ZWave, other 2.4 GHz and related/associated standards, protocols, interfaces, ISM, other frequencies including but not limited to, radio frequencies (RF), microwave frequencies, millimeter-wave frequencies, sub millimeter-wave frequencies, terahertz (THz), mobile cellular network connections, combinations of these. In some embodiments of the present invention more than one wireless and/or more than one wired communications may be use to provide, for example, but not limited to redundancy, mitigation to blocking/jamming including but not limited to intentional jamming.

In embodiments of the present invention that include or involve buck, buck-boost, boost, boost-buck, etc. inductors, one or more tagalong inductors such as those disclosed in U.S. patent application Ser. No. 13/674,072, filed Nov. 11, 2012 by Sadwick et al. for a “Dimmable LED Driver with Multiple Power Sources”, which is incorporated herein for all purposes, may be used and incorporated into embodiments of the present invention. Such tagalong inductors can be used, among other things and for example, to provide power and increase and enhance the efficiency of certain embodiments of the present invention. In addition, other methods including charge pumps, floating diode pumps, level shifters, pulse and other transformers, bootstrapping including bootstrap diodes, capacitors and circuits, floating gate drives, carrier drives, etc. can also be used with the present invention.

Embodiments of the present invention can be used to retrofit and/or allow lighting, for example, but not limited to solid state lighting of all types as well as non-solid state lighting sources and can, for example, but not limited to, single color temperature or color SSLs such as but not limited to LEDs, OLEDs, QLEDs, combinations of these, etc. and provide the capability to, for example, but not limited to, insert the present invention between the existing power supply, driver, etc. and the existing for example but not limited to SSL elements such as but not limited to strips, strings, arrays, etc. and add additional SSL strips/arrays/strings/etc. so as to take, for example but not limited to, a single dimmable or non-dimmable channel/color/color temperature lighting fixture of any type, form, shape, etc. into, for example but not limited to, one or more of a dimmable, color temperature tunable, color tunable, multi-channel, etc. lighting fixture. Embodiments of the present invention can also have sensors, controls, TOT, speakers, microphones, alarms, buzzers, detectors, one or more cameras, stereo imaging, 3D cameras, imagers, thermal imagers, people counting, smoke alarms of any types and operations/functions, fire alarms, carbon monoxide (CO), carbon dioxide (CO₂), motion, sound, pressure, vibration, noise, accelerometers, vibration, energy harvesting, moisture, humidity, temperature, orientation, global or local positioning sensing (GPS, etc.) other lighting, etc., combinations of these, etc. and can be used for any purpose or purposes including as part of an active shooter detection/protection system/solution, as a lighting as a platform solution, lighting as a solution, for productivity, health, well-being, safety, security, comfort, etc., combinations of these, etc. The present invention can also be used in conjunction with personal lighting including but not limited to task lamps, desk lamps, other lighting sources, personal workspace lighting (PWL) including but not limited to cubical top lights, etc. including wired or wireless. The present invention can be used to also expand a single color temperature to a two or (i.e., multiple) color temperature fixture including but not limited to by retrofitting the fixture with one or more color temperature LEDs/OLEDs/SSLs in general and/or one or more color LED/OLEDs/SSLs, etc. Embodiments of the present invention can also use fluorescent lamp replacements that can also provide power to other lighting elements, sensors, detectors, TOT, sirens, buzzers, speakers, microphones, piezo, etc. including but not limited to wired, wireless, powerline, etc. combinations of these, etc. and can be used to retrofit the retrofits or retrofit existing SSL including but not limited to LED lighting fixtures, luminaires, systems, packs, wall packs, sconce, pendant, recessed, inverted, ceiling facing, downlights, can lights, cove lighting, under cabinet lighting, etc.—essentially any type of lighting and lighting systems including but not limited to new, old, retrofitted, etc.

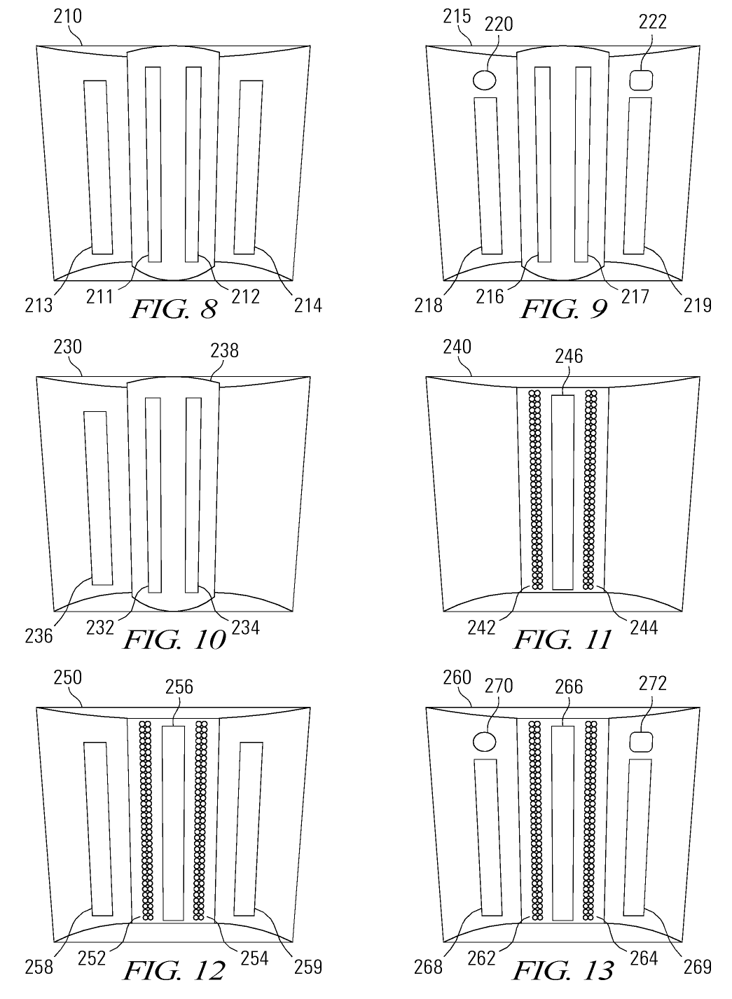

Some non-limiting examples of embodiments of the invention are depicted in FIGS. 8-13. FIG. 8 depicts a non-limiting example of an existing troffer 210 with replacement solid state lighting for which the present invention could be applied to so as to enhance, improve, etc. the functionality, capability of, etc. by adding, for example but not limited to additional SSL, LED, OLED, QLED, etc. lighting that could be single color, single color temperature, multiple color temperature, RGB, RGBA, etc. combinations, etc. Tubes 212, 213 can be replacement solid state tubes such as those described above with respect to FIGS. 3A-3B and 4A-4B or even existing conventional lighting in conjunction with additional solid state lighting strips 214, 215. The additional solid state lighting strips 214, 215 can be additional white, RGB, RGBA, etc., one or more strips, multiple strips, etc.

FIG. 9 depicts a non-limiting example of a troffer 215 where, as with FIG. 8, along with existing tube replacements 216, 217, additional lighting 218, 219 can be added with, in addition but not limited to, sensors, detectors, Internet of Things (IOT) devices, sirens, smoke generators, strobe lighting, speakers, microphones, digital signal processing, smoke detectors, etc. 220, 222 combinations of these, other sensors, IoT, speakers, microphones, sirens, etc. including but not limited to those discussed, herein, etc. Non-limiting examples include but are not limited to sensors, detectors, IOT, speakers, sirens, microphones, including but not limited to one or more motion, sound, gunshot, smoke, light, ambient light, color temperature, color, etc. sensors.

Additional lighting could be additional white, WRGB, WWRGB, RGB, RGBA, WRGBA, etc., combinations of these, etc. one or more strips, multiple strips, etc. Note the light strips, etc. can also have embedded or other types of sensor(s), ambient light sensors, motion, proximity, microwave, infrared, PR, etc., combinations of these, etc. IOT, etc.

As depicted in FIG. 10, non-limiting example embodiments of the troffer 230 can have additional lighting 236 on just one side of the existing tube replacements 232, 234, or on both sides or in other locations. Additional lighting could be additional white, WRGB, WWRGB, RGB, RGBA, WRGBA, etc. one or more strips, multiple strips, etc. In some embodiments of the present invention the lighting fixtures consist of indirect (e.g., facing up/the ceiling, etc.).

As depicted in FIG. 11, a non-limiting example embodiment of a troffer 240 is depicted in which existing fluorescent tubes have been replaced by light strips 242, 244, which may comprise but are not limited to arrays of LEDs, OLEDs or quantum dots, solid state lighting panels, etc. Additional solid state lighting 246 has also been added under a diffusor (not shown in FIG. 11, see, e.g., diffuser 238 of FIG. 10). Such lighting 246 can be single color including but not limited to red, orange, amber, yellow, green, blue, etc. combinations of these, etc.), one or more colors, one or more color temperatures, combinations of these, etc. Note in some embodiments of the present invention the original power supply or driver can be replaced with a new one with greater capabilities or the original one can be left to use and the present invention depicted in the non-limiting examples shown in FIGS. 5-7.

Additional lighting can be additional white, RGB, RGBA, WRGB, WWRGB, WRGBA, etc. combinations of these, etc., one or more strips, multiple strips, etc. Additional lighting strips can be on just one side of the troffer, or on both sides with or without sensors, TOT, etc.

In some implementations of the present invention, the diffusor can be replaced with a higher performance diffusor that for example allows higher levels of light transmission with reduced absorption, etc.

In some embodiments of the present invention, only the lighting under the diffusor is replaced, augmented, added to, enhanced, etc. Again such lighting can be single color or color temperature, multiple colors and/or color temperatures, multiple channels, etc. Sensors, TOT, detectors, microphones, speakers, etc. can also be added to the present invention as well as additional power supply drivers, etc. Embodiments of the present invention can be wired, wireless, powerline, etc. combinations, etc. In some other embodiments of the present invention the added/additional lighting can be added outside the diffuser.

FIG. 12 depicts a non-limiting example embodiment of a troffer 250 with replacement solid state light strips 252, 254 and additional central solid state lighting 256 under a diffuser and non-central solid state lighting 258, 259 which may or may not be positioned under a main diffuser or other diffuser.

Additional lighting, TOT, emergency lighting, sensors/detectors including but not limited to motion, sound, specific sound(s), fire, smoke, heat, frequency, light, color, color, camera, video, temperature, battery or batteries, communications, imaging, thermal, etc., can also be included.

Although the present invention has been discussed in terms of retrofitting existing or new SSL (e.g. but not limited to LED, OLED, QLED, general QD, etc.), the present invention also applies equally well to fluorescent and/or other gas discharge lighting including fixtures of such, etc. and can, for example, but not limited to, be used to retrofit any type of fluorescent lamp/light fixture. Note in some instances, the present invention can be used and applied to both SSL (such as LED, OLED, QLED, etc.) and fluorescent lamp fixtures including but not limited to those being used in the same location and including but not limited to those being used in conjunction with each other as well as potentially with other things, IOT, sensors, detectors, other systems, other platforms, HVAC, security, environmental, lighting sources including but not limited to cubicle top lighting, wayfinder, active shooter, etc., combinations of these, etc. Cubicle top lighting can include, but is not limited to, embodiments disclosed in U.S. patent application Ser. No. 15/885,788 filed on Jan. 31, 2018 for a “Solid State Luminaire Lighting System”, which is incorporated herein by reference.

FIG. 13 depicts a non-limiting example embodiment of a troffer 260 with replacement solid state light strips 262, 264 and additional central solid state lighting 266 under a diffuser and non-central solid state lighting 268, 269 which may or may not be positioned under a main diffuser or other diffuser. Additional lighting, IOT, emergency lighting, sensors of any type, function, purpose, detectors of any type, function, purpose, etc., IoT, flashing lighting, power sources, energy harvesting, 270, 272 can be included including but not limited to motion, sound, specific sound(s), fire, smoke, heat, frequency, light, color, color, camera, video, temperature, battery or batteries, communications, imaging, thermal, etc., others including but not limited to those discussed herein can also be included. In addition embodiments of the present invention can also perform real-time-location-system (RTLS), asset tracking, wayfinding, lighting controls, asset tags, commissioning and install and pairing including but not limited to using near field communications (NFC), continuous integration, automation of the cloud, as well as but not limited to certificate management, application programming interfaces (APIs), communication protocols, machine-to-machine (M2M)/Internet of Things connectivity protocols such as Message Queuing Telemetry Transport (MQTT), facility, message-broker software also called message-oriented middleware such as RabbitMQ, etc.

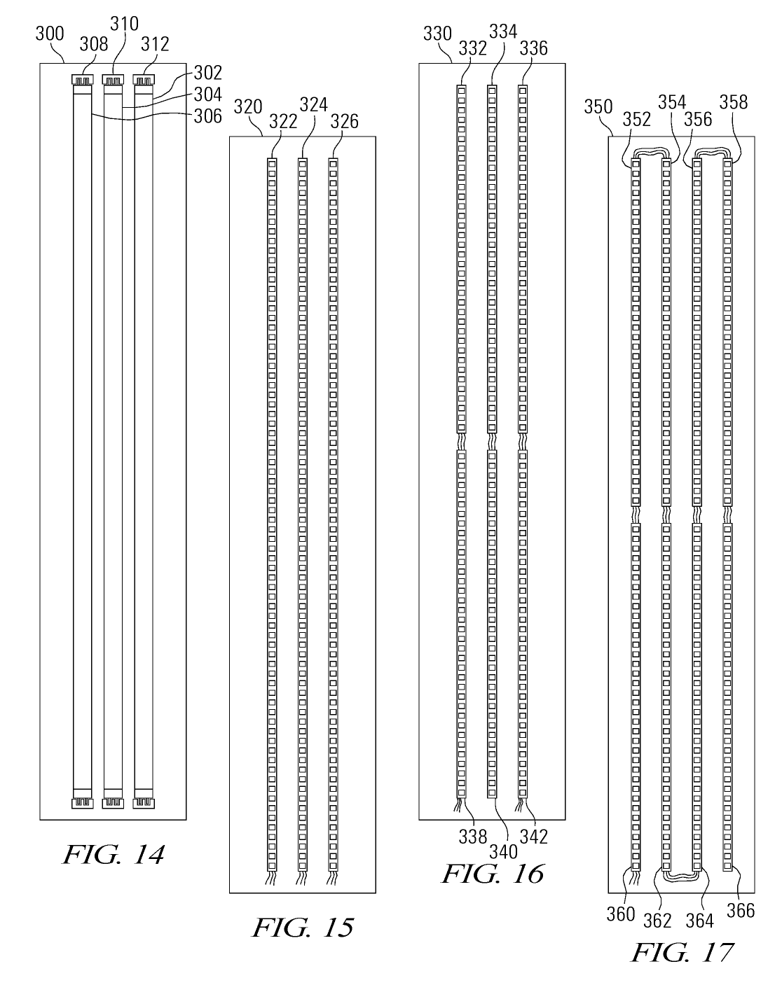

Turning now to FIG. 14, a non-limiting example embodiment of a 3 lamp fluorescent lamp fixture or troffer 300 is depicted with solid state replacement light tubes 302, 304, 306. The light tubes 302, 304, 306 can each include one or more LEDs, OLEDs, QLEDs, QDs, etc. arranged in strings, ropes, edge lit including but not limited to flat, flat panel, and/or cylindrical edge lit, other edge lit form factors and geometries, arrays of SSLs including in any form, fashion, geometry, etc. including but not limited to linear, circular, evenly spaced, randomly spaced, etc. Implementations of the present invention can have one or more color temperatures, one or more colors, can be color temperature tunable, color tunable, white and other colors, white and red and green and blue (WRGB). WRGB plus amber (WRGBA), white plus violet (WV), WVRG, WVRGB, WVRGBA, etc., combinations of these, etc., RGB plus one or more white color temperatures (RGB+W), RGB+W+amber (RGBWA), WWRGB, etc., combinations of these, etc. Other colors include but not limited to mint, yellow, violet, spectrum with blue enriched, spectrum with blue deprived, violet replacing blue. Use of green LEDS/SSLs for reducing the effects of migraine headaches, for use in surgery as well as other applications, etc. Also for use in night vision (IR) applications, etc.

The SSL can be dropped/put in place as a panel, one or more panels, strips, one or more stripes, etc. and can be powered by the ballast(s), directly powered by the AC (e.g., 120 to 277 VAC or lower or higher) power, low voltage DC, solar or other energy sources including but not limited to alternative energy sources, batteries, geothermal, super capacitor(s), etc. For example, as depicted in FIG. 14, the solid state replacement light tubes 302, 304, 306 can be installed directly in the troffer tombstone connectors 308, 310, 312 and can be powered either through the fluorescent ballast, if left installed in the troffer 300, or by a power line, if any ballast is removed, etc. In some embodiments such as upward facing, indirect, light bouncing off of the ceiling, etc., ceiling facing fixtures, etc. no additional diffusers are required, etc.

FIG. 15 depicts a non-limiting example embodiment of a 3 lamp fluorescent lamp fixture or troffer 320 with three LED light strips 322, 324, 326. While each light strip 322, 324, 326 is depicted with three wires to be connected to a power source/controller (not shown), which can draw power from the troffer 320 or from any other suitable source, the light strips 322, 324, 326 are not limited to any particular power source or controller. As non-limiting and non-exclusive examples, the light strips 322, 324, 326 can be powered by the ballast(s), directly powered by the AC (e.g., 120 to 277 VAC or lower or higher) power, low voltage DC, solar or other energy sources including but not limited to alternative energy sources, batteries, geothermal, super capacitor(s), etc.

If the fluorescent lamp fixtures are facing up toward the ceiling, the installation or retrofit can be made simpler and can potentially eliminate the need for optics, diffusers, etc.

The LED light strips 322, 324, 326 can be attached directly to the fixture 320 including by screwing, glue, tape, gravity, etc. any means, etc. Solid state lighting is not limited to strips—any form factor can in general be used.

Implementations of the present invention could for example but not limited to have the same, similar, different, etc. SSL/LED/OLED/QD arrays in a symmetric, non-symmetric, different, same, etc., combinations of these arrangement(s), configuration(s), etc.

There can be combinations of tubes, strips, arrays, panels, etc. in implementations of the present invention including but not limited to one or more color temperatures and/or one or more colors, etc.

FIG. 16 depicts a non-limiting example embodiment of a 3 lamp fluorescent lamp fixture 330 with six LED light strips 332, 334, 336, 338, 340, 342 connected with a combination of series and parallel connections.

FIG. 17 depicts a non-limiting example embodiment of a 3 lamp fluorescent lamp fixture 350 with eight LED light strips 352, 354, 356, 358, 360, 362, 364, 366 in a series connection. Note in any of these figures, which are non-limiting, the number of lamps in a fixture can be 3 as discussed in the previous or one, two, four or more

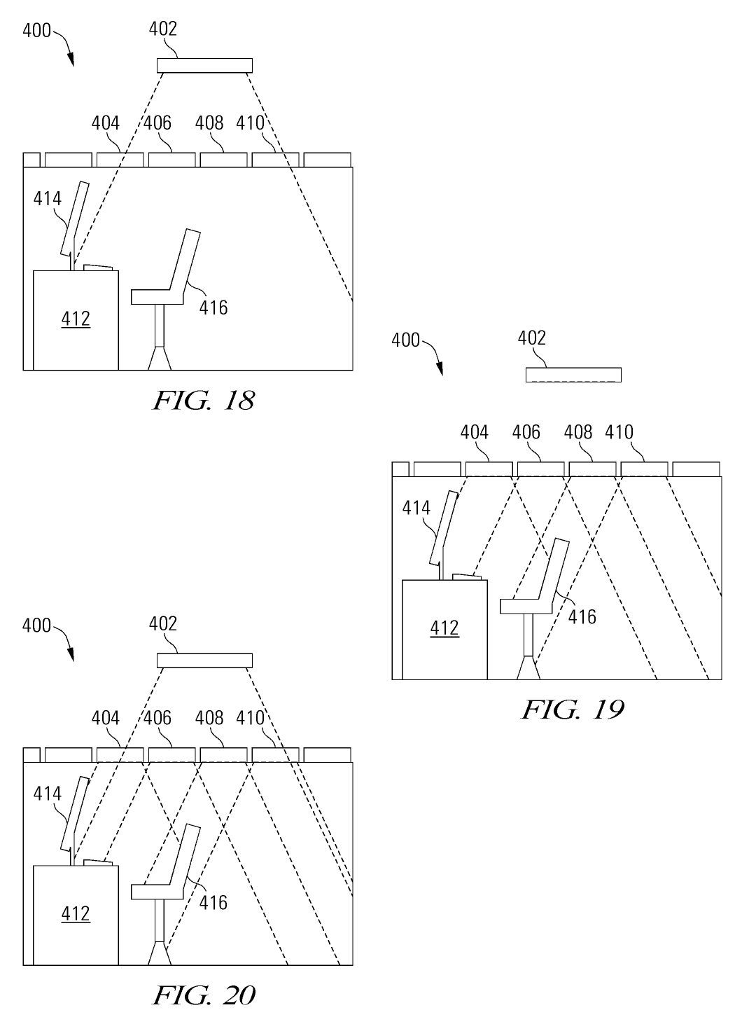

Turning to FIGS. 18-20, a cubicle workspace 400 is depicted with illumination provided by a controllable combination of an overhead solid state light (or personal workspace light) 402 and cubicle top solid state lighting 404, 406, 408, 410. By controlling the illumination individually from overhead light 402 and cubicle top lighting 404, 406, 408, 410, the desired illumination level, color, color temperature, etc. can be provided at various points in the workspace 400, such as on a desk 412, computer 414, chair 416, etc. For example, brighter task illumination can be provided at the top of the desk 412 by the cubicle top lighting 404, 406 nearest the desktop and with more comfortable dimmed lighting elsewhere in the workspace 400 by the overhead lighting 402 and other cubicle top lighting 408, 410. A few non-limiting examples of lighting combinations are depicted in FIGS. 18-20, with only overhead lighting in FIG. 18, only cubicle top lighting in FIG. 19, and a combination of both in FIG. 20.

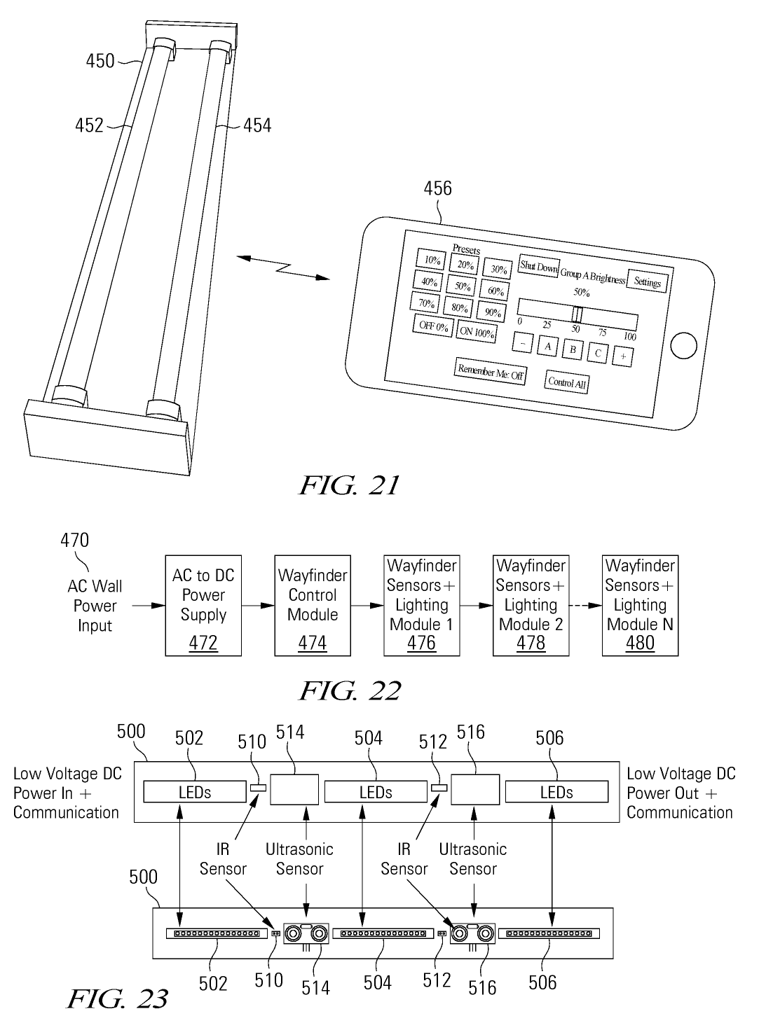

As depicted in FIG. 21, various embodiments of the present invention can be controlled by remote user interfaces, such as, but not limited to, using a smartphone app, an application on a computer, a web browser, a voice recognition system, etc. For example, solid state light strips in fluorescent replacement tubes 452, 454 mounted in a fluorescent lamp troffer 450 can be controlled remotely by an app on a smartphone 456 or tablet, or computer, etc., controlling the luminance, color, color temperature, etc., as well as interacting with sensors or other devices in or associated with the troffer 450. In one non-limiting example, the app provides dimming presets, on/off controls, enables the user to group light sources within the tubes 452, 454 to apply settings to groups of light sources, etc.

Multiple solid state lights in fluorescent lamp fixtures can be combined in a system with sensors and interfaces to, for example, provide directions or guidance to persons walking near the fixtures, for example providing wayfinding services. The block diagram of FIG. 22 depicts an example solid state lighting system for providing wayfinding services, including an AC to DC power supply 472 drawing power from an AC Wall Power input 470 and supplying power to a wayfinder control module 474, which selectively controls lighting modules 476, 478, 480 with wayfinder sensors. For example, if the system is configured to guide a person from a point approaching lighting module 476 to a point near lighting module 480, lighting module 476 can be illuminated or changed to a particular color, guiding the person to that point. As a sensor in lighting module 476 detects the person, the next lighting module 478 can be illuminated or changed to a particular color, guiding the person toward the next lighting module 478. As a sensor in lighting module 478 detects the person, the next lighting module 480 can be illuminated or changed to a particular color, guiding the person toward the next lighting module 480, and so on. Such wayfinding services can be employed, for example, to guide a patient to a particular office in a hospital or school, to guide emergency personnel to the location of an emergency in a school, employees at work, people at home, students at schools and universities, patients at hospitals, clinics, senior living facilities, assisted living facilities, independent living facilities, government offices and buildings, private businesses, public locations, libraries, bathrooms, restrooms, hallways, hospitals, ballrooms, meeting halls, classrooms, cafeterias, lunch rooms, break rooms, lounges, dormitories, parking garages, other public locations, hotels, motels, condos, apartments, assisted living, businesses, markets, restaurants, movie theaters, malls, stores, restroom and bathroom stalls, urinals, sinks, kitchens, showers, baths, warehouses, and/or other small or large building(s), to guide people safely to a destination or destinations. In other embodiments, the wayfinding can be used to guide guests at an amusement park to the location of a show or toward the exit at closing time, or to their car in a parking lot, etc.

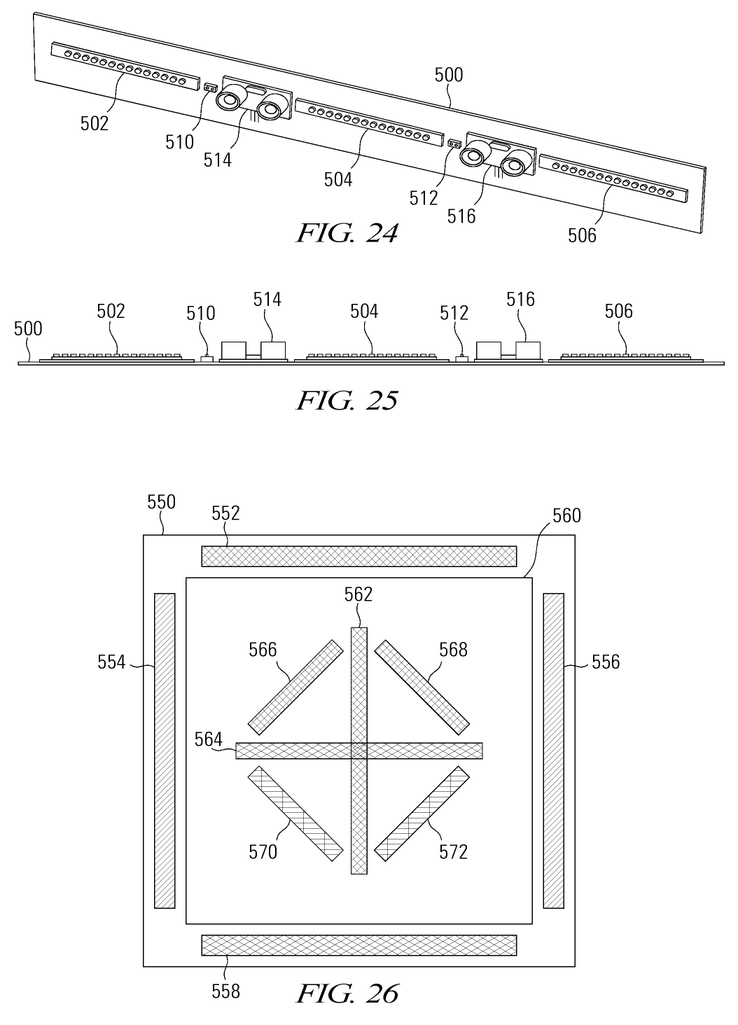

A non-limiting example embodiment of a lighting and sensor module 500 is depicted in FIGS. 23-25, shown in block diagram and graphic depiction. In some embodiments, the lighting and sensor module 500 is powered by low voltage DC power supplied by any suitable source (such a power supply could be but is not limited to Class 2, Class P, etc.), and can receive and transmit commands, status information, etc., using any suitable communications means, whether wired or wireless or a combination thereof. A lighting and sensor module 500 can include one or more individual light sources/strips/arrays/strings/etc. 502, 504, 506, infrared (IR) sensors 510, 512, ultrasonic sensors 514, 516, etc., passive infrared (PIR) motion control sensors (not shown), and associated control and communications electronics, other sensors including but not limited to those discussed, herein, etc.

In some non-limiting example embodiments, the wayfinder LED and sensor board module 500 contains 4 channel LEDs (white+RGB) and infrared and ultrasonic sensors that can accurately determine distance for example but not limited to to less than 1 inch up to 10 feet away. Not shown for clarity are the passive infrared sensors and the control and communications electronics. This module can, for example, but not limited to be the core of the wayfinding system that can support circadian rhythm alignment and no-flicker LED lighting and motion/position and velocity detection and sensing. Auxiliary light sensors can be employed to measure color temperature and optionally color. The modules can be easy to install and support simple setup and operation. The ease of installation is intended to be simple which should also reduce barriers to adoption leading to the resulting true benefits of LED lighting coupled with the enhanced safety and independence that the wayfinding can offer. The modules can be designed to be low cost yet attractive, plug and play, modular, safe, low voltage ultra-high efficient, with full protection including but not limited to over-voltage protection, under-voltage protection, over-current protection, over-temperature protection, short circuit protection, daisy chainable that are controlled by one or more control modules (note in many embodiments only one control module is needed for each wayfinder system; however having two or more control modules ensures and supports no single point of failure). Each wayfinder system can support a number of wayfinder modules, which depending on configuration, could be, for example, up to, for example, 50 or more wayfinder modules. The wayfinder modules can communicate with each other and the wayfinder controller(s) using DC to DC powerline communications thus simplifying the wiring and cabling of the wayfinder system. There are options to extend the sensors out from the module by tethering wires so as to make the modules more flexible and adapting to different situations, scenarios, logistics of room layouts, etc.

This wayfinding module can be part of a wayfinding system that can support circadian rhythm alignment and no-flicker LED lighting and motion/position and velocity detection and sensing. Auxiliary light sensors can be employed to measure color temperature and optionally color. The modules are easy to install and support simple setup and operation. The ease of installation is intended to be akin to playing with Legos should also reduce barriers to adoption leading to the resulting true benefits of LED lighting coupled with the enhanced safety and independence that the wayfinding offers. The modules can be designed to be low cost yet attractive, plug and play, modular, safe, low voltage (for, example but not limited to 5 volts, 10 volts, 12 volts, 24 volts max, 30 volts max, 36 volts max, 48 volts, max, etc.), ultra-high efficient with full protection including but not limited to over-voltage protection, under-voltage protection, over-current protection, over-temperature protection, short circuit protection, daisy chainable that are controlled by one or more control modules (note only one control module is needed for each wayfinder system; however having two or more control modules ensures and supports no single point of failure). Each wayfinder system is able to support a number of wayfinder modules, which depending on configuration. The wayfinder modules can communicate with each other and the wayfinder controller(s) using DC to DC powerline communications thus simplifying the wiring and cabling of the wayfinder system. There are options to extend the sensors out from the module by tethering wires so as to make the modules more flexible and adapting to different situations, scenarios, logistics of room layouts, etc.

The control module is able to communicate using one or more of wireless, wired or powerline communications. The control module was designed to have “slots” to insert/plug-in the various types or communications modules. The wireless communications modules (usually only one type of module is chosen) can include but are not limited to Bluetooth, WiFi, ZigBee, ZWave, non-proprietary encrypted sub-Gigahertz and other modules in the unlicensed International Scientific and Medical (ISM) frequency bands as well as an infrared (IR) communications module as well as others described herein. The wired modules include but are not limited to DMX, DMX512, 0 to 10 V, and USB. The powerline module support, for example but not limited to, X10 and variants as well as higher speed versions of both AC and DC powerline communications. The control module also support longer range communications modules that allows communications with nearby neighbors including friends and family. There can also be cellular modem communications module(s) that support audio communications and optionally audio and video communications over a cell network. The control modules also have the ability to support solar cell charging and battery storage and backup for emergency situation where main power is lost or for off-grid situations.

The wayfinder LED and sensor modules also have temperature and humidity sensors that can be used to detect too cold or too hot conditions or too damp or too dry conditions. The wayfinder system is also able to detect and determine if a person is staying in one place for what would be considered an unusually long period of time. This could be due to a fall or confusion or some other medical reason or even if a large enough object such as a suitcase or sack was put in and blocking the wayfinding path. The array of sensors for the wayfinding modules can discriminate between a sack of potatoes (or a duffle bag, suitcase, etc.) and a human being. The present invention uses methods and approaches to simply and accurately in completely noninvasive and private ways detect, determine and positively identify human movement including human falls. The detection of these types of sensor events can be monitored, logged and stored for further off-line analysis. The modules can be mounted on walls including on baseboards, below or above windows, on door frames, on ceilings and have provisions for mounting flush to a surface or being tiled from the surface, adhered, etc. to surfaces. The wayfinder modules can be incorporated into flooring, walls, ceilings, doors, etc.

This detection capability can be fed to the Monitor/Alert/Alarm Decision Unit that, among other things, can automatically issue warnings, alerts, alarms, etc. including via indoor and/or outdoor lighting, for example flashing, changing colors, etc., via sirens and speakers, etc. Depending on the system configuration, the Monitor/Alert/Alarm Decision Unit can also access the long range wireless communications module(s) and send out alerts, alarms, distress calls, send out distress signals, make audio phone calls, flash or turn lights on or off or, with intelligent lighting options, change colors including at neighbors' houses who are connected to the wayfinder system, etc.

The wayfinder is an excellent choice for Universal Design in both new construction and remodeling. The wayfinder can be used and is of value to both persons with disabilities and persons with abilities.

Simple low cost connected (wireless but not via WiFi or the Cloud directly) thermostats can also be monitored by the Monitor/Alert/Alarm Decision Unit. A bed pressure sensor can also be used with the present invention, Light sensors to measure ambient direct and reflected light including color temperature and color that are use a battery or capacitor charged by solar/photovoltaic cells, a panic button, a decision button and a social button can also be added/included in embodiments of the present invention. Near field communications (NFC) can be used to connect devices and modules and commission, configure, pair, arrange, join, etc.

Gesturing, sound, pattern recognition, clapping, other types of sounds, low frequency filters, bandpass filters, notch filters, high frequency filters, second and higher order filters, sounds, pressure, other types of movements, capacitive sensing and switches, etc. can be incorporated as optional switches including third party switches into the Wayfinder system.

The LEDs used in the wayfinder modules can be designed with diffusers to insure that there is no glare in viewing the LEDs. They can be designed to have no flicker or glare.

The control capabilities can include appropriate algorithms and incorporating elements of artificial intelligence, machine learning, etc.

The products use SSL and/or other light sources, sensors and IR controlled/enabled devices. The solutions also provide ways to control, interact and dim lighting as well as control devices that use infrared-based remote controls for practically any purpose and use including but not limited to heaters, fans, ceiling fans, TVs, VCRs, DVDs, other lights, projectors, cable boxes, satellite receiver, etc.

The control module is able to communicate using one or more of wireless, wired or powerline communications. The control module can be designed to have “slots” to insert/plug-in the various types or communications modules. The wireless communications modules (in some embodiments only one type of module can be chosen) include but are not limited to Bluetooth, WiFi, ZigBee, ZWave, encrypted sub-Gigahertz and potentially other modules in the unlicensed International Scientific and Medical (ISM) frequency bands as well as an infrared (IR) communications module. The wired modules include but are not limited to DMX, DMX512, 0 to 10 V, and USB. Powerline modules support X10 and variants as well as higher speed versions of both AC and DC powerline communications. The control module also supports longer range communications modules which allow communications with nearby neighbors including friends and family. There can also be cellular modem communications modules that support audio communications and optionally audio and video communications over a cell network. The control modules can also support solar cell charging and battery storage and backup for emergency situation where main power is lost or for off-grid situations.

The wayfinder LED and sensor modules also have temperature and humidity sensors that can be used to detect too cold or too hot conditions or too damp or too dry conditions. The wayfinder system also can detect and determine if a person is staying in one place for what would be considered an unusually long period of time. This could be due to a fall or confusion or some other medical reason or even if a large enough object such as a suitcase or sack was put in and blocking the wayfinding path. The array of sensors for the wayfinding modules can discriminate for example but not limited to between a sack of potatoes (or a duffle bag, suitcase, etc.) and a human being and also discriminate between a large animal such as a companion dog. Embodiments of the present invention can use noninvasive and private ways to detect, determine and positively identify human movement including human falls. The detection of these types of sensor events can be monitored, logged and stored including for example but not limited to for further off-line analysis. The modules can be mounted on walls including on baseboards, below or above windows, on door frames, on ceilings and can have provisions for mounting flush to a surface or being tiled from the surface and incorporate the wayfinder modules into floorings.

The detection capability can be fed to for example but not limited to a Monitor/Alert/Alarm Decision Unit that can, among other things, automatically issue warnings, alerts, alarms, etc. including via indoor and/or outdoor lighting, for example flashing, changing colors, etc., via sirens and speakers, etc. Depending on the system configuration, the Monitor/Alert/Alarm Decision Unit can also access the long range wireless communications module(s) and send out alerts, alarms, distress calls, send out distress signals, make audio phone calls, flash or turn lights on or off or, with intelligent lighting options, change colors including at neighbors' houses who are connected to the wayfinder system (which may require a careful and thorough vetting approval process for a neighbor to be connected to the wayfinder system), etc.

The Wayfinder is an excellent choice for Universal Design in both new construction and remodeling. The Wayfinder can be used and is of value to both persons with disabilities and persons with abilities. The wayfinder can also be used, for example, in active shooting applications.

A simple connected (wireless including via WiFi or the Cloud directly) thermostat can also be monitored by the Monitor/Alert/Alarm Decision as well as a bed pressure sensor, Light sensors to measure ambient direct and reflected light including color temperature and color that are use a battery or capacitor charged by solar/photovoltaic cells (and/or other energy harvesting, vibrational, mechanical, wireless power, etc.), a panic button, a decision button and a social button. In some embodiments near field communications (NFC) can be used to connect devices and modules

Gesturing, sound, pattern recognition, pressure, other types of movements, capacitive sensing and switches, etc. can be incorporated as for example but not limited to switches into the Wayfinder system.

The LEDs used in the wayfinder modules can be of very high quality with (for white LEDs) a high color rendering index (CRI), a very high efficacy and designed with diffusers to insure that there is no glare in viewing the LEDs. Performance specs along with the specifications for the wayfinder modules no flicker or glare.

The control capabilities can include appropriate algorithms and can incorporate elements of artificial intelligence and machine learning.

The present invention can use SSL and/or other light sources, sensors and IR controlled/enabled devices and also provide ways to control, interact and dim lighting as well as control devices that use infrared-based remote controls for practically any purpose and use including but not limited to heaters, fans, ceiling fans, TVs, VCRs, DVDs, other lights, projectors, cable boxes, satellite receiver, etc.

Turning to FIG. 26, a non-limiting example light panel or puck 550 is depicted, which can be controlled to display various non-limiting example patterns in accordance with some embodiments of the invention. The light panel 550 can include an outer region with multiple solid state light arrays or panels 552, 554, 556, 558, and an inner region 560 that can include a light panel and/or multiple solid state lights or light arrays or strips 562, 564, 566, 568, 570, 572, each of which can be individually controlled, such as but not limited to turning them on and off individually, dimming, changing color, changing color temperature, etc. Various patterns or symbols or letters can be formed on a solid state light panel 550 or on variations of such as light panel 550. For example, an arrow pointing to the right can be displayed using a combination of light strips 564, 568 and 572. The solid state lights on the light panel 550 can be fabricated in any suitable manner, and packaged in any suitable manner, such as, but not limited to, in surface mount packages that can be soldered to a printed circuit board. Additional components can be included on the front and/or back of the board 416 as desired, such as, but not limited to, current limiting resistors, integrated circuits, capacitors, inductors, addressing circuitry facilitating control of individual light sources, bus or other communication circuits, such as, but not limited to, serial bus receivers, parallel bus receivers, etc., status monitoring and reporting circuits, sensors and detectors of any kind, IoT, power supply or conditioning circuits, batteries, light harvesting devices, solar panels, etc. Connectors and/or wires and/or conductive traces and/or wireless coupling circuits such as, but not limited to, inductors, transformers, etc., can be provided on the board to provide power to and/or from the board, to receive commands, to provide status, to communicate with other light tiles or sensors, light show controllers, devices, etc. The example light panel 550 can be an indicator which could be shaped in any form including but not limited to circles, squares, rectangles, triangles, diamonds, pentagons, hexagons, octagons, polygons, disks, pucks, pans, pancakes, ellipses, etc., combinations of these. Such embodiments of the present invention can be used for example, but not limited to, down lights, can lights, ceiling lights, etc., any type or form of lighting, fixture, bulb, luminaire, etc.

Implementations of the present invention can also use the sensors, detectors, IoT, people counting/counters, stereo imaging, 3D imaging, dust sensors, pollution sensors, WiFi probe requests, BLE sniffing, detection, identification of surrounding BLE devices, etc., cameras and detectors to, for example but not limited to, to form a security system, detect the presence of people and/or animals, environmental conditions such as, but not limited to, temperature, movement, humidity, barometric pressure, scents, etc.

The main light source can be one or more white temperature colors including but not limited to in a flat panel 560 or edge lit or back lit and/or both. Included in the embodiments of the present invention are groups of LEDs or other type of lighting including SSL or others or combinations of these that can, for example, but not limited to provide indications, make patterns including but not limited to arrows, X's, Y's, etc. have one or more colors including RGB, full spectrum, flash, strobe, change color(s) or color temperature(s), etc.

Embodiments of the present invention can be used to provide light, to provide one or more of different color temperatures (color temperature tunable), different colors (color tunable), can indicate information, including direction, location, can be used to align circadian rhythm, path finding, way finding, direction finding, location finding, location tracking, active shooter situations, emergencies, emergency lighting, color adjustment, can be used to reduce jet lag, optimize exposure in airports, including but not limited to waiting areas, gates, check-in area, customs, food services including cafeterias, lounges, baggage areas, bathrooms, restrooms, areas where computers, laptops, phones, etc. are used, etc., train stations, bus stations, essentially any type of travel point, destination, way station, transfer station, hub, travel hub, including and especially all aspects of airports, involving airports, involving long distance travel, involving travel through one or more time zones, multiple time zones, transatlantic, transpacific, transcontinental, different countries, etc. As a non-limiting example, a color tunable implementation of the present invention can be used to, for example, but not limited to, set the light to a warm (low color temperature such as but not necessarily 2700K) to allow passengers to board a flight/plane in the nighttime to travel to a place where upon arrival it will be morning. By using a warm color temperature that is for example, deficient in the blue wavelength/color will promote and support sleep and circadian alignment. In another non-limiting example, passengers traveling in the morning to a destination where it will be later in the day, evening or even night may benefit from a cooler temperature of light which can be strong in the blue wavelength/color spectrum region. The lighting level and color temperature, color(s), spectrum, etc. can be adjusted including but not limited to by algorithm(s), scheduling, setting, using building automation system (BAS) software, hardware, firmware, etc., web-based, cloud-based, automatic, flight/plane selectable/settable, departure/destination/arrival/etc. The lighting can also be used to guide, direct, way find, etc. using light, sound, color, color temperature, flashing, strobing, to an airplane, airline, train, bus, car, other form of transportation, safety, away from danger, toward safety, offer protection, security, identify, detect, monitor, follow, intervene, disrupt, intervene, etc., others aspects of intruders, others, etc. The present invention can be used in conjunction with phones, smart phones, cellular phones, laptops, computers, tablets, other types of personal digital assistants, etc.

The present invention can be used as a part of active shooter system including but not limited to as discussed in U.S. patent application Ser. No. 16/147,561, filed Sep. 28, 2018 for a “Universal Solid State Lighting System”, which is incorporated herein by reference for all purposes. The present invention can be used with other types and embodiments of wayfinding present inventions including but not limited to: being used in conjunction with embodiments of the present invention which act as wayfinder modules that can be attached to walls, ceilings, in some embodiments, flooring and other surfaces that can also be used for people with disabilities as well as people with abilities and can also comply with Universal Design, etc. as well as for emergencies including fire, active shooter, earthquakes, other natural and manmade disasters, etc.

The health, quality of life and independence of the aging and people with disabilities is of critical importance. Without these, the ability to function and flourish is impaired and limited.

There is an unfulfilled need for assistive technology that is affordable, robust, flexible and widely applicable to the aging and people with a diverse variety of physical and intellectual disabilities, traumatic brain injuries, among others.

There is a still unfulfilled need in providing additional assistance technologies to individuals who desire to lead independent living quality lifestyles. Among others these individuals include the aging and people with disabilities. Today, much of the focus of so-called Smart Homes, Internet of Things (TOT) and associated lighting, heating ventilation and air conditioning (HVAC), other environmental controls and monitoring, air quality sensing, home security and protection, etc. is directed at younger generations of home owners including do-it-yourself (DIY) homeowners typically in the Baby Boom generation or younger to millennials living at ‘home’ with their parents or in apartments. Most of the recent innovations and enhancements in these types of technologies are aimed at smart phone/tablet users who are very familiar and savvy with phone apps and are able to navigate the landscape in installing smart/intelligent things' including internet cameras, 3D and stereo cameras including video cameras, motion sensors, people counting, dust sensors, pollution sensors, WiFi probe requests, BLE sniffing, detection, identification of surrounding BLE devices, etc., thermal imagers, other sensors, detectors, lighting, etc. including but not limited to those discussed herein, smart thermostats, etc. which can be challenging and unfriendly to older individuals or persons with diminished capacities who are not adept with smart phones for a number of reasons. In addition, those with poor eyesight or those that have visual or a number of other disabilities are also often left out of this app-based technology. Often the marketplace neglects to address the specific and special needs of the aging and those with certain disabilities. The recent trend of voice activated/recognition devices for the home can require a significant investment in technology and are require a recurring cost model of cloud-based interactions all of which may not be attractive, realistic or practical including financially for aging adults and individuals with disabilities who still desire to be able to lead independent lifestyles and retain their independence and freedom.

The present invention applied specifically to assistive technology that is easy to configure, implement, use and maintain that is also low cost/affordable and has viable non-cloud based and non-recurring cost models as well as models that do involve the cloud and, typically, monthly or annual recurring cost models. The present invention provides affordable, simple to setup and use/operate for the aging and people with disabilities.

The present invention fits in, implements and supports technology that increases access to caregiving for individuals with disabilities; Increased independence of individuals with disabilities in community settings through the development of technology to support access to these settings; Improved health-care interventions through the development of technology to support independent access to community health-care services for individuals with disabilities; Enhanced sensory or motor function of individuals with disabilities through the development of technology to support improved functional capacity; and enhanced workforce participation through the development of technology to increase access to employment, promote sustained employment, and support employment advancement for individuals with disabilities.

Embodiments of the present invention include enhanced assistive technology with advanced sensors, controls and connectivity including intelligent lighting and environmental controls (e.g., simple, low cost, connected thermostat), motion, occupancy, temperature, humidity, air quality, etc. address needs of a highly diverse group of aging and physically and intellectually disabled populations including Multiple Sclerosis (MS), Muscular Dystrophy (MD), Spinal Cord Injuries (SCI), Acquired Brain Injuries (ACI), loss of limbs or functionality, Cerebral Palsy (CP), stroke, cognitive issues, Autism Spectrum Disorders, Fragile X Syndrome, Down Syndrome, Fetal Alcohol Syndrome, Apert Syndrome, Williams Syndrome, Prader-Willi, Phenylketonuria (PKU), genetic and birth related defects and a severe head injury such as traumatic brain injury.

The present invention include low-cost, up-to-date, cohesive assistive technology that also incorporates energy efficiency, is modular and easy to setup, operate and communicate with including for the aging persons and people with relevant disabilities and caregivers.

The present invention is able to aid, enhance and increase the comfort, ability to lead an independent life and lifestyle, decease energy usage and associated costs, provide on open platform including open-source platform to allow aging adults and people with disabilities and their respective families to lead a socially active and rewarding life coupled with the ability to more fully use assistance technology for the betterment of their lives and others associated with them

The present invention includes and involves implementing assistance/assistive technologies to further enhance and support the independent living and lifestyle choices of aging and people with disabilities coupled with the efficient use of electricity and HVAC in residential housing while also further supporting social networking and security and protection. There is a need for novel and inexpensive solutions that accelerate the adoption of energy efficient and environmentally green technology. The lighting component of the present invention can use highly efficient solid state lighting (SSL). SSL is inherently digital and easily made compatible with modern electronics, sensors and control systems, yet this important aspect of SSL has failed to be fully exploited in installed systems. Implementations of the present invention include but are not limited to the needs, requirements and desires of the aging and people with disabilities groups/populations using advanced controls and sensors. By exploiting systems, components, sensors, firmware and software approaches, the use of components including sensors, control algorithms, and even applications for common digital platforms that provide control functionality to products and control and automation specifically aimed at the aging and those with disabilities. The present invention allows useful and energy saving applications specifically aimed at and targeted for the aging and people with disabilities that provides access to the enormous and powerful distributed computational capabilities of present and future SSL systems, components and sensors.

The present invention can use sensors and control hardware that are easily integrated, incorporated, and/or used in conjunction with SSL systems specifically focused on the needs of the aging and individuals with disabilities to permit a better quality of independent living. Implementations of the present invention provide modular solutions and kits some of which must be selected at time of manufacturing, some of which can be added and are field-installable without the need for experience or knowledge of advanced electronics or the details of SSL systems—and all of these modular solutions can be cost effective and can provide additional energy savings. An optional but not necessary component of the control firmware, hardware and software is additional processor capability that can also be easily integrated into SSL systems.

Some of the implementations of the present invention can employ adaptive sensors and controls that communicate typically at low data rates with low data content to achieve substantial energy usage reduction for a wide range of lighting and other products including both SSL and non-SSL lighting and other products. Such a family of modular products can, among other things, reduce energy consumption and cost as well as providing enhanced performance and functionality to the aging and people with disabilities end users. The present invention can be highly energy efficient, low-cost to manufacture and price enabling as well as open source and intentionally designed to work with numerous platforms, including large tactile buttons for those who may have restricted or limited motor functionality/capability, smart phones (i.e., iPhones, Androids), tablets (i.e., iPods, Androids), computers, simple-to-use remote controls, both smart and dumb (with a wireless interface) TVs including dumb legacy TVs that are only NTSC-compatible (and not HDTV-compatible) as well as HDTVs. Embodiments of the present inventions can be available, for example, fully assembled, tested and ready-to-plug-and-play modules and ranging from low-tech to very high-tech. The present invention can make use of but does not require the internet or internet protocol (IP) addresses to operate; however optional choices and accessories allow internet and/or cloud connectivity if so desired. Embodiments of the present invention include modular lighting dimmers for both wall voltage dimmable lights such as incandescent lamps and LED lamps. Embodiments of the present invention can provide smart/intelligent light bulbs that can be dimmed directly by the same digital signal as the modular lighting dimmer. Implementations of the present invention include but are not limited to low voltage color temperature tunable (e.g. but not limited to, from 2200 Kelvin to 6500 Kelvin) LED lighting.

Implementations of the present invention can incorporate Family and Friends (and Neighbors too) into the Assistive Digital Community of Things. This is focused on communications aspects and associated technical components and solutions of the assistive technology. The communications include the ability to, for example, reach a neighbor or one or more neighbors using radio frequency (RF) in the sub-gigahertz (sub-GHs) frequency that are capable of generating and receiving raveling a distance that is more than sufficient to typically reach on or more neighbors.

Embodiments of the present invention include but are not limited to uses for both physical and intellectual disabilities and can include methods to contact neighbors, friends and families by algorithmic (software) and ‘Panic’ and ‘Advising’ buttons that wirelessly transmit/send information to notify/alert. Some of the lighting aspects of the Wayfinding include lighting which is often a neglected area in general for people with disabilities (of course there is specific research and studies pertaining to specific conditions such as Alzheimer's, Parkinson's and other groups including segments of the aging and visually impaired, etc.).

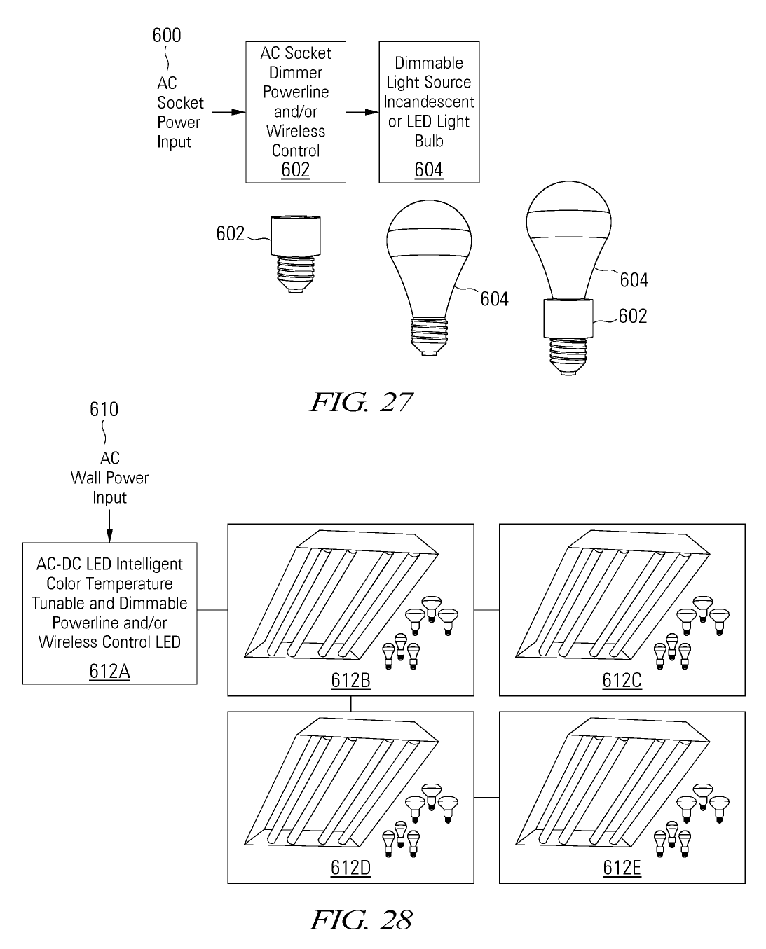

Turning now to FIG. 27, a block diagram and graphical depiction of a dimmable solid state lighting system with optional Edison lamp base adapters is shown. An AC socket power input 600 provides power to an AC socket dimmer with optional powerline and/or wireless control 602, which controls and powers a dimmable light source 604.

RF and/or IR control signals can be used with a dimmer circuit that can take/accept a dimmable bulb of any type or form including Edison socket lamps such as A-lamps, PAR lamps, MR16, R lamps as well as any type of incandescent or halogen lamp, etc.

FIG. 28 depicts a non-limiting example of a solid state security lighting system with incorporated dimmers. An AC wall power input 610 (or any other suitable power source) powers a number of solid state lights 612A-E, each of which can include AC-DC power supplies, powerline and/or wireless or other control communications, and each of which can be intelligently and individually color tunable and dimmable, for example but not limited to tuning color temperature from 2200K to 6500K or beyond. Any type of form-factor lights can be used, such as, but not limited to, any type of A-lamp, PAR, R, etc. lamp, linear tube, flat panel, etc.

Embodiments of the present invention provide means to improve circadian rhythm by providing the appropriate wavelengths of light at appropriate times.

The present invention can use internal and external photosensors, optical sensors, electromagnetic wave sensors, and/or light sensors including wavelength specific or the ability to gather entire or partial spectrum, etc.

The products can also have sirens, microphones, speakers, emergency lights, flashing lights, strobing lights, sensors including, but not limited to, temperature sensors, humidity sensors, moisture sensors, noise sensors, light sensors, spectra sensors, infrared sensors, ultraviolet sensors, speech sensors, voice sensors, ultrasonic and infrared motion, color, audio sensors, other types of motion sensors, acoustic sensors, ultrasound sensors, RF sensors, proximity sensors, sonar sensors, water leak sensors, stereo imaging, 3D cameras, people counting/counters, dust sensors, pollution sensors, WiFi probe requests, BLE sniffing, detection, identification of surrounding BLE devices, etc., combinations of these, etc. In some implementations, if smoke or fire is detected, the lights that are connected to the system it can flash on and off, can change color, can dim and then go brighter, etc. as well as speakers issuing warnings and contacting friends and family, neighbors and others as well as, in some cases, 911 or the fire department, or combinations of these, etc. Implementations of the present invention can also act as a burglar alarm/intruder detection system that can be connected to neighbors, friends and family to alert in the event of motion and/or other intrusion detection/sensing. The present invention can alert with buzzers, alarms, lights, etc. and can share, analyze, react, compare, determine data, information, detection including patterns, etc. for one or more houses, residences, apartments, condos, etc. and make local, global, etc. alerts, messages, etc. including burglar, intrusion, fire, smoke gas, carbon monoxide monitoring and response.

Embodiments of the present invention can use Inverse Universal Design that is to flip the concept of Universal Design to first design with the focus being on meeting the specific needs of the aging and people with disabilities and then expand the design to be inclusive of all people regardless of their level of abilities or lack of disabilities. The definition of Universal Design is “the design of products and environments to be usable by all people, to the greatest extent possible, without the need for adaptation or specialized design. The intent of the universal concept is simply life for everyone by making more housing usable by more people at little or no extra cost. Universal design is an approach to design that incorporates products as well as building features and elements which, to the greatest extent possible, can be used by everyone. The universal design concept targets all people of all ages, sizes, and abilities and is applied to all buildings”. The present invention can also include but is not limited to designing universal features with, again, first focusing on features specific to the needs of the aging and people with disabilities. A universal feature is any component of a house that can be used by everyone regardless of their level of ability or disability.

The internal systems of the product designed specifically for the needs of the aging and people with disabilities can be used in and applied to an universal design with modifications (if any) being in the user/human interface. Depending on the level of modification, it may be that a specific product for the aging and the people with disabilities may also be/become an universal design product.

The present invention can include a Community of Care, Compassion and Communication—that meet the needs of the aging and people with disabilities by taking into consideration all aspects in a holistic way.

Another guiding principle is Being and Staying Social in that everything that is implemented contribute to the socialization in general of the aging and persons with disabilities.

An important and practical consideration is Openness in a Safe World—in that it is imperative to seriously and sincerely take into consideration all levels, layers and types of security including but not limited to physical security and cyber security. Although this is true for everyone including people with abilities it especially true for the aging and people with disabilities as the aging and those with certain disabilities can be, among other things, in general more susceptible, vulnerable, prone and potentially negatively impacted and affected due to a number of reasons which may include being more trusting, diminished intellectual abilities, diminished reasoning abilities, etc. Also many of the persons in this group are not computer or tech savvy which can further exasperate the security risks and associated vulnerabilities. Therefore the present invention has secure features in terms of, but not limited to, encryption and to provide physical security by considering ways to make the devices, products, solutions able to also provide physical security and protection as much as practically possible.

Light for assistive technology for people with disabilities is important. It is clear that having LED lights is very beneficial for people with disabilities; however the quality of the light including color temperature (CCT), color rendering index (CRI), level of flicker, efficacy, efficiency, and glare as well as other parameters are something that is often assumed to the right choice with no real specializations listed. The present inventions are flicker-free (or as close as possible to) color temperature tunable/changing LED lighting and optimally color tunable with at least four if not five or more channels—e.g.: white, red, green, blue, amber) to be beneficial and not harmful when it comes to proper lighting for the aging and people with disabilities (as well as people with abilities).

The present invention supports and embodies the importance of light and light as a platform for assistive technologies

To appropriately synchronize daily rhythms in behavior, physiology and brain functioning with environmental time, terrestrial species have evolved an endogenous, circadian (from the Latin circa—about and diem—a day) timekeeping system. Circadian rhythms are generated by a hierarchy of central and peripheral oscillators with the suprachiasmatic nucleus (SCN) of the anterior hypothalamus acting as the master circadian pacemaker. The circadian system evolved such that environmental light input from the retina synchronizes internal timing, with the daily environmental cycle of sunlight and darkness as the primary synchronizing events.

The advent of artificial lighting has led to unnatural light exposure and persistent pattern changes (examples include general lighting, cathode ray tubes, flat panel TVs and lighting, liquid crystal displays, computers, cellphones, digital tablets and airline travel) that have impacted circadian rhythms and sleep physiology. Numerous findings indicate that these changes have led to some degradation of mental and physical health among human populations. For example, flight attendants frequently traveling across time zones exhibit gross cognitive deficits associated with reductions in temporal lobe structures. Likewise, numerous studies indicate that circadian disruption leads to an increased incidence of cancer, diabetes, ulcers, hypertension and cardiovascular disease, and a degradation of mental health. Finally, it is clear that exposure to artificial light at night causes circadian rhythm misalignments leading to cognitive decline, increased incidence of depression and anxiety disorders, and a host of metabolic disorders. These findings also apply to the aging and people with disabilities and, in many in ways, especially and particularly to these groups.

Circadian rhythm misalignments are known to affect response time, judgment and planning, as well as psychomotor skills, and can increase the prevalence of stress. Some of these problems are closely associated with people with intellectual disabilities as well as other groups. Many of those with intellectual disabilities suffer for poor sleeping habits, with the resultant inability to obtain a deep REM sleep (a restful necessity) at night.

Circadian rhythm reset is not likely to solve all aspects of sleeping problems and issues, but could restore this key pathway which has far-reaching involvement with the HPA axis, metabolism, etc. Lighting can provide other therapies (such as light adjustments, etc.) as well as to enable health professionals to determine more specific aspects of the circadian disruption. Implementations of the present invention can be used to intervene by changing the ambient light to establish the circadian rhythm using quantitative color temperature (in kelvin) and 4 channel or higher color in general, visible lighting that can be easily installed in home and work environments and can also have portable versions. The present invention provides advances in assistive technologies to develop an integrated circadian rhythm regulation device.

By developing strategies to correct/mitigate disruptions to circadian function and misalignment between endogenous cycles in circadian and sleep physiology with the external environment, one can recover diminished human performance as well as improve human health, reduce risk of disease, and enhance cognitive functioning and performance. The wayfinding can also be utilized as a personal circadian rhythm monitor and regulation device capable of rapidly disrupting and/or realigning the circadian rhythm of the user to the local environment. In other situations the system adjusts the user to the work, mission or sleep cycle requirements, leading to improved sleep, reduction of off-sleep-time napping and better performance. This system can also be able to continuously measure and collect data indicative of circadian phase and uses these data to determine both when to apply certain types of light (i.e., wavelengths) and also drive the presentation of light of appropriate wavelengths during optimal times in the circadian cycle known to maximize circadian adjustment and sleep quality and work productivity. Additionally, the data the device collects can be self-reported for periodic examination of cognitive function and decision making to further enhance light presentation.

Such technology can be implemented whereby the wayfinder system could also optionally communicate with wirelessly-controlled lighting that fits directly into conventional legacy light fixtures (without any changes in the electrical wiring or overhead lighting or lamp design). For example, but not limited to, these LED and OLED lighting sources can change from ‘white’ light illumination to any color combination of white light plus primary colors such as red, green, blue (RGB) or red, green, blue, amber (RGBA) depending on the needs. Independent of the control, these product families can have built-in features and functions including global time, alarm clock mode, scheduling, synchronization with local time, daylight harvesting and occupancy sensing. These LED and OLED light sources are inherently portable, can be fully deployed typically in a time frame of minutes and easily integrate to locations in conjunction with and connected to the sensors including and especially the optical and ambient light sensors including intensity (lux), color temperature and/or color tunable sensors to provide light feedback for circadian rhythm regulation and performance. In addition they are rugged, highly reliable, provide controlled dimming and can withstand repeated on/off cycles with no impact on life expectancy. These white or whites plus RGB LED light sources (i.e., A-lamp, PAR 30 and fluorescent lamp replacements that directly plug into existing ballasts) can also be for use as part of the circadian rhythm regulation device and system, as with all of lighting, it can be directly ‘plugged’ into either a conventional Edison socket (i.e., an E-26 ‘light bulb socket’) or in place of, for example, a 4 ft. linear fluorescent tube lamp directly ‘plugged’ into the ballast with no wiring changes needed (literally as simple as changing a light bulb—note other sizes such as 2 ft. and 3 ft. linear tubes and also U-bend lamps can also be used). To facilitate wake onset and morning circadian phase resetting, a lighting choice with a significant blue color component is selected. To promote sleep onset and permit the nightly evening rise in melatonin a color choice essentially devoid of blue color is selected.

The firmware and software frameworks for simple feedback control can also include and be adaptive decision-making, advanced dynamic feedback, data-logging and secure long-term storage. The software framework can be designed to be interoperable and multiplatform compatible in the end state. Design requirements developed incorporate protections for personally identifiable information and health care privacy regulations and to run on a number of platforms. All data regarding individual users is to be treated and designed to be kept private with encryption and tamper-resistant access permission.

Systems engineering considerations for accuracy, reliability, and robustness with system cost awareness, modularity and portability are included in the design process and reflected reporting activities. The system allows virtually any level and ‘size’ of lighting from highly compact lighting that is only a few inches square weighing much less than one pound that can be powered by, for example, batteries to LED lighting that can be quickly and easily installed in apartments, condos, dormitories, bedrooms, entire houses, apartment buildings, independent living and assisted living facilities, others including but not limited to those discussed herein as well as but not limited to office buildings of practically any size.

Implementations of present invention have data management include but are not limited to integrate, log, archive and catalog data including data management for collected information from, for example, but not limited to, other sensor(s) information, the information gathered from the circadian rhythm detector(s), and the control status information along with date, time and location stamps is stored (e.g., in Flash memory, solid-state drives, USB ‘thumb’ drives, SD cards, hard drives, etc.). This information can also be synced up to store on additional mobile devices, smart phones, laptops, PDAs, computers, laptops, etc. to, among other purposes, allow health professionals (after addressing privacy matters) further evaluation.

Supported features/functions can include, but are not limited to, as an example, an alarm clock mode with blue wavelength light content to facilitate waking and, for night-time/bed time, a blue wavelength light content off with longer visible wavelength to support and maximize circadian rhythm phase alignment which may also reduce and mitigate or even eliminate in some cases ‘daytime’ napping and onset of sleep states. For example; including white plus color changing such that, for example, the white and blue LEDs can be selected (enabled) or deselected (disabled) depending on the phase of the circadian rhythm and other measured and available signals and information. Implementations of the present invention can be synchronized with for example but not limited to a real time clock, the web, the cloud, one or more of these, etc., combinations of these, etc. Implementations of the present invention can use such clock timing information to update and change the color temperature, color, etc. of the light for example as a function of time of day or night, etc.

Sensors including, but not limited to, daylight harvesting sensors, other photo/light sensors, motion/occupancy sensors, other environment/ambient sensors, stereo cameras, 3D cameras, thermal imaging, people counting/counters, dust sensors, pollution sensors, WiFi probe requests, BLE sniffing, detection, identification of surrounding BLE devices, etc. can be used. Drowsiness/onset of sleep deprivation and circadian rhythm regulation system to prompt, notify, alert the user if an inappropriate light source such as, for example, a smart phone/tablet or television set is detected that is emitting inappropriate wavelengths for that part/phase of the circadian rhythm cycle. If the user does not respond to the prompts, notifications and/or alerts, the circadian rhythm regulation system will attempt to modify the offending light source to be circadian rhythm cycle phase-compliant.

Edge lit panels are also an excellent choice for light therapy both for ‘wake-up’ (enhanced blue ‘color’ wavelength) and ‘sleep’ (depressed or eliminated blue ‘color’ wavelength) modes of lighting to support circadian rhythm reset, entrainment, maintenance, etc. The panels can be wirelessly dimmed and controlled including color-changing and can be either AC line or, for smaller panels, battery powered including optional battery charging using solar energy. portable wireless controlled lighting for the circadian rhythm regulation system set to (a) white, (b) blue (for wake-up), (c) green, (d) red, (e) yellow (for blue-free light to promote sleep) and (f) amber-orange (also for blue-free light to promote sleep). It is understood that actual environment(s) could be highly variable (e.g., while sleeping, traveling, portable locations, etc.) as well as fixed environments (home, apartments, longer-term temporary quarters and housing, recovery facilities, nursing homes, retirement homes, centers, interim facilities, senior homes, senior care, short term recovery, long term recovery, hospice, clinics, health spas, gyms, locker rooms, swimming pools, athletic facilities, training facilities, etc.) as well as but not limited to others discussed herein.

The products based on the present invention can also have sirens, microphones, speakers, emergency lights, flashing lights, strobing lights, sensors including, but not limited to, temperature sensors, humidity sensors, moisture sensors, noise sensors, light sensors, spectra sensors, infrared sensors, ultraviolet sensors, speech sensors, voice sensors, stereo cameras, 3D cameras, thermal imaging, people counting/counters, dust sensors, pollution sensors, WiFi probe requests, BLE sniffing, detection, identification of surrounding BLE devices, etc., ultrasonic and infrared motion, color, audio sensors, other types of motion sensors, acoustic sensors, ultrasound sensors, RF sensors, proximity sensors, sonar sensors, water leak sensors, combinations of these, etc. In some implementations, if smoke or fire is detected, the lights that are connected to the system it can flash on and off, can change color, can dim and then go brighter, etc. as well as speakers issuing warnings and contacting friends and family, neighbors and others as well as, in some cases, 911 or the fire department, or combinations of these, etc. The products can also act a burglar alarm/intruder detection system that can be connected to neighbors, friends and family to alert in the event of motion and/or other intrusion detection/sensing. Can alert with buzzers, alarms, lights, etc. and can share, analyze, react, compare, determine data, information, detection including patterns, etc. for one or more houses, residences, apartments, condos, etc. and make local, global, etc. alerts, messages, etc. including burglar, intrusion, fire, smoke gas, carbon monoxide monitoring and response.

The present invention involves lighting and controls with sensor and Internet of Things (IoT) integration, developing smart platforms. The present invention also addresses unmet needs of persons with disabilities including those living independently and occupants of assisted living facilities (including mainstream and disabled elderly) and provides way finding in a digital age for numerous applications including but not limited to those discussed herein.

Implementations of the present invention address those with a poor ability to navigate and locomote in familiar or unfamiliar environments, particularly as it relates to getting in and out of bed. The present invention provides an integrated platform that uses a motion sensor to detect when a resident gets out of bed, and gradually increase the ambient light level (at a preferred or specified color or color temperature) to assist them in doing so. This can then be coordinated with the illumination of wall, cove or other lighting of a specified color and/or lighting pattern to assist the person in wayfinding (finding their way) to a bathroom or other destination safely so as to get to the destination and not fall down in doing so. The wall and or cove lighting can create a lit pathway to the room, and pre-illuminate the bathroom. This lighting can be embedded in walls and surfaces, the floor, the baseboards, handrails, etc. It would then operate in reverse to guide them back to bed. The same can be applied to other parts of the home.

The wayfinding system can is quasi-universal for the aging and people with disabilities including both physical and intellectual disabilities as well as people with abilities and can include methods to contact neighbors, friends and families by algorithmic (software) and ‘Panic’ and ‘Advising’ buttons/notifiers.

Some highlights and advantages of the wayfinder system include:
Decrease the likelihood of falls.
Minimize the likelihood of disorientation.
Decrease the need for outside supervision, lessening the burden placed on health providers.
Decrease the chance that a person will navigate to the wrong place.
By coordinating the spectrum and intensity of light at the target location (e.g., bathroom), there will be a decreased risk of circadian disruption, resulting in better overall health state.
By ensuring accurate wayfinding and minimizing falls and disorientation, insurance liability (and associated premiums) will be decreased.
Relies on non-cognitive engagement making it simple for anyone to understand and follow (no thought involved—just follow the light)
Sensors can monitor the progress of the occupant to ensure they reach the destination successfully and send an alert in the event of a problem.
This system can be sending information coordinated with the lighting to inform the occupant, as well as collecting information about the occupant to a central hub or caretaker.
The core platform serves three distinct sub-groups of the assisted living population; the elderly, a younger population with diminished capacities, and the rehabilitative care population (persons in the process of recovery of function following trauma or injury).
This core platform can be used for the special needs of the disabled or impaired population, but readily applied in the marketplace for hospitals, hotels and hospitality, enhanced in-home care (e.g., as people “sundown” at bedtimes), visitors to prisons and military bases (guiding people correctly to where they are supposed to go, and monitoring them to ensure they get there and don't go somewhere else), etc.
This can be built out with a variety of other sensors serving other purposes.

Accuracy, reliability, and usability can also be assessed using controlled and rigorous methods. Protocols can be used in dynamic, interactive, multimedia formats suitable for effective comprehension by technology stakeholders and users. The present invention can be cohesive, connected assistive technology that also supports personal circadian rhythm regulation. This product family also seamlessly integrates with other peripheral device(s), including in some optional cases web-based and Smartphone/tablet applications, and provide additional feedback and monitoring tools for long-term health assessment. In addition the assistive technology solutions are designed so as to be integrated into universal design commercial systems and marketed to commercial consumers for, among other things, improving open source energy efficiency, general health, the quality of light, circadian rhythm and to various commercial business entities and consumers for improving general health of assisted living, retirement homes, senior living facilities, shift workers, students in classrooms, airports, train stations, bus stations, boat docks, ship docking, ship stations, other transportation stations and hubs, hospital patients, workers in controlled lighting areas, sleep deprived individuals and aviation operators and eventually ships and their crew and passengers, trains and their crew and passengers, long haul buses and their passengers, aircrew and their passengers, etc. and related and other forms of indoor and outdoor lighting systems and solutions including but not limited to those discussed herein.

The system can be used in various indoor applications for the intent of assistive technology assessments and demonstration. The lighting allows virtually any level and ‘size’ of lighting from highly compact lighting that is only a few inches square weighing much less than one pound that can be powered by, for example, batteries to LED lighting that can be quickly and easily installed in apartments, condos, dormitories, bedrooms, entire houses, apartment buildings, independent living and assisted living facilities and office buildings of practically any size.

Implementations of the present invention can for example but not limited to integrate, log, archive, catalog data. The data management for collected information includes but is not limited to the sensor(s) information, the information gathered from the circadian rhythm detector(s), and the control status information along with date, time and location stamps is stored (e.g., in Flash memory, solid-state drives, USB ‘thumb’ drives, SD cards, hard drives, etc.). This information can also be synced up to store on additional mobile devices, smart phones, laptops, PDAs, computers, laptops, etc. to, among other purposes, allow health professionals (after addressing privacy matters) further evaluation.

Implementations of the present invention can include and, for example, support and have features/functions including, as a non-limiting example, an alarm clock mode with blue wavelength light content to facilitate waking and, for night-time/bed time, a blue wavelength light content off to support and maximize circadian rhythm phase alignment which may also reduce and mitigate—or even eliminate in some cases ‘daytime’ napping and onset of sleep states.

For example, the white and blue LEDs can be selected (enabled) or deselected (disabled) depending on the phase of the circadian rhythm and other measured and available signals and information. Perform addition validation based on simulated situations.

The sensors include daylight harvesting sensors, other photo/light sensors, motion/occupancy sensors, other environment/ambient sensors, etc. The drowsiness/onset of sleep deprivation and circadian rhythm regulation system can prompt, notify, alert the user if an inappropriate light source such as, for example, a smart phone/tablet or television set is detected that is emitting inappropriate wavelengths for that part/phase of the circadian rhythm cycle. If the user does not respond to the prompts, notifications and/or alerts, the circadian rhythm regulation system will attempt to modify the offending light source to be circadian rhythm cycle phase-compliant.

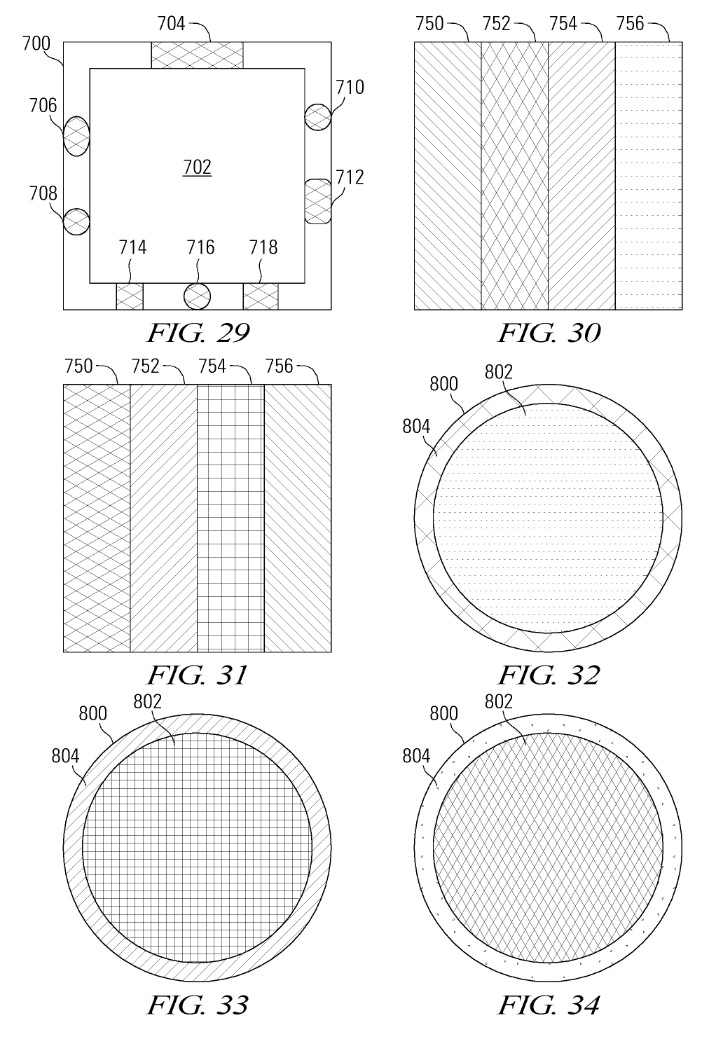

Turning to FIG. 29, a non-limiting example embodiment is depicted of a solid state light panel with a plurality of light sources and/or strips or panels 702, 704, (e.g., main lighting and border lighting) and with sensors and/or other devices 706, 708, 710, 712, 714, 716, 718, such as, but not limited to, sensors, IOT, etc., combinations of these, etc. The light sources and/or strips or panels can have different regions controlled individually/separately and have different combinations of colors and/or color temperatures as well as different dimming/intensity levels.

Such different regions can be a few or many or dozens or hundreds or more. The present invention can use sensors, indicator lights, IOT, microphones, batteries emergency lights, speakers, emergency lights and indicators, IR transmitters to control lights, projectors, TVs, audio visual (AV), etc., people counting/counters, dust sensors, pollution sensors, stereo vision cameras, 3D camera configurations, other types of cameras, infrared, imagers, smoke detectors, carbon monoxide detector(s), carbon dioxide detector(s), temperature, humidity, imager(s), etc. along, in the frame, etc. that can also be powered by the light as depicted but not limited to the light panel depicted in FIG. 29. The present invention can also use, for example but not limited to, WiFi and use WiFi probe requests to obtain, for example, MAC addresses, SSID, signal strength RSSI as well as other information from WiFi enabled devices such as smart phones, iPhones, tablets, etc.

The present invention can be used to replace or in place of the lens or diffuser of a fixture including a fluorescent lamp fixture. The fluorescent lamp fixture can be of any type and shape. The present invention can attach, connect, plug, slip, slip in, insert, hang, clip, etc. into the existing fixture. The present invention can use a flat panel such as an edge lit LED panel a back-lit LED panel, a combination of back lit and edge lit, etc. The present invention can use the fixture to provide heat sinking. The present invention can be powered by the ballast, powered by AC, powered by solar and/or other alternative energy sources, batteries, fuel cells, etc., combinations of these, etc.

The present invention can also provide a battery eliminator, charger which can be any size including coin cell and can be powered by one or more sources of power for example derived from the lighting itself including fluorescent lamp replacements that plug into the sockets of the fluorescent lamp ballasts, or a solid state lighting replacement for other types of incandescent, fluorescent, HID, etc. lighting.

The present invention supports sensors, controls, IOT, etc. including but not limited to motion, sound, PIR, acoustics, ultrasonic, ultrasound, radar, sonar, microwave, RF, microphones, digital filters, smoke, fire, speakers, sirens, strobes, strobing the lights, flashing the lights, changing the color of the lights, changing the color of part of the lights, changing, flashing, etc. the color of part of the lights, etc., combinations of these, voice, voice recognition, pattern recognition, image, image recognition, camera(s), infrared, spectrum, record, log, store, analyze, predict, use artificial intelligence, machine learning, people counting, dust sensors, pollution sensors, WiFi probe requests, BLE sniffing, detection, identification of surrounding BLE devices, etc., virtual reality, augmented reality, etc., combinations of these, etc.

Embodiments of the present invention can include lighting that for example but not limited to displays information, images, different colors including a white color temperature and other colors such as red, green, blue, amber, yellow, mint, rose, combinations of these, etc.

The present invention can also include, use, etc. active denial, anti-active shooter technology, active shooter detection, active shooter intervention, active shooter response including but not limited to sound, smoke, pattern recognition, etc., people counting, dust sensors, pollution sensors, WiFi probe requests, BLE sniffing, detection, identification of surrounding BLE devices, etc. Embodiments of the present invention can control of projectors, TVs, audio visual equipment, heating, cooling, HVAC, temperature, humidity, water leakage, water spills, moisture, etc., using for example but not limited to devices in the lighting.

The present invention can use one or more colors and/or color temperatures of lighting including but not limited to solid state lighting (SSL) including but not limited to LEDs, OLEDs, quantum dots, etc., combinations of these, etc. as well as any other type of light source, etc., combinations of these, etc.

Embodiments of the present invention can be of any size and shape and form including but not limited to for fluorescent lamp replacements 2×2 foot, 4×2 foot, 1×4 foot, 1×2 foot, 1×8 foot, 2×8 foot, 1×3 foot, 2×3 foot, other sizes including less than s foot to more than 12 feet, non-integer foot (English, or equivalent metric) lengths, widths, heights, etc.

Embodiments of the present invention can use one or more colors, including but not limited to RGB, WRGB, WRGBA, WWRGBA, WRGBAL, WWRGBAL, etc.

The present invention can connect to other types of light, etc. Implementations of the present invention can control, interact, coordinate, etc. with the other lighting including but not limited to coordinating the ceiling, mid-level (e.g.: cubicle top lighting), task lamps, desk lamps, etc. that communicate with one another to, for example, but not limited to, adjust the lighting level, spectral distribution(s), etc. by wired, wireless, powerline, combinations of these, etc., provide personal comfort levels, spectrum, color temperatures, temperature, humidity, occupancy, vacancy, movement, carbon dioxide, carbon monoxide, security, power management, IOT, combinations of these, etc.

The present invention can use WiFi, LiFi, Bluetooth, BLE, Zigbee, ZWave, Thread, sub-GHz, etc., including but not limited to others discussed herein, etc., combinations of these, etc.

The present invention can use thin film diffusion/diffusers printed in a variety of stock or custom patterns that can be used for aesthetic and functional light conduction applications. Functional options include but are not limited to control over amount of light passed (% transmission); direction of light (direction-turning, shaping); lensing (e.g., batwing, ellipsoidal, etc.), restricted space/turning; non-Gaussian diffusion/casting; utilization of shadow; utilization of contrast; utilization of meaningful patterns (logos, images of kids, etc.); minimization of glare; and/or “greyscale” light based on juxtaposed differences in intensity using thin films.

Embodiments of the present invention include cut are not limited to mounting options such as the removal of existing internal “pie plate” and insertion of high-reflectivity adhesive film into troffer chassis; cutting a sheet of a specific thickness (e.g., 7 mil) into narrower strips and then creating a mid-line attachment method; mounting based on Velcro or Dual Lock “dots” at specific points; use of an “L”-shaped or “C”-shaped bracket along the bottom of a troffer or downlight allowing a sheet of film to be slid onto the bottom side of a fixture; use of hooks, magnets, clips, springs, adjustable hardware, slots, use of double sided adhesive including but not limited to removable adhesives such as 3M Command; process for temperature- or pressure-molding a thin film diffuser dimensionally so as to fit a proprietary bracket on a troffer; processes for inserting a thin film sheet into a bracket of a heavier-weight injection-molded plastic that conforms to the shape of a troffer; appropriate tradeoff point between thickness/rigidity and flexibility that allows the film to be supported without bowing in a fixture, providing adequate light transmission, and allowing the material to be shipped and stored rolled rather than flat; use of a “family” of thin films of differing patterns allowing users to select a preference without being tied to a single one. “Subscription model” for obtaining a collection of films; use of a blank thin film that, combined with finger paints, allows a child or person to create an image on the film that can then be mounted in the light fixture; processes for laminating or etching a custom pattern or drawing onto a thin film such that it can be manufactured in single-user form for individualized lighting; processes that allow for example but not limited to a person or artist can create a private, custom line of designer diffusers; se of waveguide and beam steering; the use of edge emission and fiber optics; and/or the use of edge lit lighting

Embodiments of the present invention can have one or more white color temperatures and/or one or more multiple colors in for example the length direction and different one or more white colors in width direction and can use, for example four sided polished edge lit panels made of plastic, glass or other materials including for example, Plexiglas or acrylic. Embodiments of the present invention can have one or more white temperature colors on the length direction on a single side of the length direction on both sides of the length direction, etc. and have one or more colors (e.g., RGB, RGBA, RGBAL, WRGB, WWRGB, WWRGBA, etc.) on one or both sides of the width direction. Others embodiments of the present invention can have one or more white temperature colors on the width direction on a single side of the width direction on both sides of the width direction, etc. and have one or more colors (e.g., RGB, RGBA, RGBAL, etc.) on one or both sides of the length direction and/or combinations of these.

The present invention can be used to provide pathway finding, way finding, indications of safe paths to take, etc. The present invention can use different colors, direction-turning, direction setting, directional indicators including but not limited to arrows, crosses, sequencing, etc., combinations of these, etc. to indicate, show, direct, lead, steer, push, promote, force, correct, etc. the path taken in the event of emergency, active shooter, lock down, fire, earthquake, loss of power, other natural and man-made disasters, danger, etc., getting out of bed at night, to assist elderly, aging, people with disabilities, people recovering or recuperating, people with injuries, people with mental or physical challenges, people with dementia, people with diseases including but not limited to neurological matters, Parkinson's, Hodgkin, muscular dystrophy, Alzheimer, etc., people who are disorientated, people on medications, etc., combinations of these as well as also providing appropriate time of day/time of night light colors and wavelengths, etc.

FIGS. 30-31 depict non-limiting example embodiments of segmented solid state light panels. Each segment 750, 752, 754, 756 can have individual control of on/off, color, color temperature, dimming level, white temperature, etc. Embodiments of the present invention can have segmented parts of the light such that, for example, but not limited to, having the one or more colors and/or color temperatures on one or more sides divided into groups of connected lighting that allows each group or groups of groups to be controlled separately thus allowing for different colors, color temperatures, intensities, dimming, trimming, etc. from the different segments including but not limited to the segments being made from the same types of LEDs or different LEDs.

In some embodiments of the present invention there can be LEDs along one or more of the borders of the flat panel lighting that can be independently controlled or controlled at the same time as the main lighting of for example but not limited to, edge lit lighting, back lit lighting, etc., combinations of these, etc. Such border lighting can be used for, but not limited to, signaling, warnings, alerts, alarms, strobing, direction finding, path finding, way finding, other uses, functions, features, etc. including those discussed herein, etc.

Note although FIGS. 30-31 depict vertical segmenting only, the segmenting can be in any direction and any number of segments including but not limited to vertical, horizontal, both vertical and horizontal in the plane, in 3 dimensions, with shapes and forms including but not limited to squares, rectangles, circles, parallel pipe heads, triangles, diamonds, pentagons, hexagons, polygons and other forms of any number of sides, etc. cubes, tubes, cylinders, any other volume, volumetric shapes, etc.

Turning now to FIGS. 32-34, a non-limiting example embodiment of a circular light panel 800 with center lighting 802 and edge lighting 804 is depicted, with various cross-hatch patterns representing different colors, dimming states, color temperatures, etc. Implementations of the present invention can take, be of, etc. any shape and size including but not limited to square, rectangular, circular, triangular, round, cylindrical, pentagon, hexagon, octagon, polygon, parallel piped, any regular or irregular geometrical shape, 2D, 3D, etc. In the non-limiting example above, a round or circular embodiment of the present invention is depicted with a center light source that can be white, white tunable (e.g., color temperature tunable), color tunable, full spectrum, multi-channel, etc. which also has one or more bands or groups of lighting that can be used to signal, warn, alert, alarm, protect, etc. In general, implementations of the present invention can, for example but not limited to use back lit and edge lit to create a static or dynamic sky simulation/emulation with the white SSLs/LEDs used for, for example but not limited to clouds, and blue and possibly additional colors used to, for example, simulate blue sky during for example but not limited to daytime and as a second non-limiting example red and other colors or combinations of colors (e.g., orange, yellow, green, amber, etc.) to simulate/emulate a morning (sunrise) or especially an evening (sunset) either statically or dynamically.

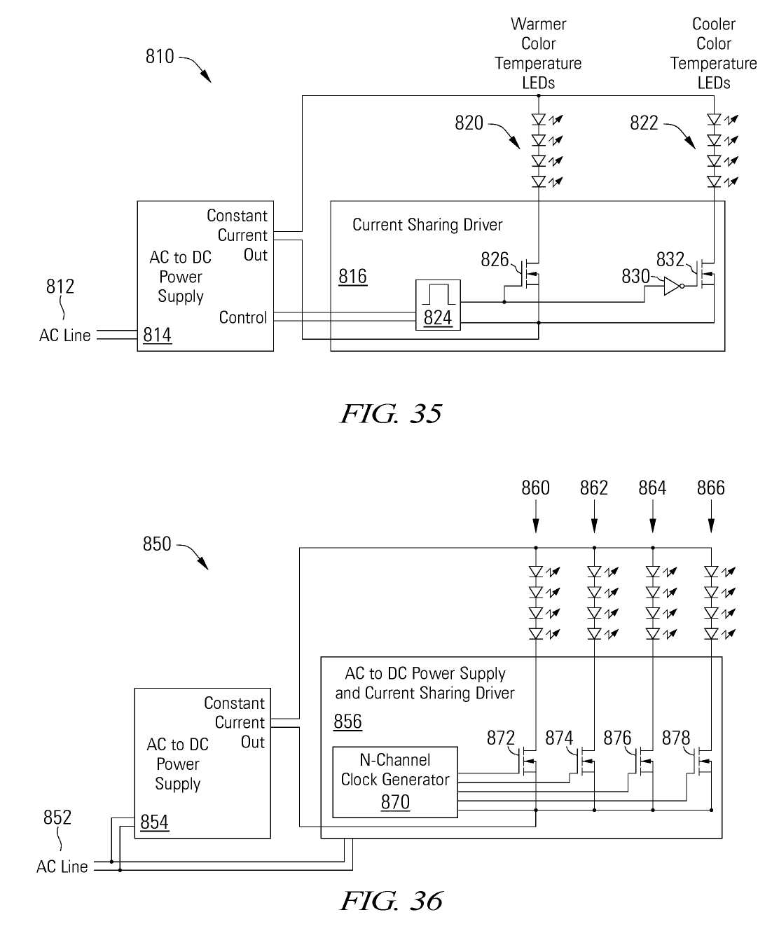

FIG. 35 depicts a non-limiting example schematic of a 2-channel current splitter 810 for SSL lighting. Current is time-divided between two banks 820, 822 of solid state lighting of any type, alternately lighting one and then the other. This can be used to tune the apparent color temperature of white LEDs, for example, or can be used to blend colors or different types of lighting. The visual effect can appear to be a constant, consistent appearance, for example by applying a higher frequency and associated duty cycle for the high frequency in a PWM generator 824 so that visual persistence and high speed switching effectively blends the light from two banks 820, 822 of solid state lighting and is extremely low flicker to flicker free. If desired, the frequency can be lowered to generate a visible flashing or switching effect, for example but not limited to to signal an emergency condition such as a fire or burglar alarm or to disorient/disturb an active shooter. Following the schematic of FIG. 35, an AC to DC power supply 814 converts an AC input 812 to produce a constant current output used that can be dimmable for example but not limited to 0 to 10 V dimming (i.e., the constant current is adjustable and dimmable based on the dimming input), PWM, DMX, etc. to power the two banks 820, 822, which, as a non-limiting example, can each be series strings of white LEDs, such as but not limited to a string 820 of 2200 degree Kelvin warm white LEDs and a string 822 of 6500 degree Kelvin cool white LEDs. By rapid switching of current between the two banks 820, 822 and balancing the duty cycle that apportions current between the two banks 820, 822, an apparent color temperature can be produced anywhere between the 2200K warm white and the 6500K cool white that can be free of flicker. Of course, these example color temperatures are non-limiting examples, and the 2-channel current splitter 810 can be used to adjust other aspects of a lighting system, such as, but not limited to dimming, color, hue, etc. as well as additional channels, etc.

The AC to DC power supply 814 in some embodiments can also generate a 0 to 10V DC control signal which can be used to adjust the duty cycle of the PWM generator 824 in a Current Sharing Driver 816. The PWM output of the generator 824 is used to control a switch 826 to turn on and off current through one SSL bank 820, and is used inverted by inverter 830 to control a switch 832 to turn on and off current through another SSL bank 822. In other embodiments the AC line can be applied to Current Sharing Driver 816 that takes in the AC converts to DC output. In other embodiments the AC to DC power supply for the dimmable constant current power supply can also have an auxiliary to power Current Sharing Driver 816. In other embodiments the Current Sharing Driver 816 is powered by other means including but not limited to PV/solar cells, batteries with or without a battery charger, energy harvesting, wireless power, super capacitor, mechanical, vibration, alternative energy, etc.

It is important to note that the division of functions in the example 2-channel current splitter 810 is purely illustrative and non-limiting. For example, all AC to DC conversion could be performed in the power supply 854, with voltage regulated DC power being provided to the current sharing driver 816 to power electronics therein. Similarly, control of the PWM generator 824 can be performed in the current sharing driver 816 rather than in the power supply 854, based for example, but not limited to, on commands from a remote user interface such as an app on a smartphone, or based on time of day for circadian rhythm management, for example commanding a cooler, bluer light in the morning and a warmer, yellower light in the evening, etc. In other embodiments the PWM generator or generators can come from a microprocessor, microcontroller, DSP, FPGA, wireless communication device, etc.

The signals controlling the switches 826, 830 can be non-overlapping or overlapping based on the desired effect. For example, non-overlapping signals can be used to prevent both banks 820, 822 from being on at the same time for more uniform luminance, or overlapping signals can be used for additional blending effects, emergency situations, etc.

FIG. 36 depicts a non-limiting example schematic of an N-channel current splitter 850 for SSL lighting. While the 2-channel current splitter 810 of FIG. 35 controls the balance between cooler and warmer banks 820, 822 of LEDs, one can subdivide illumination properties further by dividing the pulse period to generate more than two control signals, such as, but not limited to, 3, 4, 5, 6, etc., each controlling an SSL bank with a different desired characteristic, such as, but not limited to, white LED color temperature or color channels. For example, an N-phase non-overlapping clock generator using any suitable architecture can be used to control each SSL bank, such as, but not limited to, a Johnson counter, a synchronous counter decoder, a rotating serial shift register, etc. Again, an overlapping clock generator can also be used for blending with the duty cycle and timing of each channel individually adjustable. However a typical mode of operation consists of a non-overlapping clock and other associated waveforms. Such a clock generator can be any type of but not limited to for example one or more of appropriate state machine, integrated circuit, application specific integrated circuit (ASIC), microcontroller, microprocessor, FPGA, DSP, logic circuit, pulse width modulator, etc.

Following the schematic of FIG. 36, an AC to DC power supply 854 converts an AC input 852 to produce a constant current output used to power the N SSL banks 860, 862, 864, 866, where N could be any number. For example, but not limited to, the N SSL banks 860, 862, 864, 866 can each be series strings of white LEDs with, for example but not limited to, the same or different color temperatures, in order to improve the apparent overall adjustable color temperature of the lighting system. In other embodiments of the present invention, the N-Channel transistors could be replaced with P-Channel transistors. In general, enhancement and/or depletion with N-Channel and/or P-Channel transistors can be used in various arrangements, topologies, etc. of the present inventions.

As a non-limiting example, an N-channel clock generator 870 produces control signals to control switches 872, 874, 876, 878, to turn on or off each of the N SSL banks 860, 862, 864, 866. Again, in some non-limiting example embodiments, the control signals from the clock generator 870 can be non-overlapping or overlapping, and the duty cycle of each of the control signals can be individually controlled. Other circuit elements can be included as desired, such as, but not limited to, optional current sensing and/or limiting resistors in series the SSL banks 860, 862, 864, 866, capacitors, diodes, or other components as desired. Implementations of the present invention can use these components as optional to the function and operation of the circuits and drivers, etc. Switching frequencies can be any frequency from sub Hz to tens of kHz or even 100s of KHz, with above 2500 Hz (2.5 kHz) such 2500, 3000, 3500, 3550, 3770, 4100 Hz, etc. being non-limiting examples.

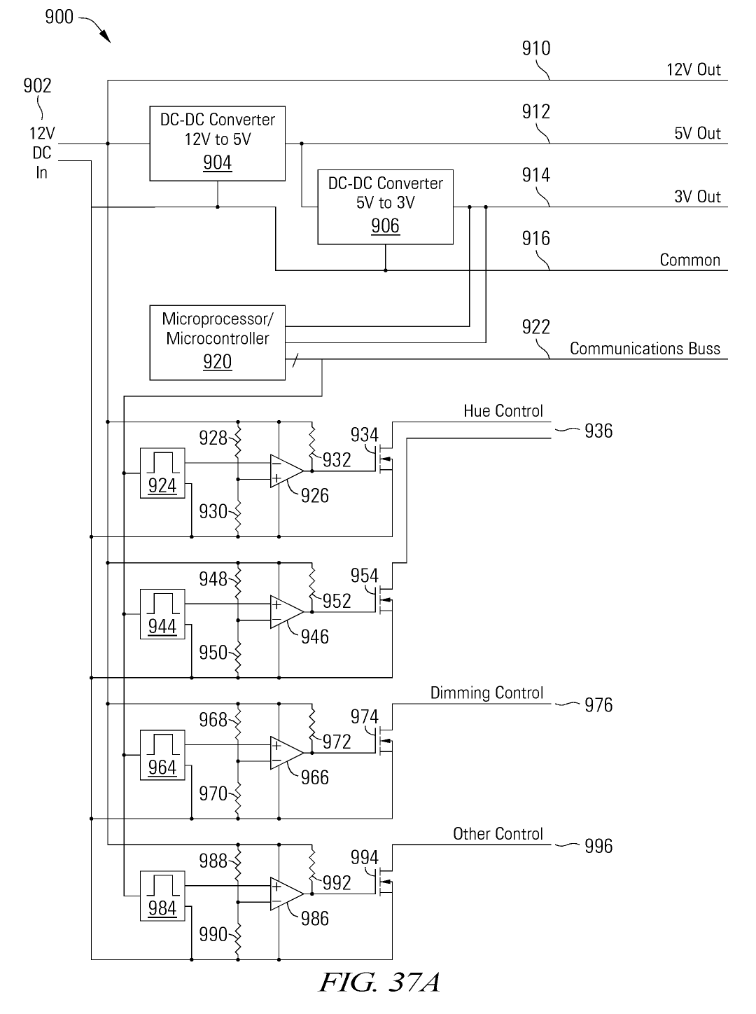

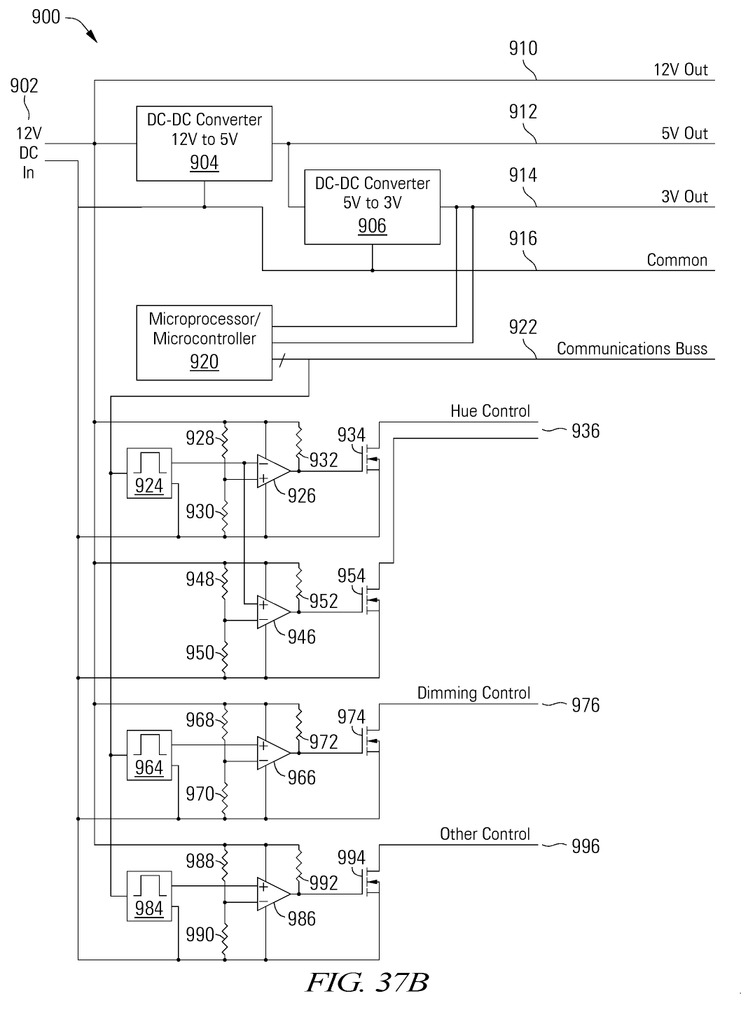

Turning now to FIG. 37A, a non-limiting example schematic of a current splitter for SSL lighting is depicted which can be used to control hue, dimming or other aspects of an SSL lighting system. For example, a hue control circuit can include a pair of PWM generators 924, 944 (which could optionally be a single PWM generator with for example but not limited to multi-use output or inverted inputs (one comparator 926 has the signal connected to the inverting input while the other 946 comparator has the signal connected to the non-inverting input) as depicted in FIG. 37B), the first 924 providing (which could for example but not limited to be a PWM generator internal to the microcontroller, the microprocessor, the FPGA, DSP, etc.) and which provides a PWM signal to the inverting input of a comparator 926, the second 944 providing a PWM signal to the non-inverting input of another comparator 946. Resistors 928, 930 and 948, 950 (which can also be combined with multi-use outputs) provide reference voltages and signals some of which may be optional to the non-inverting and inverting inputs of comparators 926, 946, respectively. Feedback resistors 932, 952 can be used as desired with the comparators 926, 946. The comparator outputs each control a switch 934, 954 which can be used to generate an output signal 936 that is fed to, in this specific example to control the ratio of current supplied to two channels for example two different arrays of color temperature LEDs so as to control the hue of the solid state lighting. For example but not limited to, connections 936 can go to two separate LED channels such as but not limited to two different color temperature LEDs such as but not limited to a warmer LED channel consisting of one or more LEDs including one or more LED and/or other SSL arrays, strings, etc. such as a 2200K or 2700K or 3000K (or higher) LED/SSL array, string, etc. and a second channel consisting of but not limited to a cooler LED channel consisting of one or more LEDs including one or more LED and/or other SSL arrays, strings, etc. such as a 5000K or 5700K or 6000K or 6500K (or other) LED/SSL array, string, etc.

A similar circuit can be used to generate a dimming control signal 976. A PWM generator 964 provides a PWM signal to the non-inverting input of a comparator 966, and resistors 968, 970 and resistor 972 provides a voltage to the inverting input of the comparator 966. The output of the comparator 966 drives switch 974 which generates a dimming control signal 976. Additional circuits can be provided to generate control signals to split current for other purposes. For example, PWM generator 984 provides a PWM signal to the non-inverting input of a comparator 986, and resistors 988, 990 and 992 provide a voltage to the inverting input of the comparator 986. The output of the comparator 986 drives switch 994 which generates an output signal 996. In some implementations of FIGS. 37A and 37B, any two resistors that form a voltage divider resistance pair (for example and not limited to 928 and 930) can be used a voltage divider reference point for the other voltage divider resistor pairs 948 and 950, 968 and 970, and 988 and 990. In some embodiments of the present invention there are no resistor pairs and the terminal of the comparator that is at the voltage divider junction point is instead applied to the common/low side terminal of the respective comparator.

Optional system elements can also be included as desired, such as a microprocessor or microcontroller, DSP, FPGA, etc. 920 to control the internal or external PWM generators, receive remote lighting control commands, etc., optionally including one or more communications busses 922, wired and/or wireless. DC to DC converters 904, 906 can be included as desired, for example but not limited to, to convert a non-limiting example of 12V input 902 to provide a variety of DC outputs 910, 912, 914, 916. Note other voltages than 12V can be used including but not limited to 20V, 24V, 28V, 30V, 36V, 42V, others including, higher, in some embodiments a voltage converter can be used to reduce the DC input voltage. The microcontroller, etc. can control and monitor the Hue, Dim. Additional PWM, other PWMs as well as communications using, for example but not limited to, I2C, SPI, etc. for communications to sensors, IOT, other devices, detectors, systems, etc. including but not limited to those discussed herein, etc.

As discussed above, the PWM generators 924, 944 of FIG. 37A can be combined as in FIG. 37B, with the output of PWM generator 924 being provided to the inverting input of comparator 926 and to the non-inverting input of comparator 946 such that the pair of hue control outputs 936 comprise non-overlapping or substantially non-overlapping signals that are fed to, in this specific example to control the ratio of current supplied to two banks of (for example but not limited to) two different arrays of color temperature LEDs so as to control the hue of the solid state lighting, such as that illustrated in FIG. 35.

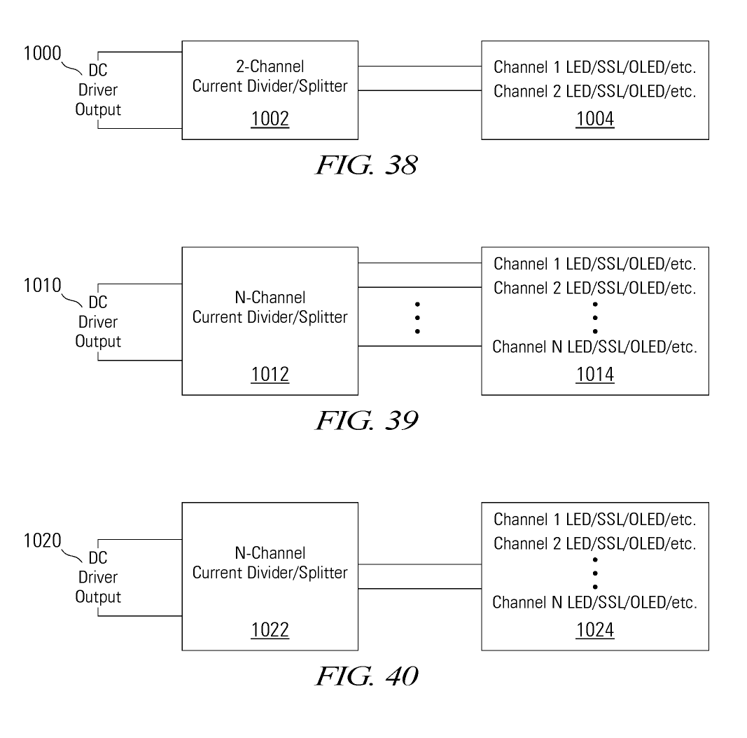

FIG. 38 depicts a non-limiting example block diagram of a 2-channel current splitter for SSL lighting. A DC driver output 1000 controls a 2-channel current divider/splitter 1002, which independently controls SSL banks 1004. Again, any suitable type of control can be performed, such as blending white LED color temperatures to yield a desired apparent color temperature from the combined SSL banks, or to control color, hue, dimming, etc.

FIG. 39 depicts a non-limiting example block diagram of an N-channel current splitter for SSL lighting with parallel control channels. A DC driver output 1010 controls an N-channel current divider/splitter 1012, which independently controls N SSL banks 1014. Again, any suitable type of control can be performed, such as blending white LED color temperatures to yield a desired apparent color temperature from the combined SSL banks, or to control color, hue, dimming, etc.

FIG. 40 depicts a non-limiting example block diagram of an N-channel current splitter for SSL lighting with serial control channels. A DC driver output 1020 controls a 2-channel current divider/splitter 1022, which independently controls SSL banks 1024. Again, any suitable type of control can be performed, such as blending white LED color temperatures to yield a desired apparent color temperature from the combined SSL banks, or to control color, hue, dimming, etc.

Embodiments of the present invention can include but are not limited to sensors, detectors, TOT, speakers, microphones, smoke detectors, fire detectors, carbon monoxide sensors and detectors, carbon dioxide sensors and detectors, sound detectors, voice detectors, motion detectors, sonar detectors, radar detectors, environmental sensors and detectors, cell phone detectors, cellular detectors, RF detectors, electromagnetic wave detectors and sensors including broadband, sirens, other types of noise and sound generators, narrow band, part of the spectrum, regions of the spectrum, etc., filtered detectors, digital detectors, temperature detectors, humidity detectors and sensors, low pass, band pass, high pass, etc. filters, digital signal processor/processing that can use artificial intelligence, machine learning, pattern recognition of any type including but not limited to voice, sound, light, optical, visual, sensory, electromagnetic, motion, accelerometers to detect vibration including but not limited to earthquakes, movements, people counting/counters, dust sensors, pollution sensors, WiFi probe requests, BLE sniffing, detection, identification of surrounding BLE devices, etc., combinations of these, others discussed herein, etc., strobing the lighting, flashing the lighting, etc.

The present invention can be used for active shooting, wayfinding, security, etc. Embodiments of the present invention including but not limited to the lighting can be used to signal, alert, show, direct, wayfind, etc. by changing color(s) in all or part of the lighting, pointing, indicating, etc., with the lighting, etc. as well as other methods, approaches, techniques, etc. discussed herein.

The present invention can combine one or more of smoke detection, fire detection, heat detection, temperature detection, sound, noise, specific frequencies of sound, infrared temperature measurements, various gases, one or more gas, air quality, carbon monoxide, carbon dioxide, etc., artificial intelligence, machine learning, space, distance, time of flight, video, stereo imaging, 3D imaging, thermal imaging, picture, camera still and dynamic data, facial expressions, movement, detection of movement in any way or form, human voices, screams, pleas, crying, erratic movements, velocity, speed, changes in ambient gas compositions, door opening(s) or closings, door locking, cell phone activity, unknown cell phones, biometrics, human responses, time of day, day, date, etc., automatic responses, automated responses, etc., can release gases, smoke, etc.

Embodiments of the present invention can have lights or other elements/components of the system perform deterrent activities including using buzzers, bells, strobe lights, speakers other forms of sound, noise, light generation, etc. some or all of which could be attached to the lights, embedded in the lights, be part of the lights, etc. Besides active shooter, the present invention can be use, for example but not limited to natural disasters, fires, earthquakes, tornadoes, damage, building injury, faults, defective, etc.

Embodiments of the present invention can be used to reduce migraine headaches, support well-being of people with disabilities, people without disabilities, infants, the aging, students, etc.

Embodiments of the present invention can have built in, embedded, incorporated, integrated, and/or attached, etc. additional components including additional lighting to indicate which way to go, which way is, safe, which way is not safe, which way to follow, which path to take, etc. which path to take of many paths, etc., other information about paths, ways to go, etc.

Implementations of the present invention can be used to retrofit existing fixtures including but not limited to existing fixtures that have only a single color, single wavelength, single color temperature (CCT) and make these existing lighting including but not limited to fixtures, troffers, sconces, LED strip lighting of any type or form including in fixtures of any type or form, cove light, downlight, LED replacement lights, tubes, bulbs, etc. any type of 2×4, 2×2, 1×4, 1×5, etc. fixture, luminaire, etc. and make these become one or more of color, color temperature CCT, color tunable, color temperature tunable, multi-channel including two, three, four, five or more channels, adding one or more of amber, mint, violet, blue enriched, blue deprived, etc. to existing lighting fixtures especially any that employ LED strips, tubes, linear bars, arrays, etc., one dimensional, two dimensional arrays, combinations, etc.

Embodiments of the present invention can have mirrors or mirror-like reflective surfaces to reflect light and act as a mirror when not illuminated. The mirror like surfaces can include but are not limited to mirrors, stainless steel, aluminum, silver, gold, other silvery metals, elements, compounds, alloys, plastics, etc., mirror-like materials, glass coated with materials, including macro, micro, nano coatings of any type, form, etc.

Embodiments of the present invention can be surrounded by, encased in, protected by, etc. glass and other transparent materials including sapphire, quartz, any type, make, etc. of glass, diamond, ceramics, porcelain, nano materials, nano coatings, thin films, water resistant coatings, water proof coatings, materials that smart cell phone screens are made of, touch screens of any type and make, etc., thin film solar cells, thin film photovoltaics, laminates, protective coatings, diffusers, light guides, beam steering, combinations of these, etc.

The health, quality of life and independence of the aging and people with disabilities is of critical importance. Without these, the ability to function and flourish is impaired and limited.

There is a still unfulfilled need in providing additional assistance technologies to individuals who desire to lead independent living quality lifestyles. Among others these individuals include the aging and people with disabilities. Embodiments of present invention can use the associated lighting to control and monitor heating ventilation and air conditioning (HVAC), other environmental controls and monitoring, air quality sensing, home security and protection, etc

The present invention involves technology applied to assistive technology that is easy to configure, implement, use and maintain that is also low cost/affordable and has viable non-cloud based and non-recurring cost models as well as models that do involve the cloud and, typically, monthly or annual recurring cost models including affordable, simple to setup and use/operate for the aging and people with disabilities.

The present invention is highly inclusive of many subgroups with disabilities and to address their needs.

The present invention include cohesive assistive technology that also incorporates energy efficiency, is modular and easy to setup, operate and communicate for aging persons and people with disabilities and caregivers.

The present invention provides aid, enhances and increases the comfort, ability to lead an independent life and lifestyle, decease energy usage and associated costs, provide on open platform including open-source platform to allow aging adults and people with disabilities and their respective families to lead a socially active and rewarding life coupled with the ability to more fully use assistance technology for the betterment of their lives and others associated with them

Embodiments of the present invention include assistance/assistive technologies to further enhance and support the independent living and lifestyle choices of aging and people with disabilities coupled with the efficient use of electricity and HVAC in residential housing while also further supporting social networking and security and protection. There is a need for novel and inexpensive solutions that will accelerate the adoption of energy efficient and environmentally green technology. The lighting component can use, for example, but not limited to, highly efficient solid state lighting (SSL). SSL is inherently digital and easily made compatible with modern electronics, sensors and control systems= in installed systems. By exploiting systems, components, sensors, firmware and software approaches, components including sensors, control algorithms, and even applications for common digital platforms that provide control functionality to products and control and automation specifically aimed at the aging and those with disabilities. Implementations of the present invention tap into useful and energy saving applications specifically aimed at and targeted for the aging and people with disabilities at modest cost that still provides access to the enormous and powerful distributed computational capabilities of present and future SSL systems, components and sensors.

Implementations of the present invention can include both sensors and control hardware that are easily integrated, incorporated, and/or used in conjunction with SSL systems specifically focused on the needs of the aging and individuals with disabilities to permit a better quality of independent living. Some implementations can provide modular solutions and kits some of which must be selected at time of manufacturing, some of which can be added and are field-installable without the need for experience or knowledge of advanced electronics or the details of SSL systems—and all of these modular solutions can provide additional energy savings. An optional but not necessary component of the control firmware, hardware and software is additional processor capability that can also be easily integrated into SSL systems.

Some embodiments of the present invention employ adaptive sensors and controls that communicate typically at low data rates with low data content to achieve substantial energy usage reduction for a wide range of lighting and other products including both SSL and non-SSL lighting and other products. Embodiments of the present invention include a family of modular products that, among other things, reduce energy consumption and cost as well as providing enhanced performance and functionality to the aging and people with disabilities end users. Implementations of the present invention can be highly energy efficient have large tactile buttons for those who may have restricted or limited motor functionality/capability, smart phones (i.e., iPhones, Androids), tablets (i.e., iPods, Androids), computers, simple-to-use remote controls, both smart and dumb (with a wireless interface) TVs including dumb legacy TVs that are only NTSC-compatible (and not HDTV-compatible) as well as HDTVs and can have-plug-and-play modules and ranging from low-tech to very high-tech. The innovations can make use of but does not require the internet or internet protocol (IP) addresses to operate; however optional choices and accessories will allow internet and/or cloud connectivity if so desired.

Implementations include RF communications for solid state lighting (SSL) and other lighting, thermostats for heating, ventilation and air conditioning, (HVAC), television, entertainment systems, etc. control and monitoring.

Embodiments can include modular lighting dimmers for both 120 VAC wall voltage dimmable lights such as incandescent lamps and LED lamps and smart light bulbs that can be dimmed directly by the same digital signal as the modular lighting dimmer. Implementations of the present invention include low voltage color temperature tunable from for example but not limited to 2200 Kelvin to 6500 Kelvin LED lighting including but not limited to wireless control and monitoring into the dimmers and related system solutions including but not limited to controls and sensors.

Other embodiments of the present invention include wayfinding systems that are quasi-universal for the Aging and People with Disabilities including both physical and intellectual disabilities. Implementations include methods to contact neighbors, friends and families by algorithmic (software) and ‘Panic’ and ‘Advising’ buttons that wirelessly transmit/send information to notify/alert.

The present invention can respond in a number of different modes to a given situation. This includes but is not limited to turning the overhead, ceiling, wall, other, etc., general lighting fixtures to a lower (dimmed) level or turning up some or all of the overhead, ceiling, wall, other, etc., general lighting fixtures when motion is detected that indicates one or more persons are leaving a personalized area as well as turning down or off certain electrical power, outlets, receptacles, appliances, personal HVAC including but not limited to fans, heaters, warmers such as but not limited to foot warmers, personal exercise equipment including but not limited to foot warmers, walking machines, tread mills, other types of exercise machines, etc., combinations of these, etc., the lighting in the personalized space including but not limited to cubicle space(s) can be of any color temperature, color, etc., one or more color temperatures, one or more colors, more than one color temperature, more than one color and can consist of one or more lighting sources including but not limited to desk lamps, task lamps, under shelf lamps and lighting, wall lighting, cove, cubicle lighting, suspended lighting, lighting attached to desks, tables, cubicles, suspended lighting, light suspended from surfaces, etc., combinations of these, etc.

The present invention provides among other things communication and coordination between the lighting sources in a room, personalized space, cubicle, office, open space, shared space, library space, library study areas, hospital and clinic, classrooms, open spaces, including but not limited to single, individual, personalized, group, shared, etc. space(s) that allows increased efficiency, enhanced comfort and quality of environment including but not limited to lighting, HVAC, air quality, physical and psychological comfort, productivity and well-being.

The coordination can include the personalized lighting detecting occupancy and/or vacancy of spaces, transitions from/to/between spaces, etc., combinations of these, etc. and adjust the light appropriately depending on the specifics of the space and the users which could dimming the overhead, etc. so as to not result in a cave effect yet be low enough that the personalized is dominant thus providing higher energy efficiency coupled with personal preferences and choices including but not limited to lighting, air flow, temperature, humidity, etc.

The present invention can use wireless communications including but not limited to WiFi, LiFi, Bluetooth, LoRa, Zigbee, Z wave, wired, power-line, others discussed, herein, combinations of these to communicate and also provide hot spots, video streaming, internet, web, cloud based communications, services, transitions, receiving, etc. and for other communications purposes.

The present invention can provide protection, security, including but not limited to air quality, pollution, airborne detection, gas detection, thermal detector/imagers, breaking glass detector, motion detection, humidity, carbon monoxide levels, carbon dioxide levels when no persons should be working, in the space, studying, occupying the spaces(s), being in the spaces, etc.

The present invention can be set/programmed/controlled to perform certain functions upon detection of motion including but not limited to be a coordinator of motion detection response including but not limited to turning some lights on, dimming or turning off other lights, etc. when motion and/or occupancy is detected or the lack of motion and/or occupancy is detected/determined in which case certain lighting is turned off/dimmed, etc., certain parts or all of the HVAC, other environment-related systems, power, outlets, receptacles, etc. are turned off or lowered as the case may be. In other circumstances such as but not limited to when the building is empty of employees, office workers, students, staff, faculty, other persons who should normally not be there, etc. and/or, depending on the type of building, facility, office and use, after hours or on the weekends or set in a mode to be in protection/protective/security, etc. Embodiments of the present invention can go into a defensive mode and provide protection and security by, for example, using the motions, occupancy, vacancy sensor, other sensor, cameras, infrared imagers, IoT, glass break sensors, water leak detectors, moisture detectors, speakers, microphone(s), etc., to detect intruders or thought-to-be intruders. The present invention can use artificial intelligence, machine learning, augmented reality, virtual reality, etc., combinations of these, etc. Such detection can include but is not limited to tracking, logging, analyzing, using artificial intelligence (AI), machine learning (ML), etc. In some embodiments of the present invention, the system can turn the lights on, use the lights to follow the one or more intruders, flash the lights on and off, strobe the lights at frequency or frequencies that are disturbing/distracting, cause temporary unpleasantness, disorientate, disturb, etc., or stay off and display or indicate no signs of detection while providing silent alerts remotely to the police, the office manager, the information technology (IT) personnel and/or department, the building manager, the building owner, the general manager of the building and/or business, etc. and then either remain silent or start to flash, strobe, change color, activate one or more sirens, speakers, cameras including security cameras, lock down the building, trigger other services, etc., one or more combinations of these, etc. Embodiments of the present invention can also be used for other types of protection including but not limited to fire, earthquake, flood, After the first responders, police, fire department, ambulance(s), the lights could them, for example, but not limited to turn on and leading the first responders, others, etc. to the intruders, flashing the lights above, near to embodiments of the present invention, etc. to assist in reaching the persons and, for example, but not limited to if there is one or more intruder(s), flashing and/or strobing the lights at the location(s) of the intruder(s), turning on speakers to alert the intruder(s) of the presence of the first responders, turn on piercing sirens, speakers, loud speakers, public assistance (PA) speakers, put out blinding light, put out high decibel sounds, noise, etc.

Embodiments of the present invention can be controlled and monitored by/via building automation system (BAS) software including but not limited to BAS, BACNET, LonNET, by Windows, iOS, code and software running on one or more of pc(s), server(s), laptop(s), computer(s), desktop computer(s), etc., one or more of these, combinations of these, etc. to control, monitor, respond, etc.

The sensors and other IOT can be mounted/installed in any practical location and locations.

Embodiments of the present invention can use sensors and IOT, controls, interface circuits, etc., that are powered by but not limited to the lighting, by AC power, by converted AC power, by battery, by proximity, by super capacitors, by the sun, by solar, by wind, by geothermal, by energy harvesting, by mechanical energy harvesting, by mechanical movement, by battery charging, by super capacitor charging, by other forms of alternative energy, etc., by combinations of these, etc.

Embodiments of the present invention can also talk, communicate, interact with thermostats and other types of HVAC controls as part of the lighting detection, comfort, energy savings, personalized enhanced choices and decisions, etc. The thermostat or other type of temperature controller/monitor may also be part of the sensor and/or IOT network of embodiments of the present invention.

The users of the present invention may communicate, interact, control, monitor, etc. via a local area network (LAN) that talks/communicates with other computers, servers, the web, the internet, the cloud etc.

Embodiments of the present invention may use, control, interact with any type of lighting and use and control any type of light, lighting, lamp, fixture that is powered in any way or form including but not limited to AC line, ballast, ballast of any type or form including electronic, magnetic, instant start, rapid start, programmed start, power over Ethernet (POE), solar, alternative energy, low voltage, DC, high voltage, pulsed, etc., combinations of the above, other types of power and energy, wireless power, etc.

Embodiments of the present invention may contain and communicate via light fidelity (LiFi).

Embodiments of the present invention can include the capability to measure input and output current, voltage, power, power factor, harmonics, total harmonic distortion (THD), crest factor, efficiency, etc. and can include sensors either internal/incorporated as part of the smart dimmer or remotely wired, wireless or powerline communications—such sensors can be of any type and form including but not limited to any type of light, solar, spectrum, color, noise, motion, proximity, radar, sonar, ultrasonic, sound, voice, voice recognition, RFID, proximity, signal strength based, wireless, RF, infrared, etc., combinations of these, etc. The smart wall switch can be directly or indirectly AC powered, battery powered, solar powered, solar charged, etc., combinations of these, etc. as well as any or all of the sensors being directly or indirectly AC powered, battery powered, solar powered, solar charged, etc., combinations of these, etc.

In some embodiments of the present invention, some or all of the sensors are incorporated into the implementations of the present invention or located close by and, for example, tethered by wires (or in some cases using wireless technology including but not limited to, wireless communications and wireless power transfer) with power being provided by the AC or ballast or indirectly powered, battery powered, solar powered, solar charged, etc., combinations of these, etc.

Some embodiments of a fluorescent lamp replacement (FLR) include tethered motion, sound, noise, ultrasonic, and optional light sensors which could be attached to the fixture including the outside of the fixture past the diffuser, if there is a diffuser. The light sensor could include but are not limited to one or more of a projection, cover, lens, cone cylinder, etc. to block direct light from the FLRs reaching the light sensor(s).

Some embodiments of the present invention can recognize specific devices including but not limited to cell phones, smart phones, tablets, RFID tags, laptops, smart watches, wearables, remote devices, Bluetooth devices, etc., combinations of these, etc., other radio communications, voice identification, signal strength, etc., combinations of these. The wall switch also supports scheduling, sequencing, programming, synchronizing, adapting, etc. including but not limited to probe requests, broadcasting, sniffing, etc. to obtain, for example, but not limited to, MAC addresses, SSIDs, RSSIs, etc.

Embodiments of the present investigation can use the lights/lighting to, for example but not limited to track restroom cleanliness frequency including but not limited to custodian check-in/checkout as well as being able to track the lifecycle of all reported incidents detected by sensors and/or inspection reports/work orders. The lights can be used to accurately detect/count the number of people who enter and use a restroom/bathroom as well as to communicate with the sensor for that can count/determine/monitor the levels for trash cans including determining when the trash can is full or nearing full. The lights can be used to gather and transmit real time feedback from customers on satisfaction of restroom cleanliness and availability as well as gather additional input if satisfaction is negative. The present invention can be used to communicate with the sensors that monitor supplies levels for all consumables including but not limited to paper towels, toilet paper and soap. The monitoring of the soap level can be determined, for example, but not limited to by constructing a metal envelope around the plastic soap container in the soap systems installed in and under the sink and measuring the capacitance of the soap container. The capacitance of the soap container will decrease as the soap is depleted due to the dielectric constant of the soap being higher than air. Embodiments of the present invention can accurately detect/count the number of people who utilize each stall, urinal, and sink by using, but not limited to, using motion and/or occupancy sensors of any type including but not limited to those discussed herein to detect the people/persons using the stalls, urinals, sinks and communicate that information to the lighting. In addition the lights can provide a visual occupancy indicator at each stall for example, but not limited to, a light or lights that communicate and are in some embodiments of the present invention powered by the light. In some implementations of the present invention a restroom usage display at a location at each restroom which could be for example but not limited to the entry that the current restroom occupancy and availability and expected duration of usage for example but not limited to the individual occupancy as well as adjacent and other nearby restroom availabilities. In addition implementations of the present invention can communicate to the lamps information from sensors that can detect a surface cleanliness of for example but not limited to the floor, counter, etc. and establish a baseline for a clean surface and then determine if there is a variance from clean baseline to trigger cleaning alerts. Embodiments of the present invention can use wireless sensors that retrofit to, for example, but not limited to existing paper towel dispensers, toilets, toilet paper dispensers, seat cover dispensers, soap dispensers, towel dispensers, etc. using for example but not limited to rotary encoders, linear encoders, rotary variable resistors, pressure sensors, and related electronics to measure, for example, the rotation of the paper towel, toilet paper dispensers, paper towel dispensers, other dispensers to determine the amount of paper used and left and transmit that information. A wirelessly communicating pressure sensor can be used for example but not limited to measuring the force/pressure exerted by the remaining paper seat covers and correlate to the number of paper seat covers remaining and transmit that information to the lights which can then communicate to the web and/or the cloud and/or a server. In some implementations of the present invention existing motions sensing/detecting elements in the for example but not limited to paper towels, soap dispensers, faucets, toilet paper, etc. can be used to provide information to the retrofit sensors including wired and wireless communication sensors so as to be able to use these existing sensor and detectors such as but not limited to motion, occupancy, etc. to provide information for example but not limited to on usage, depletion, need to resupply, operational status, reserve, etc. Embodiments of the present invention can use the lights to provide, for example but not limited to, information and indication of the occupancy of stall(s) including but not limited to bathroom, parking, food, ordering, payment, any type of stall(s), etc. Such indication could include changes in the light(s), lighting of the fixture, luminaire, etc. either or both internally or externally including but not limited to changes in the color or one or more lights or indicator lights, flashing or otherwise signaling, etc., changes to but not limited to a dashboard, monitor, TV, etc. Embodiments of the lights can also determine the number of persons in a given space using for example but not limited to stereo cameras, 3D cameras, thermal imaging, people counting/counters, dust sensors, pollution sensors, WiFi probe requests, BLE sniffing, detection, identification of surrounding BLE devices, etc. The lights may also be used a gateway or lightway for the sensors to be able to communicate with web/cloud and act as a gateway/aggregator for the sensors.

Multiple light sensors at different angles with, in some embodiments, different focal points can be used as part of the present invention. The multiple sensors can be located in the same housing or disbursed, distributed, etc. and communicate by wired or wireless means. Some embodiments of the light sensor(s) include a sleek nearly 2-D (i.e., very thin) sensor that can be mounted at appropriate places including on the wall. Some embodiments of the invention provide plug and play installation while producing constant lumens outputs.

Some embodiments of the present invention use capacitors in series to limit AC line (50, 60, 400 Hz, etc.) input current and power and use capacitors in parallel to limit ballast (output) input (to the circuit) current and power which can also prevent mis-wiring which might cause damage. Short circuit protection (SCP) can also be used in conjunction to also limit current and prevent damage.

Some embodiments of the present invention provide a USB port which can used to set addresses, ID, upload new versions, set priorities, set and program priority levels, etc.

Some embodiments of the present invention can be used to provide festive lighting including for holidays (Christmas, New Years, Halloween, Fourth of July, St Patrick's Day, etc.), favorite/local (high school, college, university, professional) team, company, state, personal, college, university, etc., colors, etc.

Some embodiments of the present invention provide the ability to disable current control (e.g., constant current/constant lumens) including remotely disable in ballast mode.

Some embodiments of the present invention include a fluorescent tube replacement such as a T1, T2, T3, T4, T5, T8, T10, T12, etc. lamp fixtures that can use a motor or similar device to raster or scan the SSL/LED lighting which could include but is not limited to one or more white color temperatures, one or more colors including but not limited to red, green, blue, amber, yellow, etc., combinations of these, etc. Some implementations of the present invention can include but are not limited to addressable arrays of LEDs including white color temperatures (W, WW, WWW, etc.) and colors such as RGB, RGBA, etc.

Some embodiments of the present invention can measure the input current, voltage, power, power factor, etc. of, for example, but not limited to, each unit (lamp), the group or groups of lamps controlled by a ‘wall dimmer’ of the present invention, etc. By measuring such input power used/consumed, implementations of the present invention can measure/calculate/determine/etc. the power/energy consumed and the both the energy (which essentially equals power x time) consumed and the energy saved for example, but not limited to, for the SSL/LED direct fluorescent replacement lamp that, for example, uses a ballast or a SSL/LED AC retrofit fluorescent replacement lamp that runs directly off the AC power and use such information to calculate the energy savings including but not limited to the energy savings based on the difference between the old/previous fluorescent lamp with ballast. Using such energy savings measurements/calculations/determinations/etc., the monetary savings value can be calculated/deduced/determined, etc. from the energy cost rate for example, but not limited to, by using the energy cost in, for example, but not limited to, multiplying the energy (equals power times time) in for example, but not limited to, kilowatt-hours (kWH) times the rate (in, for example, dollars per kWH=$/kWH) to determine the financial monetary savings. Such monetary savings can be used as the basis for determining the return on investment or, for example, to determine the value of a leasing agreement, etc. Such information, determinations, processing, etc. can be done, stored, compiled, performed, etc. by firmware, software, etc., stored anywhere in one or more locations, including but not limited and not necessarily in embodiments and implementations of the present invention, etc. (and more types of places, locations, facilities, etc.).

Some embodiments of the present invention include dimming/control units that can also optionally measure and monitor and log data, information, performance, etc. Such embodiments can use 0 to 10 V, 0 to 3 V, other analog protocols, ranges, etc., powerline communications, wireless, wired other digital protocols, etc., forward or reverse phase dimming of any kind and type including ones that involve one or more of triacs, transistors, diodes, etc., combinations of these, etc. and can use light level motion, ultrasonic, noise, sound, voice, etc.

The present invention includes power supplies and drivers that are ballast replacements (ballast replacement power supplies and ballast replacement drivers (BRPS and BRD, respectively) designed specifically for SSL/LED/OLED/quantum dot FLRs).

Some embodiments of the present invention can be used to replace, for example, 32 W with a lower wattage that can be increased manually or automatically by, for example, but not limited to, switches, software, hardware, firmware, etc.

Some embodiments of the present invention can use a smart/intelligent circuit breaker that, in addition to performing normal circuit breaker functions, can be turned on and off by wired, wireless and/or powerline communications

Some embodiments and implementations of the present invention can work with virtually any type of ballast including all types of magnetic and electronic ballasts and, regardless of the ballast type and ability (i.e., a fixed power, non-dimmable, non-controllable, etc. ballast) make the ballast and fluorescent lamp replacement into a smart and intelligent system capable of virtually any control and monitoring including but not limited to daylight harvesting, dimming, motion, noise, audio, ultrasonic, sonar, radar, proximity, cell phone, RFID, light, solar, time of day, week, month, date, etc., web, environment, etc. sensing and responding, etc. one or two way communications, data logging, analytics, fault reporting, etc. and other functions, features, modes of operation, etc. discussed herein. Such embodiment and implementations can also be implemented to work directly with AC and/or DC power. Although primarily discussed in terms of fluorescent lamp replacements, all of the functions, abilities, capabilities, features, modes of operation, approaches, methods, techniques, technologies, designs, architectures, topology, etc. apply directly and equally to high intensity discharge (HID) lighting including but not limited to metal halide, and all types of sodium and other gaseous low pressure and high pressure lighting, etc., other types of lighting discussed herein including various types of fluorescent lighting including but not limited to compact fluorescent lamps, PL and PLC fluorescent lamps, cold cathode fluorescent lamps, T1 through T13 fluorescent lamps including but not limited to T4, T5, T8, T12, fluorescent lamps of any length and shape including but not limited to linear, U-shaped, rectangular shape, one or more U-shaped, etc.

The heater emulation circuits may employ one more switches that can open or close as needed depending on for example, frequency of applied current, voltage, power, etc., temperature, operating conditions, etc., type of ballast, etc. Such one or more switches can be of any appropriate type or form including ones that are manually or automatically activated, mechanically or electrically activated, are semiconductor switches such as but not limited to field effect transistors (FETs) including but not limited to MOSFETs, JFETs, UFETs, etc., of both depletion and enhancement types, bipolar junction transistors including but not limited to PNP and NPN, heterojunction bipolar transistors (HBTs), unijunction transistors, triacs, silicon controlled rectifiers (SCRs), diacs, insulated gate bipolar transistors (IGBTs), GaN-based transistors including but not limited to GaNFETs, silicon carbide (SiC) based transistors including but not limited to SiCFETs, etc., solid state and mechanical relays, reed relays, electromechanical relays, latching relays, contactors, etc. photodiodes, phototransistors, optocouplers, etc. vacuum tubes, etc. thermistors, thermistor-based switches, etc. Temperature sensing can be accomplished using any technique including but not limited to thermistors, semiconductor junctions, thermocouple junctions, resistors, fuses, thermal methods, etc.

The present invention provides for convenient replacements for fluorescent, HID and other types of lighting using SSL including but not limited to LEDs, OLEDs, QDs, etc. that enables smart and intelligent operation where there was none before. Embodiments of the present invention provide for SSL FLRs that can perform smart and intelligent dimming and power reduction including autonomously, automatically, manually, with one-way or two-way (i.e., bidirectional) communications and reporting using smart local or remote sensors including but not limited to those discussed herein. Such sensors can be manually, automatically, programmed, modified, set, determined, changed, etc. including locally and remotely. For example, a motion sensor can be programmed/set by, for example, but not limited to, an app on a phone, tablet, laptop, other personal digital assistant, other device, etc. for sensitivity, time on, time off, trigger level, distance, reporting level and status, alarms, etc. either locally or remotely via, for example, but not limited to, an phone/tablet app. In addition, embodiments and implementations of the present invention can also be set to monitor and report back any fault conditions including but not limited to power interruptions, power loss, improper operation, too little power, too much power, too much voltage (over voltage), too little voltage (under voltage), too little current (under current), too much current (over current), too little light output, too much light output, too high of a temperature, too low of a temperature, etc., arcing, damage, combinations of these, etc. and alert/request maintenance/repair, etc.

Bathroom, closet, stairwell, garage, conference room, other locations which may or may not be used frequently, etc. can make use of the ballast-compatible direct fluorescent lamp replacement embodiments of the present invention including but not limited to the smart/intelligent ones discussed herein.

Embodiments of the present invention can also monitor and report power, current, voltage usage to, for example, but not limited to, measure, determine and calculate energy and cost savings and to also, but not limited to, determine SSL/LED usage in terms of hours on and current through the SSL/LEDs to determine, estimate, extrapolate, calculate, etc. lifetime remaining, SSL/LED degradation, depreciation, etc. Optional temperature and/or light sensors may also be used to keep track, track, log, perform additional analytics including but not limited on the lifetime, performance, degradation, decrease in lumens, lumens depreciation, etc. of the SSL/LEDs, etc.

The present invention can be used to replace any and all types of gaseous lighting including but not limited to fluorescent, HID, metal halide, sodium, low and/or high pressure lamps, etc. for parking lights, street lights, outdoor lights, indoor lights, sports lights, gymnasium lights, office lights, stair well lighting, virtually any type of indoor or outdoor lighting, stair case lights, bathrooms, closets, bedrooms, living rooms, family rooms, hospitals, hospital rooms, surgery rooms, urgent care, emergency care, classrooms, auditoriums, offices, lobbies, gyms, sports centers, community centers, recreational centers, libraries including but not limited to libraries for schools, colleges, universities, public and private libraries, study areas, individual cubicle lighting including, for example, but not limited to individual lighting in a library where the lighting preference including, for example, but not limited to light intensity, color temperature, color rendering index (CRI), light pattern and location, etc., color lighting, etc. could be selected for/by, etc. each individual or user, etc. and also includes additional facilities, rooms, homes, residences, apartments, etc. Implementations of the present invention can also be used for cleanroom applications including but not limited to photolithography applications and locations where the wavelength and associated energy, color, etc. must be restricted to typically a yellow color or below (i.e., to the red wavelengths as opposed to the blue wavelengths). For such implementations yellow SSL including but not limited to yellow phosphor coated (PC) SSLs including LEDs, OLEDs, QDs, etc. can be used to provide the appropriate and needed color of light while still being highly efficient and with long life.

Implementations of the present invention can also use emotion sensors and mood sensors.

Systems of SSL FLR, direct AC replacement kits, panels including panels of any size from inches (or less) on a side to feet on a size and larger including but not limited to 1×2 foot, 2×2 foot, 1×3 foot, 2×3 foot, 2×4 foot, 3×4 foot, 4×4 foot and larger (and also smaller), PLC lamps, PAR lamps, A lamps, R lamps, BR lamps, etc., any other type of lamp, light, light fixture, combinations of these, etc.

Embodiments of the present invention can control, monitor, color change, color temperature change, etc. all types of lighting which can all be controlled by the same interface and control

In some embodiments of the present invention, the lighting can be set/programmed including but not limited to active and/or dynamic processing, programming, synchronizing, sequencing the lighting so that, for example but not limited to, the lighting being on, turned on/off, dimmed, etc. in certain ways, paths, etc. from less than one second to more than one hour. Such embodiments allow for special effects including the appearance that the light is following, leading, shadowing, tracking, anticipating, etc., combinations of these, etc. the movement, direction, destination, or location, etc. that one or more people, living creatures, persons with permission, persons without permission, etc. may be heading to, going toward, etc. Such embodiments may use but are not limited to one or more motion sensing, radar, movement, vibration, sonar, ultrasonic, ultrasound, camera(s), vision recognition, pattern recognition, photocells, photo detector(s), electric eye(s), RFID, cell phone signals, smart phone signals, tablet signals, RF signal strength/detection including but not limited to Bluetooth, other 2.4 GHz, ISM, WiFi, ZigBee, ANT, ANT+, DASH7, IEEE 802.15/IEEE 802.15.4-2006, Indoor positioning system (IPS), MyriaNed, Ultra-wideband (UWB), WB Forum, USB, Wireless USB, MyriaNed, other types, protocols, frequencies, etc. discussed herein, etc., combinations of these, as well as other information including methods of identification, badge/sign-in entry, time of day, database information, web based information, signals, data, etc., day, date, weather, temperature, humidity, light level, solar/Sunlight level, gesturing, facial expressions, movements, ambient conditions, environment, track speed including but not limited to of a person or persons, etc., animal(s), other living creatures, animate or inanimate objects, etc. Such embodiments can make the speed of on/off and or dimming to whatever is desired, needed, required including from extremely fast to extremely slow. Such embodiments may be used for any application or use including but not limited to indoor and/or outdoor applications including but not limited to hallways, rooms, meeting locations, conference rooms, conference centers, convention centers, sports events centers, to and from locations such as bathrooms, open or closed/covered parking lots and locations, street lighting, including but not limited to for pedestrians and vehicles, freeway and highway road and other lighting, signage lighting including but not limited to roadside and billboard lighting.

Embodiments of the present invention can have a wireless or wired device provide one or more and especially more than one 0 to 3 V and/or 0 to 10 V or other analog and/or digital signals including but not limited to simple and/or complex pulsing including simple to complex and sophisticated PWM. Such embodiments can control/monitor/log/store/analyze/perform analytics, etc. on more than just the lighting and can also be used to do different things including but not limited to heat, cool, light, protect, detect, etc. Such implementations can be used for more than lighting and include but are not limited to heating, cooling, HVAC, temperature, humidity, window coverings, entertainment, etc. as well as lighting including specialized lighting and general lighting.

Some embodiments of the present invention include implementations that can replace the ballast power with power supplies that effectively and essentially perform the same function as the ballast but are specifically designed to work with present invention fluorescent lamp replacements and provide a constant AC or DC current to the present invention. Such embodiments of the present invention can, for example, but not limited to, provide numerous additional functions, features, etc. including remote control, monitoring, logging, tracking, analytics, dimming, scheduling, etc. using, for example, but not limited to, wired, wireless, powerline control (PLC), etc. Such embodiments of the present invention can also have a maximum current level set and also a maximum voltage level set.

Some embodiments use a DC buss—for example, 24 V to supply all of the ballast (re-wire from AC line voltage (e.g., 120 VAC, 240 VAC, 277 VAC, 347 VAC) to DC) using, for example, a AC to DC power supply, an off-grid source such as, but not limited, to solar, geothermal, hydro, fuel cell, battery, etc., combinations of these, etc.

In some embodiments of the present invention, a wireless or wired or powerline interface may be used to dim/control enabled. Buck-boost, boost, boost-buck, flyback, forward converter, push-pull, SEPIC, Cuk, two-stage converter, inverter, etc. can be used. Such a system can use virtually any type of light source including solid state lighting to be powered off of fluorescent lamp fixtures using any type of power source including but not limited to ballasts and AC line voltage. In some embodiments, the user can replace, mix and match, change, etc. light or power supply/driver or any type of accessories including but not limited to fans, microphones, speakers, sensors, detectors, cameras, etc.

Some embodiments of the invention make measurements of the external voltage and current to determine output power.

Some embodiments of the invention use daisy chain power drops. Some embodiments of the invention can detect shorts and are short circuited protected (SCP). Embodiments of the present invention can ensure that maximum power is not exceeded by measuring and determining the power being drawn.

The present invention supports/can use low voltage approaches as well as AC to low voltage DC.

Some embodiments of the present invention can use powerline communications including but not limited to either AC or DC or both AC and DC power communications.

Some embodiments of the present invention can use the isolated dimming function with isolated voltage/power to safely power, for example, but not limited to, sensors including, but not limited to, motion, sound, voice, voice recognition, noise, proximity, sonar, radar, ultrasonic, daylight harvesting, solar, light, signal strength including wireless signal strength, etc., combinations of these, etc., in addition to others, etc.

Some embodiments of the invention can use one or more lighting fixtures of any type or form including ceiling, wall, desk, etc. to communicate, for example, but not limited to communicate sensor information regarding light intensity, sound, solar, photo, color, spectrum, motion, sound, voice, voice recognition, noise, proximity, sonar, radar, ultrasonic, daylight harvesting, solar, light, etc., combinations of these, etc., as well as other, etc. As an example, a desk lamp or other object, piece of equipment, computer, computer monitor, television, desk, wall, shelf, cabinet, etc.

In some embodiments of the invention, a desk lamp can be used to support, house, power, etc. one or more smart/intelligent sensors including, but not limited to, light intensity, sound, solar, photo, color, spectrum, motion, sound, voice, voice recognition, noise, proximity, sonar, radar, ultrasonic, daylight harvesting, solar, light, etc., combinations of these, etc., etc., etc. as well as others, etc., etc. that are incorporated into the desk lamp. For example, a desk lamp can have one or more photosensors that sense the light level and report, adjust, etc. the overhead lighting, including but not limited to the smart, dimmable FLRs.

Some embodiments of the invention use one or more hangars to hang/support lighting. Some embodiments of the invention use bar codes (and bar code readers) or the squares that cell phones/tablets read, etc. to read in the ID/Address/Name/etc. of each smart/intelligent lamp, dimmer, light, etc. so as to assign each to its proper place.

Some embodiments of the invention include circuits to link to watches and in particular smart watches, wearable watches, health monitoring watches, FitBit, Apple watches other health and fitness watches, etc.

Some embodiments of the invention include circuits to link to watches to interact with, control, dim, monitor, light and other systems.

Some embodiments of the invention include motion detectors for outdoor outside that can have motion sensor, ultrasonics, noise, etc. separate from the light source and connected via Bluetooth Smart, BLE, USB, use WEB and/or Cloud and other info including but not limited to weather, wind, wind speed, could coordinate with other sensors, lights, etc. feedback information, etc.

Some embodiments of the invention includes lamps that can be all or partially screen printed, 3D printed, etc. including custom designs, customized designs, etc. using, for example, UL or CE approved, recognized, listed, etc. materials.

Some embodiments of the invention use proximity sensors and/or beacons, identifiers, etc. to identify who is near including by cellular/smart phone, smart watch, other Bluetooth devices, RFID, others, etc. and take appropriate actions including settings selection based on profile information stored, learned, memorized, etc.

Some embodiments of the invention advertise and obtain Bluetooth and other ID, etc.

Some embodiments of the invention use display panels including but not limited to OLED panels, tablets, etc. as lighting panels.

Some embodiments of the invention use a synchronous bridge for the dimmer. Some embodiments of the invention can also have a TRIAC that is, for example, but not limited to being in parallel with the diodes and transistors of embodiments of the present invention.

Some embodiments of the invention include motion sensing for either outdoor or indoor that can wirelessly, wired and/or powerline communications set, program, control, monitor, log, respond, alert, alarm, etc. including being able to be part of a cluster, group, community of lights, etc., that provides, for example, but not limited to, protection and security, etc., can, for example, but not limited to, detect a defective light, light (burned) out, can provide dimming, can use one or more colors of white, RGB, etc., can dim up and dim down, etc., Can control, set, program, sequence, synchronize, etc. all parameters including but not limited to distance, length of time on, sensitivity, ambient light level, response, synchronizing with outdoor and indoor motion sensors, response including but not limited to white color temperature and/or color choice(s), flashing or solid on, flashing, sequences of flashing, sequences of flashing and solid on, etc. of one or more colors including but not limited to one or more white colors, one or more white colors with one or more other colors, one or more colors,

Some embodiments of the invention include sensors in the light(s), sensors attached to and/or near the light(s), sensors remote from the lights including battery powered, AC powered, solar powered, energy harvested, battery charged, etc., combinations of these, etc., including, for example, but not limited to, solar power battery charging.

Some embodiments of the invention are adapted for use in stairwells, etc. especially ones that have doors to entry, use a device that makes a sound when the door is opened so that the light source ‘hears’ the sound and turns on. Can use any device, approach, method, etc. that can convey that the door is opened or someone has passed through the door including, for example, but not limited to, photoelectric beam and photoelectric eye, magnetic proximity switch, other types of detection of open door, etc., can use two tone or more tone frequency, etc.

Some embodiments of the invention can use active or passive or both high pass, low pass, bandpass, notch, other filters, combinations, etc. including with the voice, sound, noise detection.

Some embodiments of the invention can use isolated digital PWM that can be converted to analog near the control reference point.

Some embodiments of the invention can use proximity and/or signal strength to decide, for example, but not limited to turn on or off lights, etc.

Some embodiments of the invention can flash at the end of an allotted time to indicate that the next group is ready to use, for example, a conference room.

Some embodiments of the invention can listen for and respond to emergency sounds such as smoke, fire, carbon monoxide (CO), etc. detectors, sensors, etc. by flashing, turning on, forwarding the information, alert, alarm, etc.

Some embodiments of the invention can be powered over Ethernet (POE), dimmed, controlled, monitored, logged, two way communicated with, data mined, analytics, etc. Can be powered, controlled, monitored, managed, etc. via wired or wireless or powerline control (PLC) including but not limited to serial communications, parallel communications, RS232, RS485, RS422, RS423, SPI, I2C, UART, Ethernet, ZigBee, Zwave, Bluetooth, BTLE, WiFi, cellular, mobile, ISM, Wink, powerline, etc., combinations of these, etc.

Implementations of the present include but are not limited to solid state lighting system with color controllable multiple light sources in accordance with some embodiments of the invention. For example, a solid state lighting system may include a solid state light fixture with multiple flat lighting panels including, for example, but not limited to LEDs and OLEDs and multiple solid state point light sources such as LEDs. The shape, layout, form factor, and types and numbers of light sources are merely examples and should not be viewed as limiting in any manner. Embodiments of the present invention can also have lighting on the outside of, for example, the light bar, panel, etc. including direct lit, edge lit, back lit, etc. Some example embodiments are shown below which can also include one or multiple LEDs, OLEDs, QDs that can consist of one or more of white, red, green, blue, amber, yellow, orange, etc. In addition, such lighting can be used to convey information about the status of a situation including flashing lights which may convey emergency situations, etc. In some embodiments, the SSL can provide evening/night light using for example amber-orange-yellow SSLs including but not limited to LEDs and/or OLEDs that can be dimmed, flashed, color-changing, sound alarms, sequence, provide time of day and circadian rhythm, etc. Some embodiments of the present invention can have light, motion, proximity, noise, sound RFID, NFC, etc. sensors that are either internal or external and connected by one or more of wired, wireless, powerline communications (PLC), etc.

Some embodiments of the present invention can include LEDs. OLEDs, QDs, other SSLs, other types of lights, etc. combinations of these, etc. and can include combinations of flashing, sequencing, dimming, changing colors, individually and/or collectively, etc., sirens, alarms, alerts, web connectivity, wired, wireless and/or PLC, etc.

Embodiments of the present invention can include solid state lighting systems with isolated control inputs. The SSL systems can be powered by any suitable source(s), such as, but not limited to, a ballast output via heater emulation and rectification circuits(s) and/or AC inputs via EMI filter and rectification circuits(s). Power supply circuits can pass power through to solid state lights and can provide one or more of the functions disclosed herein, such as, but not limited to, current control, undervoltage protection (UVP), overvoltage protection (OVP), short circuit protection (SCP), over-temperature protection (OTP), etc. Dimming control signals, either or both wired and wireless, can be used to control the power supply circuits, including, for example, using isolated dimming inputs (e.g., 0 to 10 V, 0 to 3 V, digital, etc.) Other embodiments of the present invention can also monitor, log, store, etc.

Some embodiments of the invention can include indoor and/or outdoor motion sensors. The lights and, for example, sensors can have auxiliary ports that allow both control signals and other types of sensors, detectors, features, functions, etc. including, for example, but not limited to, motion, sound, video, vision recognition, pattern recognition, etc., combinations of these, etc. The indoor and outdoor embodiments can be very similar except for weather-proof for outdoor uses. Embodiments of the present invention can use existing lighting fixtures, including those with or without motion sensing and make them motion sensing capable including having the motion sensing inside the light source or as an extension to the light source that can be plugged into the light source and control the turning on/off and dimming up/down of the light source(s), etc., other sensors, alarms, alerts, communications, etc. can be added to embodiments of the present invention as well as being capable of being compatible with existing/legacy lighting including, for example, but not limited to motion detection, security, photoelectric cell/dusk to dawn lighting, etc., combinations of these, etc., including for example but not limited to, detecting when a conventional, non-communicating motion detector light fixture turns on and wirelessly or wire (or, in some cases, PLC) reporting, communicating, logging, tracking, etc. such information, etc. Embodiments of the present invention can also completely set all parameters of the present invention including but not limited to, the light level, detection threshold, detection level, distance, proximity, etc., notify under what conditions, notify neighbors, etc., light level to turn on at, whether to flash or not, etc., detection, sniffing, identification, etc. of smart devices including but not limited to smart phones, cellular phones, tablets, smart watches, wrist watches, fitness, well-being watches, PDAs, mobile devices, RFID, wearables, sounds, noise, voice(s), one or more certain frequencies, other types of technologies that can be used in tandem, conjunction with the present invention, other signatures, signs, identification, etc., combinations of these. Embodiments of the present invention can use such information to decide or aid in deciding whether the detection is due to, for example, but not limited to, a friend or foe and an unidentified source or object, person, animal, wind, etc.

Embodiments of the present invention can record, store, analyze, keep track of, for example, the frequency of such occurrences and incidents, including any new digital, electronic, or other information including unique information about the device or person, etc. such as cellular phone identifiers, RF/wireless IDs, names, user names, etc. In addition, embodiments and implementations of the present invention can use optical or other methods to act as an intruder alert system such that, for example, but not limited to, an optical beam that connects two or more of the present invention including, examples where the two or more embodiments of the present invention have direct line of sight to each other and effectively have a beam of light in between that is broken or disrupted, etc. Such a beam of light can be modulated with the user able to select one or more from a variety of modulations so as to make it more difficult to emulate the beam, etc. Such beam modulations and detection can be two or more way so as to add to the reliability and security, etc.

Some embodiments of the invention can be configured, controlled, monitored, etc., from/to smart devices using for example, but not limited to, Apps, laptops, desktops, servers, mobile and/or PDA devices of any type or form, combinations of these, etc.

Some embodiments of the invention can include motion sensors performing multiple duties—turning on/off lights, alerting that there are people there, heating or cooling spaces, burglar alarm, camera, image recognition, noise, voice, recognition, sound recognition, etc. accessories, thermal imagers, night vision, infrared cameras, infrared lit cameras, infrared imagers, etc., combinations of these, etc.

In some embodiments of the present invention, a small PWM pulse width can be the default pulse width such that the amount of power/current at the highest input voltage will limit the power applied without a signal to increase the pulse. This will allow a current/power limit in the event of, for example, a short circuit on the output since a small pulse to big pulse is needed for higher power in AC line voltage mode. The pulse width can be made larger by a circuit that measures the pulse width and allows the pulse width to increase until the desired current level is attained.

Some embodiments of the invention can include outdoor motion sensing with smart additional components, accessories, etc. Sense includes weather, including from any source such as a local weather station, personal weather station, web-based weather report, etc. Smart Motion sense can also dim, flash, change intensities, white colors, be color-changing, etc., communicate two or more way, etc., monitor weather locally, regionally, wind factor, have a wind indicator, etc., wind vane, wind generator, etc.

Implementations of the present invention are designed to be a cost-effective and complete solution that provides both forward and backward compatibility which is also ideal for retrofits and can use either wireless or wire (or both) communications.

Implementations of the present invention include comprehensive sensing and monitoring. Implementations of the present invention can be Web-based and/or WiFi-based (or other) and interface with smart phones, tablets, other mobile devices, laptops, computers, dedicated remote units, etc. and can support a number of wireless communications including, but not limited to, IEEE 802 and various others, etc., ZigBee, WiFi, LiFi, LoRa, Bluetooth, ISM, etc.

Implementations of the present invention can include, but not limited to, dimmers, drivers, power supplies of all types, switches, motion sensors, light sensors, temperature sensors, daylight harvesting, other sensors, thermostats and more and can include monitoring, logging, analytics, etc.

Embodiments of the present invention support and can include color changing, color tuning, etc. lights with numerous ways to interact with the lights.

Embodiments of the present invention can be integrated with video, burglar, fire alarm, etc. components, systems.

Other features and functions include but are not limited to detecting the frequency using a microprocessor, microcontroller, field programmable gate array (FPGA), DSP, etc. The use a switch including, for example, a transistor such as a field effect transistor (FET) such as a MOSFET or JFET to, for example, either turn on or turn off a circuit that operates in either ballast mode or AC line mode depending on the amplitude of the signal or with the inclusion of a time constant, the average, RMS, etc. voltage level. Embodiments of the present invention removes the requirement that a reference level and a comparison to the reference level is required to detect the amplitude of the waveform

The present invention can also have sirens, microphones, speakers, earphones, headphones, emergency lights, flashing lights, fans, heaters, sensors including, but not limited to, temperature sensors, humidity sensors, moisture sensors, noise sensors, light sensors, spectra sensors, infrared sensors, ultraviolet sensors, speech sensors, voice sensors, motion sensors, acoustic sensors, ultrasound sensors, RF sensors, proximity sensors, sonar sensors, radar sensors, etc., combinations of these, etc.

The present invention can also provide two or more side (multi-side) lighting for example, for a FLR where one side contains SSL that, for example, consists of white color or white colors of one or more color temperatures and another side contains SSL or other lighting of one or more wavelengths such as red, green, blue, amber, white, yellow, etc., combinations of these, subsets of these, etc. The two or more sided lighting can perform different functions—for example, the side that is primarily white or all white light of one or more color temperatures can provide primary lighting whereas the side that has one or more color/wavelengths of light can provide indication of location, status, code level in, for example, a hospital (i.e., code red, code blue, code yellow, etc.), accent lighting, mood lighting, location indication, emergency information and direction, full spectrum lighting, etc.

The present invention can work with all types of communications devices including portable communications devices worn by individuals, walkie-talkie types of devices, etc.

The present device can use combinations of wireless and wired interfaces to control and monitor; for example for a linear or other fluorescent replacement for, for example, but not limited to, T4, T5, T8, T9, T10, T12, etc. lamps and fixtures. One (or more) of the replacements can be wireless with wired connections from the one (or more) replacement(s) to the other replacements such that the one or more wireless replacements acts as a master receiving and/or transmitting information, data, commands, etc. wirelessly and passing along or receiving information, data, commands, etc. from the other remaining wired slaved units. In other embodiments one or more wired masters/leaders may transfer, transmit, or receive, etc. information, data, commands from other wireless and/or wired equipped fluorescent lamp replacements, etc. of combinations of these.

The present invention can also have one or more thermometers, thermostats, temperature controllers, temperature monitors, etc., combinations of these, etc. that can be wirelessly or wired interfaced controlled, monitored, etc. Such one or more thermometers, thermostats, temperature controllers, temperature monitors, etc., combinations of these, etc. can be connected/interfaced, for example, but not limited to, by Bluetooth, Bluetooth low energy, WiFi, IEEE 801, IEEE 802, ZigBee, Zwave, other 2.4 GHz and related/associated standards, protocols, interfaces, ISM, other frequencies including but not limited to, radio frequencies (RF), microwave frequencies, millimeter-wave frequencies, sub millimeter-wave frequencies, terahertz (THz), mobile cellular network connections, combinations of these. Wired connections, interfaces, protocols, etc. include but are not limited to, serial, parallel, UART, SPI, I2C, RS232, RS485, RS422, other RS standards and serial standards, interfaces, protocols, etc. powerline communications, interfaces, protocols, etc. including both ones that work on DC and/or AC, DMX, DALI, 0 to 10 Volt, other voltage ranges including but not limited to 0 to 3 Volt, 0 to 5 Volt, 1 to 8 Volt, etc.

In some embodiments of the present invention, the thermometer(s) and/or thermostats may be remotely located. In other embodiments of the present invention, such a temperature sensor or sensors or thermostat or thermostats can use wireless or wired units, interfaces, protocols, device, circuits, systems, etc. In some embodiments the thermometer(s) and/or thermostat(s) can communicate with each other and relay, share, and pass commands as well as provide information and data to one another.

In addition, embodiments of the present invention can use switches that are remotely controlled and monitored to detect the use of power or the absence of power usage, to open or close garage or other doors by locally and/or remotely sending signals to garage door openers including acting as a switch to complete detection circuits, remembering the status of garage door opening or closing, working with other motion sensors, photosensors, etc. horizontal/vertical detectors, inclinometers, etc., combinations of these, etc. Embodiments of the present invention can both control and monitor the status of the garage or other door and sound alarms, send alerts, flash lights including flashing white lights and/or one or more color/wavelength lights, turn on lights, turn off lights, activate cameras, record video, images, sounds, voices, respond to sounds, noise, movement, include and use microphones, speakers, earphones, headphones, cellular communications, etc., other communications, combinations of these, etc. Such embodiments and implementations can use Bluetooth, Bluetooth low energy, WiFi, IEEE 801, IEEE 802, ZigBee, ZWave, other 2.4 GHz and related/associated standards, protocols, interfaces, ISM, other frequencies including but not limited to, radio frequencies (RF), microwave frequencies, millimeter-wave frequencies, sub millimeter-wave frequencies, terahertz (THz), mobile cellular network connections, combinations of these. Wired connections, interfaces, protocols, etc. include but are not limited to, serial, parallel, SPI, I2C, RS232, RS485, RS422, other RS standards and serial standards, interfaces, protocols, etc. powerline communications, interfaces, protocols, etc. including both ones that work on DC and/or AC, DMX, DALI, 0 to 10 Volt, other voltage ranges including but not limited to 0 to 3 Volt, 0 to 5 Volt, 1 to 8 Volt, etc., relays, switches, transistors of any type and number, etc., combinations of these, etc.

The present invention also allows various types of radio frequency (RF) devices such as, but not limited to, window shades, drapes, diffusers, garage door openers, cable boxes, satellite boxes, etc. to be controlled and monitored by replacing and integrating these functions into implementations of the present invention including being able to synthesize and reproduce the RF signals which are typically in the range of less than 1 kHz to greater than 5 GHz using one or more RF synthesizers including ones based on phase lock loops and other such frequency tunable and adjustable circuits with may also employ frequency multiplication, amplification, modulation, etc., combinations of these, etc., amplitude modulation, phase modulation, pulses, pulse trains, combinations of these, etc.

A global positioning system (GPS) can be included in the present invention to track the location and, for example, to also make decisions as to where and when the present invention should do certain things including but not limited to turning on or off, dimming, turn on heat or cooling, control and monitor the lighting, etc., control, water, monitor the lawn and other plants, trees etc.

Embodiments of the present invention can use/incorporate/include/etc. thermal imagers including but not limited to IR imagers, IR imaging arrays, non-contact temperature measurements including point temperature and array temperature measurements including in lighting such as, but not limited to, T5, T8, T10, T12, etc. replacements where the imagers are powered, for example, but not limited to the ballast, AC line, solar, alternative energy sources, combinations of these, etc.

Embodiments of the present invention allow for dimming with both ballasts and AC line voltage.

Implementations of the present invention can use, but are not limited to, Bluetooth, Bluetooth low energy, WiFi, IEEE 801, IEEE 802, ZigBee, ZWave, other 2.4 GHz and related/associated standards, protocols, interfaces, ISM, other frequencies including but not limited to, radio frequencies (RF), microwave frequencies, millimeter-wave frequencies, sub millimeter-wave frequencies, terahertz (THz), mobile cellular network connections, combinations of these. Wired connections, interfaces, protocols, etc. include but are not limited to, serial, parallel, SPI, I2C, RS232, RS485, RS422, other RS standards and serial standards, interfaces, protocols, etc. powerline communications, interfaces, protocols, etc. including both ones that work on DC and/or AC, DMX, DALI, 0 to 10 Volt, other voltage ranges including but not limited to 0 to 3 Volt, 0 to 5 Volt, 1 to 8 Volt, etc.

Embodiments of the present invention include SSL/LED Fluorescent Tube Lamp Replacements that can be used, for example, but not limited to, for daylight harvesting/occupancy uses and applications.

Embodiments of the present invention uses wireless signals to both control (i.e., dim) the LED fluorescent lamp replacements (FLRs) and monitor the LED current, voltage and power. The present invention includes but is not limited to fluorescent lamp replacements that work directly with existing electronic ballasts and requires no re-wiring and can be installed in the same amount of time or less than changing a regular fluorescent lamp tube. These smart/intelligent LED FLRs are compatible with most daylight harvesting controls and protocols. Optional sensors allow for relative light output to be measured and wirelessly reported, monitored, and logged permitting analytics to be performed. Embodiments of the present invention come in a diversity of lengths including but are not limited to two foot and four foot standard/nominal linear lengths. Additional optional input power measurements allow total power usage, power factor, input current, input voltage, input real and apparent power to also be measured thus allowing efficiency to be measured. The wireless signals can be radio signals in the industrial, scientific and medical (ISM) for lower cost and simplicity or ZigBee, ZWave, IEEE 802, or WiFi or Bluetooth or any type of form. In addition to occupancy/motion sensors, photo sensors and daylight harvesting controls, simple and low cost interfaces that allow existing other brands, makes, and models of daylight harvesting controls, photo sensors, and occupancy/motion sensors to be connected to and control/dim embodiments of the wireless SSL/LED lighting. The SSL can be switched on and off millions of times without damage as well as be dimmed up and down without damage. The wireless communications can be encrypted and secure. Such embodiments of the present invention do not require or need a dimmable ballast and work with virtually any electronic ballast.

The present invention can have integrated motion sensor as part of the housing and can also use auxiliary motion sensors and can also have integrated light/photocell sensor as well as auxiliary.

The present invention can also respond to proximity sensors including passive or active or both, as well as voice commands and can be used to turn on, turn off, dim, flash or change colors including doing so in response to an emergency situation. The present invention can use wireless, wired, powerline, combinations of these, etc., Bluetooth, RFID, WiFi, ZigBee, ZWave, IEEE 801, IEEE 802, ISM, NFC, etc. In addition the present invention can be connected to fire alarms, fire alarm monitoring equipment, etc.

Embodiments of the present invention permits enhanced circadian rhythm alignment and maintenance using sources of light. Such sources of light include, but are not limited to, computer screens, monitors, panels, etc., tablet screens, smart phone screens, etc., televisions (TVs), LCD and CRT displays of any type or form, DVD and other entertainment lighting and displays containing LEDs, OLEDs, CCFLs, FLs, CRTs, etc., displays, monitors, TVs, OLED, LED, CCFL, FL, incandescent lighting, etc.

The present invention can use smart phones, tablets, computers, dedicated remote controls, to provide lighting appropriate for circadian rhythm alignment, correction, support, maintenance, etc. that can be, for example, coordinated wake-up and sleep times whether on a ‘natural’ or shifted (i.e., night workers, shift workers, etc.) to set and align their sleep patterns and circadian rhythm to appropriates phases including time shifts and time zone shifts due to work and other related matters.

The present invention can use external and internal information gathered from a number of sources including clocks, internal and external lighting, time of the year, individual, specific input, physiological signals, movements, monitoring of physiological signals, stimuli, including but not limited to, EEG, melatonin levels, urine, wearable device information, sleep information, temperature, body temperature, weather conditions, etc., combinations of these, etc.

The present invention can use TVs essentially of any type or form, including, but not limited to smart TVs, and related and similar items, products and technologies including, but not limited to, computer and other monitors and displays that can either be remotely or manually controlled and, in some embodiments, monitored. The present invention can use smart phones, tablets, PCs, remote controls including programmable remote controls, consoles, etc., combinations of these etc., to control and set the content of the lighting (e.g., white or blue-enriched, etc. combinations of these, etc. for wake-up; yellow, amber, orange, red, etc., combinations of these, etc. for sleep-time, etc.) automatically to assist in circadian rhythm, sleep, SAD mitigation, reduction, elimination, etc. In some embodiments of the present invention, music, sounds, white noise, sea shore sounds, sound effects, narratives, live audio, inspirational audio including previously recorded, generated, synthesized, etc., soothing sounds, familiar sounds and voices, etc. and combinations of these to go to sleep with. Jarring, buzzing, alarming, beeping, interrupting sounds, alarm clock sounds and noises, sleep disruptive sounds, noises and/or voices, etc. accompanied by white light, blue color/wavelength light including, but not limited to, slowing dimming up to a preset, optimum, and/or maximum brightness or setting, etc. for wake-up in the morning. Embodiments of the present invention can provide multiple wake-ups to the same location and/or different locations including other locations in homes, houses, hotels, hospitals, dormitories including school and military and other types of barracks, dormitories, etc., assisted living homes and facilities, chronic care facilities, rehabilitation facilities, etc., children's hospitals and care facilities, etc. group living, elder living, etc., children's rooms and other family members whether in the same physical location or in different physical locations, friends and family, clients, guests, travelers, jet lagged and sleep deprived people and personnel, etc.

The present invention can have integrated motion sensor as part of the housing and can also use auxiliary motion sensors and can also have integrated light/photocell sensor as well as auxiliary. In some embodiments of the present invention, these can be stand-alone units that replace conventional fluorescent lamps including, but not limited to, T8, T12, T5, T10, T9, U-shaped, CFLs, etc. of any length, size and power as well as high intensity discharge lamps of any size, type, power, etc.

The present invention can also respond to proximity sensors including passive or active or both, as well as voice commands and can be used to turn on, turn off, dim, flash or change colors including doing so in response to an emergency situation. The present invention can use wireless, wired, powerline, combinations of these, etc., Bluetooth, RFID, WiFi, ZigBee, ZWave, IEEE 801, IEEE 802, ISM, etc. In addition the present invention can be connected to fire alarms, fire alarm monitoring equipment, etc.

The present invention can use a BACNET to wireless converter box or BACNET to Bluetooth including Bluetooth low energy (BLE) converter. The present invention can also use infrared signals to control and dim the lighting and other systems as well as other types of devices including but not limited to heating and cooling, thermostats, on/off switches, other types of switches, etc.

The present invention can have the motion proximity sensor send signals back to the controller/monitor or other devices including but not limited to cell phones, smart phones, tablets, computers, laptops, servers, remote controls, etc. when motion or proximity is detected etc. Embodiments of the present invention can have on/off switches for the ballasts where the ballasts connect to the AC lines and/or also where the ballasts connect to the present invention, etc.

Embodiments and implementations of the present invention allow for optional add-ons including but not limited to wired, wireless or powerline control to be added later and interfaced to the present invention as well as allowing sensors such as daylight harvesting/photo/light/solar/etc. sensors as well as motion/PIR/proximity/other types of motion, distance, proximity, location, etc., sensors, detectors, technologies, etc., combinations of these, etc. to be used with the present invention.

The present invention provides a means to improve circadian rhythm by providing the appropriate wavelengths of light at appropriate times.

Internal and external photosensors including wavelength specific or the ability to gather entire or partial spectrum, etc. and can use atomic clock(s) signals, other broadcast time signals, cellular phone, time, smart phone, tablet, computers, personal digital assistants, etc., remote control via dedicated units, smart phones, computers, laptops, tablets, etc.

The present invention can also have sirens, microphones, speakers, earphones, headphones, emergency lights, flashing lights, fans, heaters, sensors including, but not limited to, temperature sensors, humidity sensors, moisture sensors, noise sensors, light sensors, spectra sensors, infrared sensors, ultraviolet sensors, speech sensors, voice sensors, motion sensors, acoustic sensors, ultrasound sensors, RF sensors, proximity sensors, sonar sensors, radar sensors, etc., combinations of these, etc. The sound and/or noise sensors as well as other sensors, etc. can use one or more filters including one or more low pass, high pass, notch, bandpass including narrow bandpass filters, etc. Such filters can be realized by either or both analog and digital means, approaches, ways, functions, circuits, etc., combinations of these, etc. Such filter functions can be active or passive or both, can be manually and/or automatically set and adjustable, can be set, adjusted, programmed, etc. by an app, by other types and forms of software and hardware, by smart phone(s), tablet(s), laptops, servers, computers, other types of personal digital assistant(s), etc.

Embodiments of the present invention can have more than one wavelength or color of LEDs and/or SSLs and can include more than one array of LEDs, OLEDs, QDs, etc. that permit color selection, color blending, color tuning, color adjustment, etc. Embodiments of the present invention can include multiple arrays that can be switched on or off or in or out and/or dimmed with either power being supplied by a ballast or the AC line that can be remotely selected, controlled and monitored. Examples of the present invention include different wavelengths, combinations of colors and phosphors, etc. are used to obtain desired performance, effects, operation, use, etc. Embodiments can include one, two, three or more arrays of SSLs, including, but not limited to, side-by-side, 180 degrees from each other, on opposite sides, on multiple sides for example hexagon or octagon, etc. The SSLs including but not limited to LEDs, OLEDs, QDs, etc. may be put in series, parallel or combinations of series and parallel, parallel and series, etc. In other embodiments of the present invention, phosphors, quantum dots, and other types of light absorbing/changing materials that for example can effectively change wavelengths, colors, etc. for example by applying a voltage bias or electric field. The present invention can also take the form of linear fluorescent lamps from less than 1 foot to more than 8 feet in length and may typically be T4, T5, T8, T9, T10, T12, etc. fixtures. Such embodiments of the present invention may use an insulating housing made from, for example but not limited to, glass or an appropriate type of plastic, which may or may not have a diffuser or be a diffuser c. In some embodiments of the present invention plastic housings may be used that can include diffusers on the entire surface, diffusers on half the surface, diffusers on less than half the surface, diffusers on more than half of the surface, with the rest of the surface either being clear plastic, opaque plastic or a metal such as aluminum or an aluminum alloy.

Photon/wavelength conversion including down conversion can be used with the present invention including being able to adjust the photon/wavelength conversion electrically. Spectral/spectrum sensors can be used to detect the light spectral content and adjust the light spectrum by turning on or off certain wavelengths/colors of SSL. The spectral sensors could consist of color/wavelength sensitive detectors covering a range of colors/wavelengths of filters that only each only permit a certain, typically relatively narrow, range of wavelengths to be detected. As an example, red, orange, amber, yellow, green, blue, etc. color detectors could be included as part of the spectral/spectrum sensor or sensors. In some embodiments of the present invention, quantum dots can be used as part of and to implement the spectral/spectrum sensors.

Implementations of the present invention can include and consist of any number and arrangement of smart dimmers (by wired, wireless, powerline communications, etc. combinations of these, etc.) including ones that connect directly to the AC power lines that can control, but are not limited to, one or more of, for example, but not limited to, as an example, FLRs, A-lamps, PAR 30, PAR 38, PLC lamps, R20, R30, dimmable compact florescent lamps, incandescent bulbs, halogen bulbs, etc. as well as smart dimmable (i.e., by wired, wireless, powerline communications, etc., combinations of these, etc.), infrared controlled devices including heaters of any type or form, air conditioners of any type or form, color-changing, color-tunable, white color-changing, lighting of any type including but not limited to those discussed herein. Non-dimmable lamps and appliances and entertainment device can also be included in such implementations of the present invention and may be turned on and off by one or more of the smart on/off switches or a dimmer that is, for example, but not limited to, programmed to full on and full off only, etc. Such implementations of the present invention can also use one or more or all of the sensors, detectors, processes, approaches, etc. discussed herein and well as any other type or types of sensors, detectors, controls, etc. The smart lighting, dimmers, power supplies, sensors, controls, etc. can you any type or types of wired, wireless, and/or powerline communications. Any practical number of dimmers, lights, lighting, sensors, detectors, controls, monitoring, logging, analytics, heaters, air conditioners, fire, safety, burglar alarm(s), burglar protection, etc., appliances, entertainment devices, home safety, personal safety, thermometer(s), thermostat(s), humidifier(s), HVAC, air conditioners, furnaces, heaters, etc.

The present invention may use any type of circuit, integrated circuit (IC), microchip(s), microcontroller, microprocessor, digital signal processor (DSP), application specific IC (ASIC), field gate programmable array (FPGA), complex logic device (CLD), analog and/or digital circuit, system, component(s), filters, etc. including, but not limited to, any method to provide a switched signal such as a PWM drive signal to the switching devices. In addition, additional voltage and/or current detect circuits may be used in place of or to augment the control and feedback circuits.

Some embodiments of the present invention can accept the output of a fluorescent ballast replacement that is designed and intended for a LED Fluorescent Lamp Replacement that is remote dimmable and can also be Triac, Triac-based, forward and reverse dimmer dimmable and incorporates all of the discussion above for the example embodiments. The remote fluorescent lamp replacement ballast can use or receive control signals/commands from, for example, but not limited to any or all of wired, wireless, optical, acoustic, voice, voice recognition, motion, light, sonar, gesturing, sound, ultrasound, ultrasonic, mechanical, vibrational, and/or PLC, etc., combinations of these, etc. remote control, monitoring and dimming, motion detection/proximity detection/gesture detection, etc. In some embodiments, dimming or/other control can be performed using methods/techniques/approaches/algorithms/etc. that implement one or more of the following: motion detection, recognizing motion or proximity to a detector or sensor and setting a dimming level or control response/level in response to the detected motion or proximity, or with audio detection, for example detecting sounds or verbal commands to set the dimming level in response to detected sounds, volumes, or by interpreting the sounds, including voice recognition or, for example, by gesturing including hand or arm gesturing, etc. sonar, light, mechanical, vibration, detection and sensing, etc. Some embodiments may be dual or multiple dimming and/or control, supporting the use of multiple sources, methods, algorithms, interfaces, sensors, detectors, protocols, etc. to control and/or monitor including data logging, data mining and analytics. Some embodiments of the present invention may be multiple dimming or control (i.e., accept dimming information, input(s), control from two or more sources).

Remote interfaces include, but are not limited to, 0 to 10 V, 0 to 2 V, 0 to 1 V, 0 to 3 V, etc., RS 232, RS485, DMX, DMX512, WiFi, Bluetooth, ZigBee, IEEE 802, two wire, three wire, SPI, I2C, PLC, and others discussed in this document, etc. In various embodiments, the control signals can be received and used by the remote fluorescent lamp replacement ballast or by the LED, OLED and/or QD fluorescent lamp replacement or both. Such a Remote Controlled Florescent Ballast Replacement Panel can also support color LEDs including single and multi-color including RGB, White plus red-green-blue (RGB) LEDs or OLEDs or other lighting sources, RGB plus one or more colors, red yellow blue (RYB), other variants, etc. Color-changing/tuning can include more than one color including RGB, WRGB, RGBW, WRGBA, WWRGBA, etc. where A stands for amber, etc. 5 color, 6 color, N color, etc. Color-changing/tuning can include, but is not limited to, white color-tuning including the color temperature tuning/adjustments/settings/etc., color correction temperature (CCT), color rendering index (CRI), etc. Color rendering, color monitoring, color feedback and control can be implemented using wired or wireless circuits, systems, interfaces, etc. that can be interactive using for example, but not limited to, smart phones, tablets, computers, laptops, servers, remote controls, etc. The present invention can use or, for example, make, create, produces, etc. any color of white including but not limited to soft, warm, bright, daylight, cool, etc. Color temperature monitoring, feedback, and adjustment can be performed in such embodiments of the present invention. The ability to change to different colors when using light sources capable of supporting such (i.e., LEDs, OLEDs and/or QDs including but not limited to red, green, blue, amber, white LEDs and/or any other possible combination of LEDs and colors). Embodiments of the present invention has the ability to store color choices, selections, etc. and retrieve, restore, display, update, etc. these color choices and selections when using non-fluorescent light sources that can support color changing. Embodiments of the present invention also have the ability to change between various color choices, selections, and associated inputs to do as well as the ability to modulate the color choices and selections.

A further feature and capability of embodiments of present invention is use of passive or active color filters and diffusers to produce enhanced lighting effects.

In addition, protection can be enabled (or disabled) by microcontroller(s), microprocessor(s), FPGAs, CLDs, PLDs, digital logic, etc. including remotely via wireless or wired connections, based on but not limited to, for example, a sequence of events and/or fault or no-fault conditions, sensor, monitoring, detection, safe operation, etc. An example of protection detection/sensing can include measuring/detecting/sensing lower current than expected due to, for example, a human person being in series with (e.g., in between) one leg of the LED, OLED and/or QD replacement fluorescent lamp and one side of the power being provided by the energized ballast. The present invention can use microcontroller(s), microprocessor(s), FPGA(s), other firmware and/or software means, digital state functions, etc. to accomplish protection, control, monitoring, operation, etc.

In addition to using a switching element, a linear regulation/regulator instead of switching regulation/regulator can be used or both linear and switching regulation or combinations of both can be used in embodiments of the present invention.

Rapid start ballasts with heater connections may be made operable using resistors and/or capacitors. Certain implementations require less power and also evenly divide and resistance or reactive (e.g., capacitive and/or inductive) impedances so as to reduce or minimize power losses for the current supplied to the fluorescent lamp replacement(s). An example when having power supplied from an instant start or other ballast without heater(s) with only one electrical connection per ‘side’ of the fluorescent tube/lamp or fluorescent tube replacement (for a total of two connections) the resistors are effectively put into parallel thus reducing the resistance by a factor of four compared to being in serial for, for example, a heater emulation circuit or as part of a heater emulation circuit. Such heater circuits can contain resistors, capacitors, inductors, transformers, transistors, switches, diodes, silicon controlled rectifiers (SCR), triacs, other types of semiconductors and ICs including but not limited to op amps, comparators, timers, counters, microcontroller(s), microprocessors, DSPs, FPGAs, ASICs, CLDs, AND, NOR, Inverters and other types of Boolean logic digital components, combinations of the above, etc.

In some embodiments of the present invention, a switch may be put (at an appropriate location) in between the ballast output and the fluorescent lamp/fluorescent lamp replacement such that there is no completion of current flow in the fluorescent lamp replacement to act as a protection including shock hazard protection for humans and other living creatures in the event of an improper installation or attempt at or during installation. The detection of a such a fault or improper installation can be done by any method including analog and/or digital circuits including, but not limited to, op amps, comparators, voltage reference, current references, current sensing, voltage sensing, mechanical sensing, etc., microcontrollers, microprocessors, FPGAs, CLDs, wireless transmission, wireless sensing, optical sensing, motion sensing, light/daylight/etc. sensing, gesturing, sonar, infrared, visible light sensing, etc. A microprocessor or other alternative including, but not limited to, those discussed herein may be used to enable or disable protection and may be combined with other functions, features, controls, monitoring, etc. to improve the safety and performance of the present invention including before, during, after dimming, etc.

In embodiments of the present invention that include or involve buck, buck-boost, boost, boost-buck, etc. inductors, one or more tagalong inductors such as those disclosed in U.S. patent application Ser. No. 13/674,072, filed Nov. 11, 2012 by Sadwick et al. for a “Dimmable LED Driver with Multiple Power Sources”, which is incorporated herein for all purposes, may be used and incorporated into embodiments of the present invention. Such tagalong inductors can be used, among other things and for example, to provide power and increase and enhance the efficiency of certain embodiments of the present invention. In addition, other methods including charge pumps, floating diode pumps, level shifters, pulse and other transformers, bootstrapping including bootstrap diodes, capacitors and circuits, floating gate drives, carrier drives, etc. can also be used with the present invention.

The present invention can work with programmable soft start ballasts including being able to also have a soft short at turn-on which then allows the input voltage to rise to its running and operational level can also be included in various implementations and embodiments of the present invention.

Some embodiments of the present invention utilize high frequency diodes including high frequency diode bridges and current to voltage conversion to transform the ballast output into a suitable form so as to be able to work with existing AC line input PFC-LED circuits and drivers. Some other embodiments of the present invention utilize high-frequency diodes to transform the AC output of the electronic ballast (or the low frequency AC output of a magnetic ballast into a direct current (DC) format that can be used directly or with further current or voltage regulation to power and driver LEDs for a fluorescent lamp replacement. Embodiments of the present invention can be used to convert the low frequency (i.e., typically 50 or 60 Hz) magnetic ballast AC output to an appropriate current or voltage to drive and power LEDs using either or both shunt or series regulation. Some other embodiments of the present invention combine one or more of these. In some embodiments of the present invention, one or more switches can be used to clamp the output compliance current and/or voltage of the ballast. Various implementations of the present invention can involve voltage or current forward converters and/or inverters, square-wave, sine-wave, resonant-wave, etc. that include, but are not limited to, push pull, half-bridge, full-bridge, square wave, sine wave, fly-back, resonant, synchronous, etc.

For the present invention, in general, any type of transistor or vacuum tube or other similarly functioning device can be used including, but not limited to, MOSFETs, JFETs, GANFETs, depletion or enhancement FETs, N and/or P FETs, CMOS, PNP BJTs, triodes, etc. which can be made of any suitable material and configured to function and operate to provide the performance, for example, described above. In addition, other types of devices and components can be used including, but not limited to transformers, transformers of any suitable type and form, coils, level shifters, digital logic, analog circuits, analog and digital, mixed signals, microprocessors, microcontrollers, FPGAs, CLDs, PLDs, comparators, op amps, instrumentation amplifiers, and other analog and digital components, circuits, electronics, systems etc. For all of the example figures shown, the above analog and/or digital components, circuits, electronics, systems etc. are, in general, applicable and usable in and for the present invention.

The example figures and embodiments shown in herein are merely intended to provide some illustrations of the present inventions and not limiting in any way or form for the present inventions.

Using digital and/or analog designs and/or microcontrollers and/or microprocessors any and all practical combinations of control, protection, sequencing, levels, etc., some examples of which are listed below for the present invention, can be realized.

In addition to these examples, a potentiometer or similar device such as a variable resistor may be used to control the dimming level. Such a potentiometer may be connected across a voltage such that the wiper of the potentiometer can swing from minimum voltage (i.e., full dimming) to maximum voltage (i.e., full light). Often the minimum voltage will be zero volts which may correspond to full off and, for the example embodiments shown here, the maximum will be equal to or approximately equal to the voltage on the negative input of, for example, a comparator.

Current sense methods including resistors, current transformers, current coils and windings, etc. can be used to measure and monitor the current of the present invention and provide both monitoring and protection.

In addition to dimming by adjusting, for example, a potentiometer, the present invention can also support all standards, ways, methods, approaches, techniques, etc. for interfacing, interacting with and supporting, for example, 0 to 10 V dimming with a suitable reference voltage that can be remotely set or set via an analog or digital input such as illustrated in patent application 61/652,033 filed on May 25, 2012, for a “Dimmable LED Driver”, which is incorporated herein by reference for all purposes.

The present invention supports all standards and conventions for 0 to 10 V dimming or other dimming techniques. In addition the present invention can support, for example, overcurrent, overvoltage, short circuit, and over-temperature protection. The present invention can also measure and monitor electrical parameters including, but not limited to, input current, input voltage, power factor, apparent power, real power, inrush current, harmonic distortion, total harmonic distortion, power consumed, watthours (WH) or kilowatt hours (kWH), etc. of the load or loads connected to the present invention. In addition, in certain configurations and embodiments, some or all of the output electrical parameters may also be monitored and/or controlled directly for, for example, LED drivers and FL ballasts. Such output parameters can include, but are not limited to, output current, output voltage, output power, duty cycle, PWM, dimming level(s), provide data monitoring, data logging, analytics, analysis, etc. including, but not limited to, input and output current, voltage, power, phase angle, real power, light output (lumens, lux), dimming level if appropriate, kilowatt hours (kWH), efficiency, temperature including temperatures of components, driver, LED or OLED array or array or strings or other types of configurations and groupings, etc.

In place of the potentiometer, an encoder or decoder can be used. The use of such also permits digital signals to be used and allows digital signals to either or both locally or remotely control the dimming level and state. A potentiometer with an analog to digital converter (ADC) or converters (ADCs) could also be used in many of such implementations of the present invention.

The examples and figures are merely meant to provide illustrations of the present and should not be construed as limiting in any way or form for the present invention.

In addition to the examples above and any combinations of the above examples, the present invention can have multiple dimming levels set by the dimmer in conjunction with the motion sensor and photosensor/photodetector and/or other control and monitoring inputs including, but not limited to, analog (e.g., 0 to 10 V, 0 to 3 V, etc.), digital (RS232, RS485, USB, DMX, SPI, SPC, UART, DALI, other serial interfaces, etc.), a combination of analog and digital, analog-to-digital converters and interfaces, digital-to-analog converters and interfaces, wired, wireless (i.e., RF, WiFi, ZigBee, Zwave, ISM bands, 2.4 GHz, Bluetooth, etc.), powerline (PLC) including X-10, Insteon, HomePlug, etc.), etc.

The present invention is highly configurable and words such as current, set, specified, etc. when referring to, for example, the dimming level or levels, may have similar meanings and intent or may refer to different conditions, situations, etc. For example, in a simple case, the current dimming level may refer to the dimming level set by, for example, a control voltage from a digital or analog source including, but not limited to digital signals, digital to analog converters (DACs), potentiometer(s), encoders, etc.

The present invention can have embodiments and implementations that include manual, automatic, monitored, controlled operations and combinations of these operations. The present invention can have switches, knobs, variable resistors, encoders, decoders, push buttons, scrolling displays, cursors, etc. The present invention can use analog and digital circuits, a combination of analog and digital circuits, microcontrollers and/or microprocessors including, for example, DSP versions, FPGAs, CLDs, ASICs, etc. and associated components including, but not limited to, static, dynamic and/or non-volatile memory, a combination and any combinations of analog and digital, microcontrollers, microprocessors, FPGAs, CLDs, etc. Items such as the motion sensor(s), photodetector(s)/photosensor(s), microcontrollers, microprocessors, controls, displays, knobs, etc. may be internally located and integrated/incorporated into the dimmer or externally located. The switches/switching elements can consist of any type of semiconductor and/or vacuum technology including but not limited to triacs, transistors, vacuum tubes, triodes, diodes or any type and configuration, pentodes, tetrodes, thyristors, silicon controlled rectifiers, diodes, etc. The transistors can be of any type(s) and any material(s)—examples of which are listed below and elsewhere in this document.

The dimming level(s) can be set by any method and combinations of methods including, but not limited to, motion, photodetection/light, sound, vibration, selector/push buttons, rotary switches, potentiometers, resistors, capacitive sensors, touch screens, wired, wireless, PLC interfaces, etc. In addition, both control and monitoring of some or all aspects of the dimming, motion sensing, light detection level, sound, etc. can be performed for and with the present invention.

Other embodiments can use other types of comparators and comparator configurations, other op amp configurations and circuits, including but not limited to error amplifiers, summing amplifiers, log amplifiers, integrating amplifiers, averaging amplifiers, differentiators and differentiating amplifiers, etc. and/or other digital and analog circuits, microcontrollers, microprocessors, complex logic devices (CLDs), field programmable gate arrays (FPGAs), etc.

The dimmer for dimmable drivers may use and be configured in continuous conduction mode (CCM), critical conduction mode (CRM), discontinuous conduction mode (DCM), resonant conduction modes, etc., with any type of circuit topology including but not limited to buck, boost, buck-boost, boost-buck, Cuk, SEPIC, flyback, forward-converters, etc. The present invention works with both isolated and non-isolated designs including, but not limited to, buck, boost-buck, buck-boost, boost, Cuk, SEPIC, flyback and forward-converters including but not limited to push-pull, single and double forward converters, current mode, voltage mode, current fed, voltage fed, etc. The present invention itself may also be non-isolated or isolated, for example using a tagalong inductor or transformer winding or other isolating techniques, including, but not limited to, transformers including signal, gate, isolation, etc. transformers, optoisolators, optocouplers, etc.

The present invention may include other implementations that contain various other control circuits including, but not limited to, linear, square, square-root, power-law, sine, cosine, other trigonometric functions, logarithmic, exponential, cubic, cube root, hyperbolic, etc. in addition to error, difference, summing, integrating, differentiators, etc. type of op amps. In addition, logic, including digital and Boolean logic such as AND, NOT (inverter), OR, Exclusive OR gates, etc., complex logic devices (CLDs), field programmable gate arrays (FPGAs), microcontrollers, microprocessors, application specific integrated circuits (ASICs), etc. can also be used either alone or in combinations including analog and digital combinations for the present invention. The present invention can be incorporated into an integrated circuit, be an integrated circuit, etc. It should be noted that the various blocks shown in the drawings and discussed herein may be implemented in integrated circuits along with other functionality. Such integrated circuits may include all of the functions of a given block, system or circuit, or a subset of the block, system or circuit. Further, elements of the blocks, systems or circuits may be implemented across multiple integrated circuits. Such integrated circuits may be any type of integrated circuit known in the art including, but are not limited to, a monolithic integrated circuit, a flip chip integrated circuit, a multichip module integrated circuit, and/or a mixed signal integrated circuit. It should also be noted that various functions of the blocks, systems or circuits discussed herein may be implemented in either software or firmware. In some such cases, the entire system, block or circuit may be implemented using its software or firmware equivalent. In other cases, the one part of a given system, block or circuit may be implemented in software or firmware, while other parts are implemented in hardware.

Embodiments of the present invention may also include short circuit protection (SCP) and other forms of protection including protection against damage due to other sources of power including but not limited to AC mains power lines and/or other types of devices, circuits, etc. Some embodiments of the present invention may use, for example, but are not limited to capacitors to limit the low frequency (examples include, but are not limited to, AC line mains at 50 Hz, 60 Hz, 400 Hz) voltage and/or current that can be applied to the load. In addition to capacitors, inductors and resistors may also be used in some embodiments of the present invention.

The present invention can also incorporate at an appropriate location or locations one or more thermistors (i.e., either of a negative temperature coefficient [NTC] or a positive temperature coefficient [PTC]) to provide temperature-based load current limiting.

As an example, when the temperature rises at the selected monitoring point(s), the phase dimming of the present invention can be designed and implemented to drop, for example, by a factor of, for example, two. The output power, no matter where the circuit was originally in the dimming cycle, will also drop/decrease by some factor. Values other than a factor of two (i.e., 50%) can also be used and are easily implemented in the present invention by, for example, changing components of the example circuits described here for the present invention. As an example, a resistor change would allow and result in a different phase/power decrease than a factor of two. The present invention can be made to have a rather instant more digital-like decrease in output power or a more gradual analog-like decrease, including, for example, a linear decrease in output phase or power once, for example, the temperature or other stimulus/signal(s) trigger/activate this thermal or other signal control.

In other embodiments, other temperature sensors may be used or connected to the circuit in other locations. The present invention also supports external dimming by, for example, an external analog and/or digital signal input. One or more of the embodiments discussed above may be used in practice either combined or separately including having and supporting both 0 to 10 V and digital dimming. The present invention can also have very high power factor. The present invention can also be used to support dimming of a number of circuits, drivers, etc. including in parallel configurations. For example, more than one driver can be put together, grouped together with the present invention. Groupings can be done such that, for example, half of the dimmers are forward dimmers and half of the dimmers are reverse dimmers. Again, the present invention allows easy selection between forward and reverse dimming that can be performed manually, automatically, dynamically, algorithmically, can employ smart and intelligent dimming decisions, artificial intelligence, remote control, remote dimming, etc.

The present invention may be used in conjunction with dimming to provide thermal control or other types of control to, for example, a dimming LED driver. For example, embodiments of the present invention or variations thereof may also be adapted to provide overvoltage or overcurrent protection, short circuit protection for, for example, a dimming LED or OLED driver, etc., or to override and cut the phase and power to the dimming LED driver(s) based on any arbitrary external signal(s) and/or stimulus. The present invention can also be used for purposes and applications other than lighting—as an example, electrical heating where a heating element or elements are electrically controlled to, for example, maintain the temperature at a location at a certain value. The present invention can also include circuit breakers including solid state circuit breakers and other devices, circuits, systems, etc. that limit or trip in the event of an overload condition/situation. The present invention can also include, for example analog or digital controls including but not limited to wired (i.e., 0 to 10 V, RS 232, RS485, IEEE standards, SPI, I2C, other serial and parallel standards and interfaces, etc.), wireless including as discussed above, powerline, etc. and can be implemented in any part of the circuit for the present invention. The present invention can be used with a buck, a buck-boost, a boost-buck and/or a boost, flyback, or forward-converter design, topology, implementation, others discussed herein, etc.

A dimming voltage signal, VDIM, which represents a voltage from, for example but not limited to, a 0-10 V Dimmer can be used with the present invention; when such a VDIM signal is connected, the output as a function time or phase angle (or phase cut) will correspond to the inputted VDIM.

Other embodiments can use comparators, other op amp configurations and circuits, including but not limited to error amplifiers, summing amplifiers, log amplifiers, integrating amplifiers, averaging amplifiers, differentiators and differentiating amplifiers, etc. and/or other digital and analog circuits, microcontrollers, microprocessors, complex logic devices, field programmable gate arrays, etc.

Some embodiments include a circuit that dynamically adjusts such that the output current to a load such as a LED and/or OLED array is essentially kept constant by, for example, in some embodiments of the present invention shorting or shunting current from the ballast as needed to maintain the output current to a load such as a LED array essentially constant. Some embodiments of the present invention may use time constants to as part of the circuit.

Some embodiments include a circuit to power a protection device/switch such that the switch is on unless commanded or controlled to be set off in the event/situation/condition of a fault hazard. Such a control can be implemented in various and diverse forms and types including, but not limited to, latching, hiccup mode, etc. In some embodiments of the present invention such a circuit may have a separate rectification stage. In and for various embodiments of the present invention, the device/switch may be of any type or form or function and includes but is not limited to, semiconductor switches, vacuum tube switches, mechanical switches, relays, etc.

Some embodiments include an over-voltage protection (OVP) circuit that shunts/shorts or limits the ballast output and/or the output to the load such as a LED array in the event that the output voltage exceeds a set value.

Some embodiments include an over temperature protection (OTP) circuit that shunts/shorts or limits the ballast output and/or the output to the load such as a LED array in the event that the temperature at one or more locations exceeds a set value or set values.

Embodiments of the present invention may also include short circuit protection (SCP) and other forms of protection including protection against damage due to other sources of power including but not limited to AC mains power lines and/or other types of devices, circuits, etc. Some embodiments of the present invention may use, for example, but are not limited to capacitors to limit the low frequency (examples include, but are not limited to, AC line mains at 50 Hz, 60 Hz, 400 Hz) voltage and/or current that can be applied to the load.

Embodiments of the present invention include, but are not limited to, having a rectification stage (such as, but not limited to) consisting of a single full wave rectification stage to provide power/current to the output load such as an LED output load and a rectification stage (such as, but not limited to) consisting of a single full wave rectification stage to provide power to, for example, the hazard protection circuit.

Remote dimming can be performed using a controller implementing motion detection, recognizing motion or proximity to a detector or sensor and setting a dimming level in response to the detected motion or proximity, or with audio detection, for example detecting sounds or verbal commands to set the dimming level in response to detected sounds, volumes, or by interpreting the sounds, including voice recognition or, for example, by gesturing including hand or arm gesturing, etc. Some embodiments may be dual dimming, supporting the use of a 0-10 V dimming signal in addition to a Triac-based or other phase-cut or phase angle dimmer. Some embodiments of the present invention may multiple dimming (i.e., accept dimming information, input(s), control from two or more sources). In addition, the resulting dimming, including current or voltage dimming, can be either PWM (digital) or analog dimming or both or selectable either manually, automatically, or by other methods and ways including software, remote control of any type including, but not limited to, wired, wireless, voice, voice recognition, gesturing including hand and/or arm gesturing, pattern and motion recognition, PLC, RS232, RS422, RS485, SPI, I2C, universal serial bus (USB), Firewire 1394, DALI, DMX, etc. Voice, voice recognition, gesturing, motion, motion recognition, etc. can also be transmitted via wireless, wired and/or powerline communications or other methods, etc. In some embodiments of the present invention speakers, earphones, microphones, etc. may be used with voice, voice recognition, sound, etc. and other methods, ways, approaches, algorithms, etc. discussed herein.

The present invention includes implementations that contain various other control circuits including, but not limited to, linear, square, square-root, power-law, sine, cosine, other trigonometric functions, logarithmic, exponential, cubic, cube root, hyperbolic, etc. in addition to error, difference, summing, integrating, differentiators, etc. type of op amps. In addition, logic, including digital and Boolean logic such as AND, NOT (inverter), OR, Exclusive OR gates, etc., complex logic devices (CLDs), field programmable gate arrays (FPGAs), microcontrollers, microprocessors, application specific integrated circuits (ASICs), etc. can also be used either alone or in combinations including analog and digital combinations for the present invention. The present invention can be incorporated into an integrated circuit, be an integrated circuit, etc.

The present invention, although described primarily for motion and light/photodetection control, can and may also use other types of stimuli, input, detection, feedback, response, etc. including but not limited to sound, vibration, frequencies above and below the typical human hearing range, temperature, humidity, pressure, light including below the visible (i.e., infrared, IR) and above the visible (i.e., ultraviolet, UV), radio frequency signals, combinations of these, etc. For example, the motion sensor may be replaced or augmented with a sound sensor (including broad, narrow, notch, tuned, tank, etc. frequency response sound sensors) and the light sensor could consist of one or more of the following: visible, IR, UV, etc. sensors. In addition, the light sensor(s)/detector(s) can also be replaced or augmented by thermal detector(s)/sensor(s), etc.

The example embodiments disclosed herein illustrate certain features of the present invention and not limiting in any way, form or function of present invention. The present invention is, likewise, not limited in materials choices including semiconductor materials such as, but not limited to, silicon (Si), silicon carbide (SiC), silicon on insulator (SOI), other silicon combination and alloys such as silicon germanium (SiGe), etc., diamond, graphene, gallium nitride (GaN) and GaN-based materials, gallium arsenide (GaAs) and GaAs-based materials, etc. The present invention can include any type of switching elements including, but not limited to, field effect transistors (FETs) of any type such as metal oxide semiconductor field effect transistors (MOSFETs) including either p-channel or n-channel MOSFETs of any type, junction field effect transistors (JFETs) of any type, metal emitter semiconductor field effect transistors, etc. again, either p-channel or n-channel or both, bipolar junction transistors (BJTs) again, either NPN or PNP or both, heterojunction bipolar transistors (HBTs) of any type, high electron mobility transistors (HEMTs) of any type, unijunction transistors of any type, modulation doped field effect transistors (MODFETs) of any type, etc., again, in general, n-channel or p-channel or both, vacuum tubes including diodes, triodes, tetrodes, pentodes, etc. and any other type of switch, etc.

The examples shown above are intended to provide non-limiting examples of the present invention and represent only a very small sampling of the possible ways, topologies, connections, arrangements, applications, etc. of the present invention. Based upon the disclosure provided herein, one of skill of the art will recognize a number of combinations and applications of solid state lighting system elements disclosed herein that can be used in accordance with various embodiments of the invention without departing from the inventive concepts.

It should be noted that the various blocks discussed in the above application may be implemented in integrated circuits along with other functionality. Such integrated circuits may include all of the functions of a given block, system or circuit, or a subset of the block, system or circuit. Further, elements of the blocks, systems or circuits may be implemented across multiple integrated circuits. Such integrated circuits may be any type of integrated circuit known in the art including, but are not limited to, a monolithic integrated circuit, a flip chip integrated circuit, a multichip module integrated circuit, and/or a mixed signal integrated circuit. It should also be noted that various functions of the blocks, systems or circuits discussed herein may be implemented in either software or firmware. In some cases, parts of a given system block or circuit may be implemented in software or firmware, while other parts are implemented in hardware. Embodiments of the present invention including but not limited to those described above and discussed herein can include, for example, but not limited to stereo cameras, 3D cameras, thermal imaging, people counting/counters, dust sensors, pollution sensors, WiFi probe requests, BLE sniffing, detection, identification of surrounding BLE devices, etc. including but not limited to announce, broadcast, authenticate, pair, repeat, broadcasting, advertising, broadcasting advertising packets, discovery, detection, mesh, beacon, UUIDs, signal strength, RSSI, etc.

The choice and types of transistors and other circuits shown and depicted in the figures and discussed herein and not limiting and can be in general replaced with other transistors of, for example, but not limited to another type and family. For example as a non-limiting example in general a FET can be replaced with a BJT or vice versa for the transistors and switches depicted in the figures and discussed in the text herein.

The circuits and associated figures depicting the circuits are also applicable to circuits and drivers and systems for SSL fluorescent tube replacements

While embodiments of the present invention have been illustrated and described, it will be clear that the invention is not limited to these embodiments only, and that the configuration, arrangement and type of components in the various embodiments set forth herein are illustrative embodiments only and should not be viewed as limiting or as encompassing all possible variations that may be performed by one skilled in the art while remaining within the scope of the claimed invention. Numerous modifications, changes, combinations, variations, substitutions, and equivalents will be apparent to those skilled in the art, without departing from the spirit and scope of the invention, as described in the claims. Example embodiments disclosed herein do not present every possible combination of novel features or applications. Features presented in one embodiment can be applied to and implemented in other embodiments without departing from the spirit and scope of the invention, as described in the claims.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected”, or “coupled”, to each other to achieve the desired functionality, and any two components capable of being so associated can also be viewed as being “couplable”, to each other to achieve the desired functionality. Specific examples of couplable include but are not limited to physically mateable and/or physically interacting components and/or wirelessly interactable and/or wirelessly interacting components and/or logically interacting and/or logically interactable components. For example, op amp and comparator in most cases may be used in place of one another in this document.

It should be noted that the various blocks discussed in the above application may be implemented in integrated circuits along with other functionality. Such integrated circuits may include all of the functions of a given block, system or circuit, or a subset of the block, system or circuit. Further, elements of the blocks, systems or circuits may be implemented across multiple integrated circuits. Such integrated circuits may be any type of integrated circuit known in the art including, but are not limited to, a monolithic integrated circuit, a flip chip integrated circuit, a multichip module integrated circuit, and/or a mixed signal integrated circuit. It should also be noted that various functions of the blocks, systems or circuits discussed herein may be implemented in either software or firmware. In some cases, parts of a given system, block or circuit may be implemented in software or firmware, while other parts are implemented in hardware.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected”, or “coupled”, to each other to achieve the desired functionality, and any two components capable of being so associated can also be viewed as being “couplable”, to each other to achieve the desired functionality. Specific examples of couplable include but are not limited to physically mateable and/or physically interacting components and/or wirelessly interactable and/or wirelessly interacting components and/or logically interacting and/or logically interactable components.

In conclusion, embodiments of the present invention provide novel systems, devices, methods and arrangements for solid state lighting, which in some embodiments can include security functions. While detailed descriptions of one or more embodiments of the invention have been given above, various alternatives, modifications, and equivalents will be apparent to those skilled in the art without varying from the spirit of the invention. Therefore, the above description should not be taken as limiting the scope of embodiments of the invention which are encompassed by the appended claims.

What is claimed is:

1. An apparatus for providing light, comprising:
a power supply;
a solid state light connected to the power supply;
a switch connected in series with the solid state light, operable when open to block electrical current through the solid state light;
a current sensor connected to the solid state light; and
a comparator operable to compare a measurement from the current sensor with a reference value and to control the switch in response to a result of the comparison.

2. The apparatus of claim 1, wherein the solid state light comprises a string of a plurality of light emitting diodes.

3. The apparatus of claim 1, further comprising a pulse width modulator connected to an input of the switch and operable to deactivate the switch during a portion of a period of the pulse width modulator.

4. The apparatus of claim 3, wherein the pulse width modulator is further operable to deactivate the comparator when deactivating the switch.

5. The apparatus of claim 1, wherein the solid state light is mounted in a fluorescent lamp replacement tube adapted to be installed in a fluorescent lamp fixture.

6. The apparatus of claim 1, further comprising a second solid state light connected to the power supply through a diode, wherein electrical current flows through the second solid state light when the switch is open.

7. An apparatus for providing light, comprising:
a power supply;
a control module connected to the power supply; and
a plurality of solid state light modules, each comprising at least one sensor for detecting whether a user is near the solid state light module, wherein the control module is adapted to sequentially change an illumination state of the plurality of solid state light modules to signal a direction.

8. The apparatus of claim 7, wherein the at least one sensor comprises at least one element selected from a group consisting of an ultrasonic sensor, an infrared sensor, and a motion sensor.

9. The apparatus of claim 7, wherein the control module is configured to receive commands from a user interface in a computing device.

10. The apparatus of claim 7, wherein at least one of the plurality of solid state modules is configured as a fluorescent tube replacement.

11. The apparatus of claim 7, wherein at least one of the plurality of solid state modules is configured as an Edison lamp base adapter with solid state light bulb connected thereto.

12. The apparatus of claim 7, wherein the control module is configured to tune an apparent color temperature of the plurality of solid state light modules.

13. The apparatus of claim 7, wherein the control module is configured to control dimming of each of the plurality of solid state light modules.

14. An apparatus for providing light, comprising:
a power supply;
a plurality of solid state lights connected to the power supply;
a plurality of switches, each connected to one of the plurality of solid state lights and operable to switchably block electrical current from the power supply through an associated one of the plurality of solid state lights; and
a clock generator connected to the plurality of switches and configured to activate the plurality of switches.

15. The apparatus of claim 14, wherein the clock generator comprises a non-overlapping clock generator.

16. The apparatus of claim 14, wherein the clock generator comprises a pulse width modulator.

17. The apparatus of claim 14, wherein each of the plurality of solid state lights comprises a white solid state light, each producing a different color temperature, and wherein the clock generator is operable to adjust a balance between on-time of each of the plurality of solid state lights to control an apparent color temperature from the plurality of solid state lights.

18. The apparatus of claim 14, wherein the clock generator comprises an element selected from a group consisting of a microcontroller, a microprocessor, a digital signal processor, a field programmable array and a pulse width modulator.

19. The apparatus of claim 14, wherein each of the plurality of solid state lights comprises a solid state light of a different color, and wherein the clock generator is operable to adjust a balance between on-time of each of the plurality of solid state lights to control an apparent color from the plurality of solid state lights.

20. The apparatus of claim 14, wherein the clock generator is operable to adjust a balance between on-time of each of the plurality of solid state lights to control dimming of the plurality of solid state lights.
